(19) United States
(12) Patent Application Publication
(10) Pub. No.: US 2014/0095629 A1
(43) Pub. Date: Apr. 3, 2014

(54) Systems and Methods for Organizing Events

(71) Applicant: THINKPUDDLE INC., Toronto (CA)

(72) Inventors: Mitchell Hart Brown, Toronto (CA); Stern Jerome Breslin, Toronto (CA)

(73) Assignee: Thinkpuddle Inc., Toronto (CA)

(21) Appl. No.: 13/633,674

(22) Filed: Oct. 2, 2012

(51) Int. Cl. G06F 15/16; G06F 3/048

(52) U.S. Cl. 709/206; 709/204; 715/764

(57) ABSTRACT

Systems and methods are provided to organize Events, including transmitting invitations and receiving RSVP responses, and to organize Date Polls to determine availability of attendees. The Events and Date Polls can be related to various Groups. Each Group represents a Group of Users, who choose to attend Events and respond to Date Polls. A Graphical User Interface is provided that displays the consolidated status of all Date Polls, Events and Groups with which a User is associated, even if these Entities are created by multiple independent Administrators. Where the User is also an Administrator of a Date Poll, Event, Group, or any combination thereof, the software provides various options to allow the Administrator to customize data related to any of the Date Poll, Event or Group.

### TECHNICAL FIELD

The following relates generally to organizing Events.

### DESCRIPTION OF THE RELATED ART

A person can be part of many social circles and take part in different types of activities. As communication technology develops, a person can use the technology in a variety of ways to become engaged in different social circles and activities. As computers and electronic devices become more common, various electronic communication media are used to arrange and set up activities or Events. For example, email is used to schedule and organize Events.

### SUMMARY OF CERTAIN ASPECTS OF THE SYSTEMS AND METHODS DESCRIBED HEREIN

There are many different aspects described and illustrated in this application. The below summary does not limit the systems and methods to any single aspect nor embodiment thereof, nor to any combinations or permutations, or both, of such aspects described in this application. Moreover, each of the aspects of the systems and methods described in this application and embodiments thereof, may be employed alone or in combination with one or more of the other aspects described in the present application. For the sake of brevity, certain of those permutations and combinations are summarized below.

In an example of an embodiment, a method performed by a computing device is provided for organizing events. The method comprises: receiving data from an administrator to create an entity, the entity comprising any one of a group, an event, and a date poll, the data including a unique identifier of a user; creating the entity; creating a user account based on the unique identifier and associating the entity with the user account; receiving other data from an other administrator to create an other entity, the other entity comprising any one of an other group, an other event, and an other date poll, the other data including the unique identifier of the user; creating the other entity; identifying the user account using the unique identifier and associating the other entity with the user account; and when the user account is accessed by the user using the unique identifier, enabling access to the entity and the other entity.

In an example of an aspect, the unique identifier is an email address of the user. In another example of an aspect, the administrator has a profile associated with the entity and the other administrator has an other profile associated with the other entity and both the profile and the other profile are associated with a same user account. In another example of an aspect, the administrator is associated with a different user account and the other administrator is associated with an other different user account. In another example of an aspect, after associating the entity with the user account, sending an electronic message to the user with information to view the entity. In another example of an aspect, after receiving data to create the entity, the method further comprises: determining if the user has an existing user account based on the unique identifier; and if not, proceeding with creating the user account. In another example of an aspect, if the user has an existing account, the entity is associated with the existing user account. In another example of an aspect, the method further comprises: creating a profile for the user, identified by the unique identifier, that is associated with the entity; creating an other profile for the user, identified by the unique identifier, that is associated with the other entity; and wherein both the profile and the other profile are associated with the user account. In another example of an aspect, the entity and the other entity each have an entity ID, and the profile and the other profile each have a profile ID. In another example of an aspect, the method further comprises: determining if the entity is activated, and if so, enabling the user to access the entity; and determining if the other entity is activated, and if so, enabling the user to access the other entity. In another example of an aspect, the entity is the event and enabling access to the event includes a condition that precludes the user from RSVP'ing or registering for the event until a date prior to an event date of the event. In another example of an aspect, a user home page graphical user interface is displayed when the user accesses the user account, the user home page graphical user interface including the data about the entity and the other data about the other entity.

In an example of an embodiment, a method performed by a computing device is provided for creating an entity, the entity being any one of an event, a date poll and a group. The method comprises: receiving an input from an electronic device to create the entity; generating an entity ID; obtaining entity information and associating the entity information with the entity ID; obtaining contact information associated with a user; associating the user with the entity ID; obtaining a profile and a corresponding profile ID for the user, the profile and the profile ID associated with the entity ID; and after receiving an input to activate the entity, enabling the user to access the entity.

In an example of an aspect, the method further comprises, after receiving the input to activate the entity, sending an electronic message to the user with information to view the entity. In another example of an aspect, before the entity is activated, the method further comprises: generating a cookie including the entity ID and sending the cookie to the electronic device; after detecting the electronic device has been disconnected and reconnected with the computing device, obtaining the cookie from the electronic device; using the cookie and the entity ID stored therein to obtain and enable the display of the entity information to facilitate the creation of the entity. In another example of an aspect, the electronic message includes data from which the computing device can identify the entity ID and the profile ID. In another example of an aspect, the method further comprises associating the profile ID and entity ID with a user account. In another example of an aspect, the method further comprises: after receiving the input to activate the entity, sending an electronic message that includes a web link to the user with information to view the entity, the web link including data from which the computing device can identify the entity ID and the profile ID; and enabling access to the user account when accessed through the web link. In another example of an aspect, the method further comprises, after the user account is accessed, displaying the entity information. In another example of an aspect, the contact information includes an email address of the user, the email address used as a unique identifier of the user. In another example of an aspect, after obtaining the contact information associated with the user, the method further comprises: determining if the user has an existing user account based on the unique identifier; and if not, generating a user account associated with the unique identifier. In another example of an aspect, the entity is a copy of an original entity, and the entity information is a copy of original entity information. In another example of an aspect, the computing device receives, from the electronic device, modification to the original entity information when obtaining the entity information. In another example of an aspect, the original entity information includes another profile of another user, and after the entity is activated, enabling the other user to access the entity. In another example of an aspect, the entity is the event that is converted from an other date poll, and wherein the entity information is a copy of information of the other date poll. In another example of an aspect, the entity is created by an administrator having a user account, the user account associated with an other entity, the other entity associated with an other user, and the method further comprises: associating the other user with the entity ID; generating an other profile and an other corresponding profile ID for the other user, the other profile and the other profile ID associated with the entity ID; and after activating the entity, enabling the other user to access to the entity. In another example of an aspect, the entity is the event created within context of a group; the profile and the corresponding profile ID are associated with the group; and, the method further comprises: automatically obtaining the contact information of the user from the profile; and automatically associating the profile and the profile ID with the entity ID. In another example of an aspect, after associating the profile and the profile ID with the entity ID, the method further comprises: determining whether the user is a member of the group; and if the user is a member, automatically designating the user as eligible to attend the event. In another example of an aspect, the computing device receives the contact information of the user from the electronic device.

In another example of an embodiment, a method performed by a computing device is provided for converting a date poll to an event. The method comprises: receiving an input to convert the date poll to the event displaying a graphical user interface for receiving a selection of one of a plurality of polled dates in the date poll, and for receiving a selection to designate pollees of the date poll as invitees of the event; and after receiving an input to proceed with creating the event, establishing the selected one of the plurality of polled dates as a date of the event as the event and designating the pollees as invitees.

In an example of an aspect, the graphical user interface is also for receiving a selection for terminating the date poll. In another example of an aspect, a name of the event is identical to a name of a proposed event presented in the date poll.

Again, there are many aspects of the systems and methods described in this application and the example embodiments thereof. This Summary is not exhaustive of those aspects and the example embodiments. Indeed, this Summary may not be reflective of or correlate to the invention or inventions protected by the claims in this application or any related applications thereof.

This Summary of certain aspects and examples of embodiments is not intended to be limiting to the claims, whether the currently presented claims, or claims of a related application, and should not be interpreted in that manner. Furthermore, indeed, many other aspects and examples of embodiments, which may be different from or similar to the certain aspects and examples of embodiments in this Summary, will be provided in this application.

### BRIEF DESCRIPTION OF THE DRAWINGS

Example embodiments will now be described by way of example only with reference to the appended drawings wherein:

FIG. 1 is a block diagram of an example of an embodiment system used to organize Events and Date Polls, either as independent entities or within the context of a Group.

FIG. 2 is a block diagram illustrating an example of embodiment components of memory of a server used to organize Events and Date Polls, either as independent entities or within the context of a Group.

FIG. 3 is a block diagram of an example embodiment of data components (e.g. Users, Groups, Events, Date Polls) in an Event organizing system that are linked together.

FIG. 4 is a screenshot of an example of an embodiment of a Home Page graphical User interface (GUI) that is displayed when an individual views the Event Organizing Software.

FIG. 5 is an example of an embodiment of computer executable or processor implemented instructions for selecting different options provided on the Home Page GUI.

FIG. 6 is a screenshot of an example of an embodiment of a User Home Page GUI displayed after a User logs into the Event Organizing Software, showing the “My Events” tab actively displayed.

FIG. 7 is a screenshot of an example of an embodiment of the User Home Page GUI in FIG. 6, with the “My Group Memberships” tab actively displayed.

FIG. 8 is a screenshot of an example of an embodiment of the User Home Page GUI in FIG. 6, with the “I am Administrator of” tab actively displayed.

FIG. 9 is an example of an embodiment of computer executable or processor implemented instructions for selecting different tabs provided on the User Home Page GUI.

FIG. 10 is an example of an embodiment of computer executable or processor implemented instructions for creating a new Profile.

FIG. 11 is a block diagram of an example of an embodiment of data components, including Entities, Profiles, and User Accounts, and their relationship to each other.

FIGS. 12, 13, 14, 15, and 16 are examples of embodiments of creating Entities, including One-off Date Polls, One-off Events, Groups, Group Date Polls, and Group Events.

FIG. 17 is an example of an embodiment of computer executable or processor implemented instructions for creating an Entity.

FIG. 18 is an example of an embodiment of computer executable or processor implemented instructions that are invoked by receiving a message containing an Entity Page GUI link.

FIG. 19 is a screenshot of an example of an embodiment of a GUI for prompting the Minimum Event Details when creating an Event.

FIG. 20 is a screenshot of an example of an embodiment of a GUI for receiving Event Configuration information.

FIG. 21 is a screenshot of an example of an embodiment of a GUI for receiving Guest Privileges information.

FIG. 22 is a screenshot of an example of an embodiment of a GUI for receiving RSVP survey questions and custom Administrator fields.

FIG. 23 is a screenshot of an example of an embodiment of a GUI for configuring viewing rights.

FIG. 24 is a screenshot of an example of an embodiment of a GUI for configuring email alerts.

FIG. 25 is a screenshot of an example of an embodiment of a GUI for configuring a Signup Method.

FIG. 26 is a screenshot of an example of an embodiment of a GUI for configuring “RSVP By” settings.

FIG. 27 is a screenshot of an example of an embodiment of a GUI of a Group Event that is not activated, and is shown in Administrator mode.

FIG. 28 is a screenshot of an example of an embodiment of an Attendance Management GUI.

FIG. 29 is a screenshot of an example of an embodiment of a Copy Event GUI.

FIG. 30 is a screenshot of an example of an embodiment of a Cancel Event GUI.

FIG. 31A is a screenshot of an example of an embodiment of an Event Page GUI in User mode.

FIG. 31B is a screenshot of an example of an embodiment of the Event Page GUI in FIG. 31A, where the Event is activated, and Event Page GUI is shown in Administrator mode.

FIG. 32 is a screenshot of an example of an embodiment of an RSVP GUI, allowing a User to provide an RSVP response.

FIG. 33 is a screenshot of an example of an embodiment of an RSVP GUI, allowing a User of a Family/Department Profile to provide an RSVP response.

FIG. 34 is a screenshot of an example of an embodiment of an RSVP GUI for a Registrant.

FIG. 35 is an example of an embodiment of computer executable or processor implemented instructions for processes related to an Event.

FIG. 36 is a screenshot of an example of an embodiment of a GUI for configuring a Date Poll.

FIG. 37A is a screenshot of an example of an embodiment of a One-off Date Poll GUI in Administrator Mode.

FIG. 37B is a screenshot of an example of an embodiment of the One-off Date Poll GUI in FIG. 37A, but in User mode.

FIG. 38 is a screenshot of an example of an embodiment of a Pollee Management GUI.

FIG. 39 is a screenshot of an example of an embodiment of a GUI for converting a Date Poll to an Event.

FIG. 40 is a screenshot of an example of an embodiment of a Date Poll Response GUI.

FIG. 41 is an example of an embodiment of computer executable or processor implemented instructions for processes related to a Date Poll.

FIG. 42 is a screenshot of an example of an embodiment of a GUI for creating a Group.

FIG. 43A is a screenshot of an example of an embodiment of a Group page GUI in Administrator Mode.

FIG. 43B is a screenshot of an example of an embodiment of a Group page GUI in Administrator Mode, where the Group has not been activated.

FIG. 44 is a screenshot of an example of an embodiment of a GUI for copying a Group.

FIG. 45 is an example of an embodiment of computer executable or processor implemented instructions for processes related to a Group.

FIG. 46 is a screenshot of an example of an embodiment of a GUI for adding or removing Administrators.

FIG. 47 is a screenshot of an example of an embodiment of a GUI for displaying a contracted view of a Profile.

FIGS. 48, 49 and 50 are screenshots of examples of embodiments of a GUI for displaying an expanded view of a Profile.

FIG. 51 is a screenshot of an example of an embodiment of a GUI for displaying a contracted view of a Family/Department Profile.

FIG. 52 is a screenshot of an example of an embodiment of a GUI for displaying an expanded view of a Family/Department Profile.

FIG. 53 is a screenshot of an example of an embodiment of a Profile and Member Management GUI.

FIG. 54A is a screenshot of an example of an embodiment of a GUI for importing Profiles by manually inputting emails or pasting emails.

FIG. 54B is a screenshot of an example of an embodiment of a GUI for importing Profiles by obtaining contacts associated with other Entities in the Event Organizing Software.

FIG. 55 is a screenshot of an example of an embodiment of a GUI for creating additional Member Classes.

FIG. 56 is a screenshot of an example of an embodiment of a GUI for displaying Membership information associated with a given Profile, including Membership history.

FIG. 57 is a screenshot of an example of an embodiment of a GUI for renewing a Membership.

FIG. 58 is a screenshot of an example of an embodiment of a GUI for terminating a Membership.

FIG. 59 is a screenshot of an example of an embodiment of a GUI for configuring the privacy level for an Event.

FIG. 60 is a screenshot of an example of an embodiment of a GUI configuring the privacy level for a Group.

FIG. 61 is a screenshot of an example of an embodiment of a Copy Date Poll GUI.

FIG. 62 is a screenshot of an example of an embodiment of a GUI for configuring Member Eligibility Restrictions.

All names of individuals or persons appearing in the Figures or in this application are fictitious. Any resemblance to real individuals or persons, living or dead, is purely coincidental.

### DETAILED DESCRIPTION

### Introduction

A number of terms used in this application are defined in the following section. It will be appreciated that for simplicity and clarity of illustration, where considered appropriate, reference numerals may be repeated among multiple figures to indicate corresponding or analogous elements. While specific details and features are set forth to provide a thorough understanding of the example embodiments described herein, it will be understood by those of ordinary skill in the art that the example embodiments described herein may be practiced without these, or with other, specific details and features. In other instances, generally known methods, procedures and components have not been described in detail to avoid obscuring the examples of the embodiments described herein. Also, the description is not to be considered as limiting the scope of the example embodiments described herein.

A person may be involved in a variety of activities related to different aspects (e.g. social, work, business, family, recreation, etc.) of his or her life. The activities may involve different Groups of people. For example, a family activity may involve relatives and close friends. A business activity may involve workplace staff, or a particular department. It is recognized that organizing Events for different Groups can be difficult, and can be more difficult as a Group has more Events and also as a person becomes involved with a larger number of Groups.

In many situations, emails are exchanged among people to organize an Event. For example, the emails can be used to determine a date and time of the Event, the meeting location, and whom is invited. The email exchanges can be numerous, for example, when trying to determine a date and time that is available for many people. Even if the Event Date and time are known, similar exchanges may be required in order to ascertain who will attend the Event and who will not.

It is also recognized that for recurring Events, such as Group meetings or recurring social events, determining suitable Event dates or tracking who will attend an Event, or both, can be difficult and time-consuming.

It is therefore desirable to provide Event organizing systems and methods that make it more convenient to organize an Event, or multiple Events, for Groups.

The proposed systems and methods described herein include Event Organizing Software that can be accessed by an electronic device (e.g. a computer, mobile device, tablet, etc.) over a network. In an example of an embodiment, the Event Organizing Software provides a website that can be accessed over the Internet. In an example of another embodiment, the Event Organizing Software interacts over a network (e.g. the Internet) with an application residing on the user's electronic device. The Event Organizing Software allows a User to create a Group within which there may be Members, Events and Date Polls. The Event Organizing Software also allows a User to create a single-use or “One-Off” Event or Date Poll which is not connected with a Group. It also allows other Users to RSVP or Register for an Event, or to respond to a Date Poll. The Event Organizing. Software conveniently displays to a User real-time information about all Date Polls, Events and Groups with which the User is associated. The Event Organizing Software provides various options to allow a User, who is the Administrator of an Event, Date Poll or Group, to customize data related thereto, including setup or configuration options.

### TERMINOLOGY

Below is a brief explanation of various terms used throughout this application.

Activation. The term “Activation” herein refers to the action of the Administrator to convert an Entity from a “Not Activated” state to an “Activated” state. In an example embodiment, a Group, Event or Date Poll, when first created, is in a “Not Activated” state. In the “Not Activated” state, only the Administrator is made aware of, and is permitted to open and view, the Entity Page GUI. After the Entity has been set up or configured to the Administrator's satisfaction, the Administrator can Activate the Entity. In an “Activated” state, Users with a right to view the Entity Page GUI are made aware of, and are permitted to open and view, the Entity Page GUI.

Activation Status. The term “Activation Status” herein refers to the state of an Entity. Possible values for the Activation Status of an Event are “not Activated”, “Activated”, “cancelled” and “past”. Possible values for the Activation Status of a Date Poll are “not Activated”, “Activated”, “terminated” and “past”. Possible values for the Activation Status of a Group are “not Activated”, “Activated” and “terminated”. The date and time of a change of Activation Status is saved to the database, and may be viewed by the Administrator. The “cancelled” value means that the Event has been cancelled by the Administrator, by way of the “Cancel Event” functionality. In the case of a Date Poll, the “terminated” value means that the Date Poll has been cancelled or terminated by the Administrator, by way of the “Terminate Poll” functionality. In the case of a Group, the “terminated” value means that the Group has been terminated by the Administrator, by way of the “Terminate Group” functionality. In the case of a Date Poll, the “past” value means that all of the Polled Dates have passed. For example, the system makes the determination that the Date Poll has passed. In the case of an Event, the “past” value means that the Event Date has passed. For example, the system makes the determination that the Event has passed.

Administrator. The term “Administrator” herein refers to a User who has the authority to configure or modify settings relating to a Group, a One-Off Event, or a One-Off Date Poll (e.g. a Primary Entity). Non-limiting examples of the rights available to an Administrator are the ability to specify Entity Details and Entity Setup Options, the ability to create and modify Memberships and the ability to create Events and Date Polls within a Group. In an example of an embodiment, a User who creates a Primary Entity is the initial Administrator of such Primary Entity.

Administrator Mode. The terms “User Mode” and “Administrator Mode” herein refer to the two alternative Modes in which an Entity Page GUI may be viewed. When the Entity Page GUI is viewed in Administrator Mode, in addition to elements which are displayed in User Mode, the Entity Page GUI includes information, menu options and controls which are intended for viewing or for use by an Administrator. Administrator Mode may be accessed only by a User who is an Administrator of the Entity, including a situation where the User is creating a new Entity and is deemed to be the Administrator. A User, who is an Administrator and, at a particular time, is entitled to access the Entity Page GUI in either of the User Mode and the Administrator Mode can switch from one to the other by clicking the control displayed on the Entity Page GUI for this purpose.

Affiliation Icon. The term “Affiliation Icon” herein refers to an image or icon which indicates the involvement or affiliation of a Profile with the Entity. For example, there are Affiliation Icons for a Member, an Invitee, a Registrant, a Guest and a Former Member.

Class Exception. The term “Class Exception” herein refers to functionality whereby the Administrator who is configuring an Entity, may specify that a particular Profile is not subject to the setting which would otherwise apply to its Class of Profiles. For example, if an Event is configured so that Invitees may not bring Guests to an Event, the Administrator may create a Class Exception for John Doe, an Invitee, so that he may bring one Guest.

Class of Profiles. The term “Class of Profiles” herein refers to a set of Profiles which, in the given context, share a common attribute. For example, in the case of an Event, classes of Profiles might include Class “A” Members, Class “B” Members, and Invitees. The concept applies to Setup Options; for example, when assigning Guest privileges, the Administrator might allow Members to bring two Guests each, and Invitees to bring zero.

Date Poll. The term “Date Poll” herein refers to a set of one or more Polled Dates, coupled with functionality by which Pollees may respond as to their availability to attend the proposed Event for each of the Polled Dates. A Date Poll is created by an Administrator, either within the context of a Group or as a One-Off.

Date Poll Response. The term “Date Poll Response” herein refers to the response of a Pollee to a Date Poll. Although there may be other data associated with a Date Poll Response, the main elements are the responses (one for each Polled Date) as to whether the Pollee intends to attend, intends not to attend, or (provided that the Date Poll has been configured so as to permit a response of “maybe”) may attend the proposed Event. Non-limiting examples of other data that can be provided in a Date Poll Response form include comments. In the case of a Family/Department Profile, a response per Polled Date is permitted, just as would be the case with an individual's Profile. It will be appreciated that a Family/Department Profile can respond as a unit with respect to each date, as opposed to each member of the family/department responding. In the case of an RSVP to an Event, each member of a family/department is able to respond individually.

Date Poll Response GUI. The term “Date Poll Response GUI” herein refers to the GUI which displays a form by which a Pollee may respond to a Date Poll.

Date Poll Response Value. The term “Date Poll Response Value” herein refers to an indicator as to whether or not the Pollee has responded to the Date Poll. Possible Date Poll Response Values are “submitted” and “no reply”. Although not strictly a Date Poll Response Value, the Event Organizing Software might show “not Activated” (if the User is an Administrator of a Date Poll which has not yet been Activated) or “ineligible” (if the User is an Administrator, but not a Pollee, of an Activated Date Poll).

Demo Entity. The term “Demo Entity” herein refers to a Primary Entity created by a Demo User. In order to facilitate adoption of the Event Organizing Software by Users, the system permits a User who has not logged in (the Demo User) to create a Group, Event or Date Poll (the Demo Entity). In the case of a Group, a Demo User may also create Events and Date Polls which are associated with the Group. A Demo User cannot Activate a Demo Entity, unless the Demo User first creates a User Account, if necessary, and Logs in and “adopts” the Demo Entity.

Demo User. The term “Demo User” herein refers to a User who is not Logged in and who creates a Demo Entity.

electronic messages. The term “electronic messages” herein refers to messages sent through electronic communication methods. Email, or electronic mail, is an example of an electronic message. Other communication methods for sending data or electronic messages can be used. Non-limiting examples of other communication methods and electronic messages include push notifications, text messages (e.g. using short message service, multimedia messaging service, and enhanced messaging service), and instant messaging. Other types of electronic messages can be used.

Eligible Attendee. The term “Eligible Attendee” herein refers to an individual who is entitled to attend an Event. Examples of embodiments of such individuals include: an individual who has already sent an RSVP that he or she will be attending an Event, a Guest referenced in such an RSVP, an Invitee, a Registrant, and, in the case of an Event associated with a Group, a Member of the Group. In an example of an embodiment, the Administrator may configure the Event so that certain classes of Members or certain individual Members are precluded from sending an RSVP response until specified conditions are satisfied, for example, until a certain number of days prior to the Event. In an example embodiment, the Administrator may configure whether a current Member is to be considered an Eligible Attendee for an Event which has an Event Date after the individual's Membership expiry. In an example of an embodiment, an Event may be Activated by the Administrator, but configured so that no one may send an RSVP or register until a date which has been specified either explicitly or by reference to a period of time prior to the Event Date. In another example of the embodiment, although there is the condition that precludes the Eligible Attendee for sending an RSVP response for the Event until a date prior to the Event Date, the Eligible Attendee is enabled to access and view information about an Event.

Entity. The term “Entity” herein refers to any of a Group, Event or Date Poll.

Entity Details. The terms “Group Details”, “Event Details” and “Date Poll Details” (or more generally referred to as “Entity Details”) herein refer to information entered by the Administrator which describes or provides particulars of the Entity and which may be displayed to a User viewing the Entity Page GUI. Non-limiting examples of such information, in the case of a Group, include: a name of the Group; category/type of Group (e.g. sport/lacrosse); a description of Group; organizer information; contact information; images; and any other Group information that the Administrator may determine. Non-limiting examples of such information, in the case of an Event, include: a name of the Event; a type of the Event; a description of the Event; an Event Date; an Event location; organizer/host information; an “RSVP by” date; images; and any other Event information that the Administrator may determine. Non-limiting examples of such information, in the case of a Date Poll, include: a name of the proposed Event; a type of the proposed Event; a description of the proposed Event; various proposed times for which the proposed Event might be scheduled, a location of the proposed Event, organizer/host information; images; and any other information that the Administrator may determine.

Entity Page GUI. The terms “Group Page GUI”, “Event Page GUI” and “Date Poll Page GUI” (or generically, “Entity Page GUI”) herein refer to the GUI which displays information about the particular Entity. The Entity Page GUI may include Entity Details, Entity Setup Options, User Posts, Reporting and various controls and navigation elements.

Entity Page GUI Link. The terms “Group Page GUI” Link, “Event Page GUI Link” and “Date Poll Page GUI Link” (or more generally referred to as “Entity Page GUI Link”) herein refer to a data link generated by the Event Organizing Software for which the target or destination is a specific Entity Page GUI. This term may be further qualified according to whether it is “Public” or “Personal”. A “Public Entity Page GUI Link” is intended for use by a member of the general public, namely someone who may not have any existing relationship to the Entity and who may not be Logged in, to access an Entity Page GUI for which the Privacy Level is “low”. A “Personal Entity Page GUI Link” is intended for the exclusive use of a particular User and accordingly, the link contains data from which the Event Organizing Software may determine not only the target Entity ID, but also the specific Profile associated with the Entity, and accordingly, the User Account associated with such Profile.

Entity Setup Options. The terms “Group Setup Options”, “Event Setup Options” and “Date Poll Setup Options” (or more generally referred to as “Entity Setup Options”) herein refer to information which is editable by the Administrator and which relates to the creation or configuration of the Entity. In the case of an Event, this may include specifying the maximum number who may attend an Event or how many Guests may be brought by an Eligible Attendee or whether all Users have the right to view the list of Eligible Attendees as well as their RSVP Values.

Event. The term “Event” herein refers to an occurrence or an activity with a specified Event Date. Non-limiting examples of an occurrence or an activity include a meeting, a game, a party, a presentation, a concert, a practice and a lesson. An Event is created by an Administrator, either within the context of a Group or as a One-Off (e.g. a One-Off Event).

Event Date. The term “Event Date” herein refers to when an Event is scheduled to occur. An Event has an Event Date which includes a start date of the Event. In other examples of embodiments, the Event Date may also include any of a start time, an end date, and an end time.

Event Organizing Software. The term “Event Organizing Software” refers to computer readable or processor implemented instructions which are used to perform the functions and features described in the present application.

Family/Department Profile. The term “Family/Department Profile” herein refers to a specialized type of Profile which may identify multiple individuals with a commonality (e.g. family members, or employees within a particular department) and for which a shared, or proxy, email is used. For example, the Profile for “The Thomas Family” may contain the names of a mother, father and three children, but contain only the email address of one parent, who will therefore receive communications, and be able to respond thereto, on behalf of the family. In an example of an embodiment, the Administrator creating a Profile may designate the maximum number of people represented by the Family/Department Profile, but not specify the names of any or all of them. This is advantageous where the Administrator does not know the names of all of the family members or where the Administrator wishes to leave it to the head of a family or a department to decide which members of the family or the department should attend an Event.

Group. The term “Group” herein refers to a set of data which provides a convenient structure for situations involving a group of people, such as those in a club, office, committee or sports team, who schedule periodic meetings, events or games. Examples of Groups may be a “sports group”, a “book club”, a “computer tutorial group”, a “business group”, and a “sales department group”. A Group is the Parent Entity for Events and Date Polls which are associated with such Group. Profiles associated with the Group are referenced by Events and Date Polls associated with the Group. Administrators of the Group are Administrators of all Events and Date Polls within the Group.

Guest. The term “Guest” herein refers to an individual who is a Guest of a Member, Invitee, or Registrant. In an example embodiment, a Guest does not access the Event Page GUI or otherwise RSVP through the Event Organizing Software; rather the Guest is referenced in the RSVP of another Eligible Attendee. In an example embodiment, the Administrator may set limitations to the number of Guests which an individual may bring to an Event.

Invitee. The term “Invitee” herein refers to a Profile which has been designated by the Administrator as an Eligible Attendee of a particular Event. Where such an Event is within the context of a Group, such Invitee is not a Member of the Group at the time that the invitation process is initiated.

Log in. The term “Log in” herein refers to the action whereby a User accesses the Event Organizing Software in such a manner that the Event Organizing Software identifies the User as the holder of an existing User Account, and accordingly, associates the User's session with such User Account. In an example embodiment, the User enters Log in credentials (e.g. email address and password). In another example of an embodiment, the User clicks on a data link (e.g. an Entity Page GUI Link) generated by the Event Organizing Software and emailed to the User's email address, which link is associated with the User Account of the User. In another example of an embodiment, the User clicks on an Entity Page GUI Link, and the User is required to enter further credentials (e.g. a password) in order to Log in. Whatever the method, after Logging in, a User can access information about Entities containing Profiles with which such User Account is associated. In an example embodiment, a User is not required to Log in in order to view Entity Page GUIs which have a Privacy Level of “low”.

Member. The term “Member” herein refers to a Profile within a Group which has been designated by the Administrator as being a Member of the Group. In an example of an embodiment, a newly-created Group has, by default, one class of Members. However, the Administrator of the Group may create additional classes of Membership; whether to reflect the actual Membership structure of the Group or to distinguish among different types of Members in terms of the rights which they are granted on the Event Organizing Software. In another example of an embodiment, an Administrator may configure the Group so that members of the public may access online functionality to become Members.

Messaging. The term “Messaging” herein refers to sending electronic messages to Users or persons with User Accounts, through the Event Organizing Software. For example, an Administrator may transmit an electronic message to all Members of a Group, or to all Eligible Attendees of an Event, or to all Profiles who have sent an RSVP that they will attend an Event. In another example of an embodiment, an Administrator can determine permissions so that Users with access to an Entity Page GUI can also use the associated Messaging functionality.

Minimum Entity Details. The terms “Minimum Group Details”, “Minimum Event Details” and “Minimum Date Poll Details” (or more generally referred to as “Minimum Entity Details”) herein refers to a subset of the corresponding Entity Details representing the mandatory data required in order to save the Entity to the server memory and to assign to it an ID. In an example of an embodiment, Minimum Entity Details of a Primary Entity are the name of the Entity and the category/type of Entity. In addition, the Minimum Entity Details for an Event includes an Event Date, and the Minimum Entity Details for a Date Poll includes one or more Polled Dates.

One-Off. The term “One-Off” is used to describe a Date Poll or Event which is created independently from the context of a Group and which is therefore not associated with a Group. Profiles associated with such One-Off Event or One-Off Date Poll are not available for use with another Group, Event or Date Poll. If a One-Off Event or a One-Off Date Poll is copied, its associated Profiles are also copied, and the copied Profiles are not associated with the original One-Off Event or One-Off Date Poll. This is to be contrasted with a Group Event or a Group Date Poll, which references Profiles associated with its Parent Group. In an example of an embodiment, the “One-Off” approach may be desirable if the User is arranging an isolated Event, such as a birthday party or class reunion. In an example of an embodiment, the Group approach may be desired if a Group has periodic meetings (e.g. for a book club, corporate organization, sports team).

Parent Group. The term “Parent Group” herein refers to the Group which is the Parent Entity of an Event or Date Poll which is associated with such Group.

Polled Date. The term “Polled Date” herein refers to a proposed date, as set out in a Date Poll, on which a currently-unscheduled Event may occur. A Date Poll may have multiple Polled Dates. In an example of an embodiment, a Date Poll has at least one Polled Date. In an example of an embodiment, a Polled Date includes a proposed start date of a currently-unscheduled Event. In other examples of embodiments, a Polled Date may also include any of a start time, an end date, and an end time of the currently-unscheduled Event.

Pollee. The term “Pollee” herein refers to a Profile which has been designated as a recipient of a Date Poll.

Primary Entity. The term “Primary Entity” herein refers to the Entity with which Profiles may be associated. In the case of an Event or Date Poll which is associated with a Group, the Group is the Primary Entity. In the case of a One-Off Event, such One-Off Event is the only Entity and is therefore the Primary Entity. In the case of a One-Off Date Poll, such One-Off Date Poll is the only Entity and is therefore the Primary Entity.

Privacy Level. The term “Privacy Level” herein refers to the level of restrictions limiting who may view a Group Page GUI or an Event Page GUI. For example, a Privacy Level of “low” may indicate that the Entity Page GUI may be viewed by any member of the public.

Profile. The term “Profile” herein refers to a set of data pertaining to an individual person or, in the case of a “Family/Department Profile”, pertaining to a plurality of people. Information which may be stored as part of a Profile includes the unique identifier, name, address, telephone number, email address of an individual person or of a plurality of people and notes about them. In an example of an embodiment, the unique identifier is the email address. In an example embodiment, a Profile is also associated with one Primary Entity and one User Account. A User Account can be associated with multiple Profiles and, thus, multiple Entities. In the case of a Group, there is a Profile for each individual person associated with the Group, including those individuals who are Members, non-Members or former Members. For example, a Profile has membership history for each of these types of individuals, although the membership history is empty for non-Members. Although an example of an embodiment would permit the creation of a Profile which does not contain a unique identifier, a Profile of this type would serve as a placeholder. In an example of an embodiment, a Profile of this type is also not used by the system (e.g. due to the fact that a unique identifier is required to associate the Profile with a User Account). For simplicity, in an example of an embodiment, it is assumed that a Profile must contain a unique identifier of the User.

Registrant/Registration. The term “Registrant” herein refers to a Profile which is associated with an Event as a result of an individual signing up to attend, or “registering for”, such Event. The data submitted in this regard, or the “Registration” is a form of RSVP. This functionality is available only if the Event has a Privacy Level of “low” and the Administrator has enabled “Online Registration by the Public”. In order to become a Registrant, an individual need not have had any prior association with the Group or Event, but may instead be a member of the public who accessed the Registration functionality on the Event Page GUI after clicking a Public Entity Page GUI Link.

Reporting. The term “Reporting” herein refers to the functionality whereby the Event Organizing Software can generate extensive reports relating to a Group, an upcoming Event, a past Event, or a Date Poll, or combinations thereof. For example, reports may include the following information: a headcount (e.g. the number of individuals attending, not attending, maybe attending); a list of individuals associated with each of the headcount values; a summary of responses to survey questions in the RSVP; a summary of who has viewed the Event Page GUI for a particular Event; a list of attendees for a particular Event; a list of Group Members (for example, organized by Membership expiry date); and a report of attendance of Group Members across various Group Events.

RSVP. The term “RSVP” herein refers to a response by a Member or Invitee, who is an Eligible Attendee of an Event. Although there may be other data associated with an RSVP, the essential component is the RSVP Value, being the response as to whether such individual intends to attend the Event. Non-limiting examples of other data that can be provided in a RSVP include the number of Guests, the names of the Guests, responses to survey questions (e.g. questions determined by the Administrator as part of the Setup Options; for example, relating to food allergies, seating preferences, what position the User plays in a sport, etc.), and comments. The Registration of a Registrant is a specialized form of RSVP which initially supports a RSVP Value of either “in” or “waiting list” (if the Event is full), but which, following submission, can be “cancelled”, which is equivalent to an RSVP response of “out”.

RSVP GUI. The term “RSVP GUI” herein refers to the GUI which displays the online form by which an Eligible Attendee may send an RSVP to an Event. A Registration is a specialized form of RSVP.

RSVP Value. The term “RSVP Value” herein refers to the response of an Eligible Attendee to the specific question of whether he or she will attend a particular Event. Possible RSVP Values are “in” (e.g. will attend), “out” (e.g. will not attend), “maybe” (e.g. undecided), “waiting list” (e.g. which is applicable if the Event is configured to allow a maximum number of attendees, and such cap has already been met, rendering “in” and “maybe” non-selectable) or “no reply” (e.g. has not yet RSVP'd). In the case of a Family/Department Profile, the RSVP may contain separate fields to designate whether each individual identified in the Family/Department Profile is attending. In an example of an embodiment, the RSVP Value for a Family/Department Profile might be shown as “multiple”. In an example of an embodiment, an RSVP Value might have an associated number to indicate the number of individuals represented by this value (e.g. In [3]) to signify an Eligible Attendee who is attending with two Guests). Although not strictly an RSVP Value, the Event Organizing Software might show “ineligible” in the RSVP Value column for a User who is able to view information about an Event but who is not an Eligible Attendee. Similarly, it might show “not Activated” where the Event is listed in a report being viewed by a User who is Administrator. In an example embodiment, the RSVP Value for a Registrant may be “Registered” (e.g. equivalent to “in”) or “cancelled” (e.g. equivalent to “out”).

User. The term “User” herein refers to an individual who uses the Event Organizing Software.

User Account. The term “User Account” herein refers to data used by the Event Organizing Software to identify a User. Data comprising the User Account includes, for example, a unique identifier of the user and a password of the User and may contain other personal information of the User, such as its name and address. In an example of an embodiment, there may be only one User Account associated with the unique identifier. In an example of an embodiment, the unique identifier is an email address of the user, although other information to uniquely identify the user can be used instead of or in addition to the email address. Non-limiting examples of the unique identifier include a phone number, a name, a serial number, and an instant messaging identifier. A Profile is associated with one Primary Entity and, by virtue of a common unique identifier, with one User Account. Through this association, User Accounts are associated with Primary Entities.

User Home Page GUI. The term “User Home Page GUI” herein refers to the GUI which may be accessed by a User who is logged in to the Event Organizing Software and which GUI displays information about Entities with which the User Account is associated, including data links to facilitate access to such Entities. In an example of an embodiment, the User Home Page GUI also displays information about Entities with a Privacy Level of “low”, in which the User has indicated interest or chosen to “follow”.

User Mode. The terms “User Mode” and “Administrator Mode” herein refer to the two alternative Modes in which an Entity Page GUI may be viewed. When viewed in User Mode, the Entity Page GUI contains information and controls intended for viewing or use by a User who either is not an Administrator or who is not currently engaged in performing administrative functions. In User Mode, the elements displayed may be restricted based on the viewing rights or permissions applicable to that User. In an example embodiment, viewing rights are among the Setup Options which may be set by the Administrator. Certain restrictions may also follow from the current state, or Activation Status, of the Entity; for example, an Entity which has not been Activated may be seen only by Administrators and therefore cannot be viewed in User Mode. When viewed in User Mode, the Entity Page GUI offers no administration functionality.

User Posts. The term “User Posts” refers to Posts or messages submitted by Users for display on a particular Entity Page GUI.

### Architecture Overview

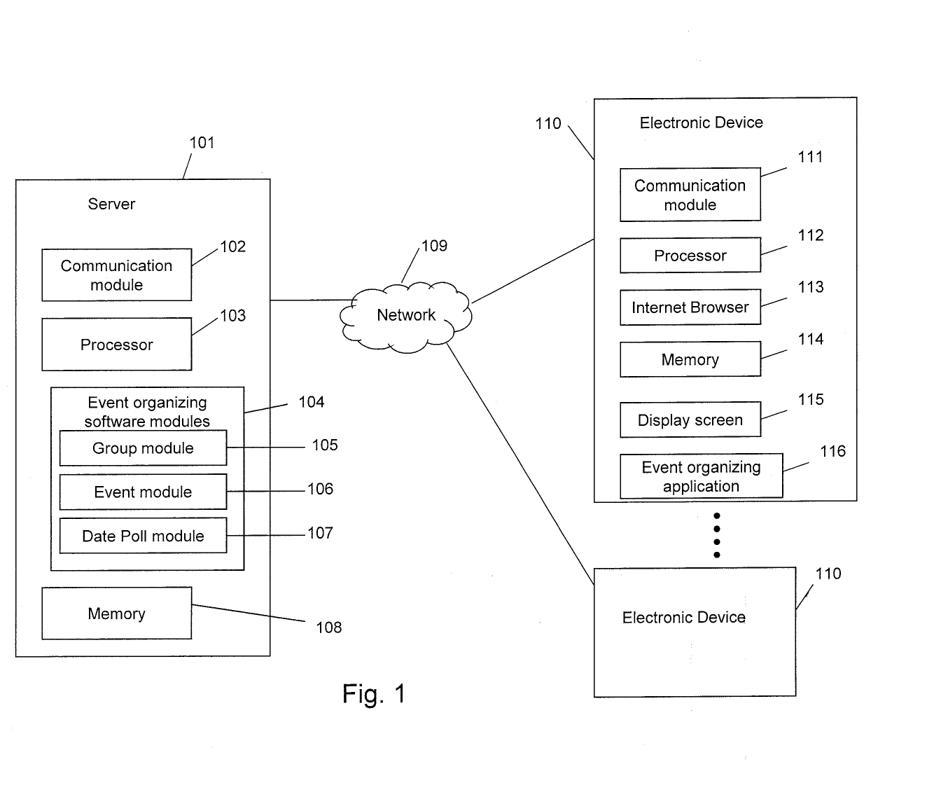

Turning to FIG. 1, an example system configuration is provided for using the Event Organizing Software. A computing device, hereon referred to as a server 101, is provided. It includes software modules 104 for organizing Events and Groups. For example, it includes a Group module 105, an Event module 106 and a Date Poll module 107. Other modules or organization of the software can be used.

The server 101 includes memory 108, a processor 103, and a communication module or device 102. The communication device 102 is used to exchange data over a network 109 with other electronic devices 110. Multiple electronic devices 110 can communicate with the server 101 over the network 109 and interact with the software 104. The network 109, for example, can be the Internet.

Various electronic devices can be used with the example embodiments described herein. Examples of applicable electronic devices include pagers, tablets, cellular phones, cellular smart-phones, wireless organizers, personal digital assistants, computers, laptops, handheld wireless communication devices, wirelessly enabled notebook computers, camera devices, the like, and other types of devices which may not yet have been developed. Such devices will hereinafter be generally referred to as “mobile devices”. It will, however, be appreciated that the example embodiments described herein are also suitable for other devices, e.g. “non-mobile” devices. The non-mobile devices may include, for example, a desktop computer. More generally, both non-mobile and mobile devices are referred to as “electronic devices”.

In an example embodiment, the electronic device 110 includes a communication module 111. For example, it can include a Modem, a wireless radio suitable for communicating over a cellular network, Bluetooth devices, a WiFi radio, or any other currently known or future known communication devices.

In an example of an embodiment, the electronic device is configured to communicate with the network in accordance with the Global System for Mobile Communication (GSM) and General Packet Radio Services (GPRS) standards, which is used worldwide. Other communication configurations that are equally applicable are the 3G and 4G networks such as EDGE, UMTS and HSDPA, LTE, Wi-Max, etc. New standards are still being defined, but it is believed that they will have similarities to the network behaviour described herein. It will also be understood by persons skilled in the art that the examples of embodiments described herein are intended to use any other suitable standards that are developed in the future. In an example of an embodiment, the wireless link connecting the communication module with the network represents one or more different Radio Frequency (RF) channels, operating according to defined protocols specified for GSM/GPRS communications.

The electronic device also includes a processor 112, an Internet browser 113, and memory 114. In an example embodiment, the electronic device further includes an event organizing application 116 which can display and process data used for the Event Organizing Software. The electronic device is either connected to a display screen 115 or includes a display screen. For example, tablets, laptops, and mobile devices are electronic devices that are integrated with a display screen. Other devices for displaying graphics and User interfaces can be used.

It will be appreciated that any module or component exemplified herein that executes instructions or operations may include or otherwise have access to computer readable media such as storage media, computer storage media or removable and/or non-removable data storage devices such as, for example, magnetic disks, optical disks, or tapes. Computer storage media may include volatile and non-volatile, removable and non-removable media implemented in any method or technology for storage of information, such as computer readable instructions, data structures, program modules, or other data, except transitory propagating signals per se. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by an application, module, or both. Any such computer storage media may be part of the server 101 or electronic device 110, or accessible or connectable thereto. Any application or module herein described may be implemented using computer readable/executable instructions or operations that may be stored or otherwise held by such computer readable media.

A number of the operations and methods described herein are within the context of GUIs, and that the operations and methods related to the GUIs include computer executable or processor implemented instructions. The computer executable or processor implemented instructions in some cases are shown, and in other cases, are not shown, in the context of flow diagrams.

The GUIs described herein are shown on a display screen 115 on a User's electronic device or connected to the User's electronic device. In an example of an embodiment, the GUIs, or the computer executable or processor implemented instructions for generating the GUIs, are provided by the server 101. In an example embodiment, the GUIs are shown in a web or Internet browser 113. In another example of an embodiment, the GUIs, or the computer executable or processor implemented instructions for generating the GUIs, are shown on the event organizing application 116 residing on the User's electronic device.

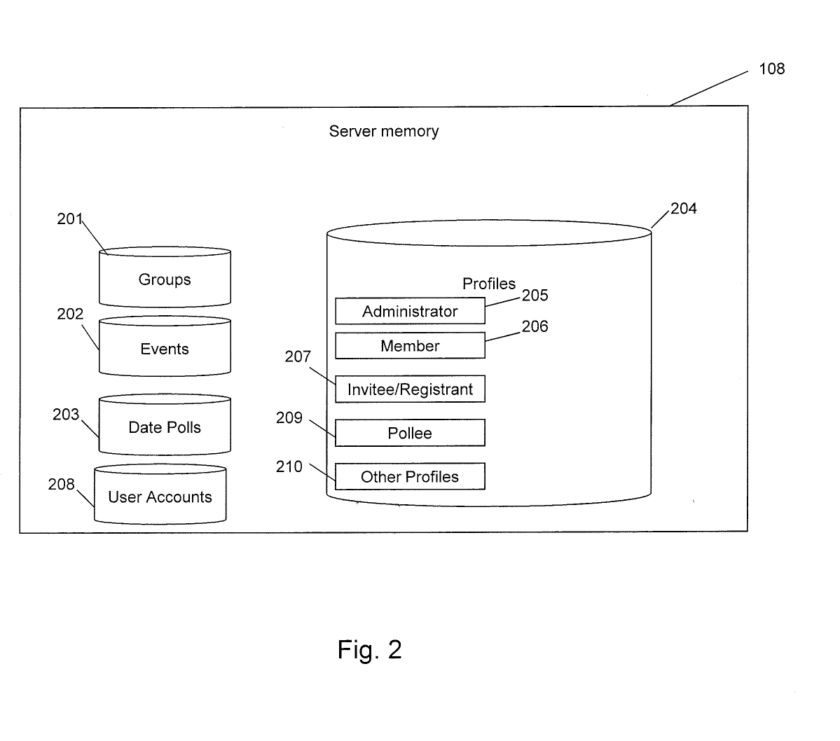

Turning to FIG. 2, example components of the server memory 108 are shown. The server memory includes a Groups database 201, an Events database 202, a Date Polls database 203 and a Profiles database 204 The Groups database 201 stores information pertaining to the various Groups, including Group Details and Group Setup Options. Each Group is represented by a Group ID, and any information associated with the Group is associated with the Group D. The Events database 202 stores information about each Event.

The Events database 202 stores information pertaining to the various Events, including Event Details and Event Setup Options and, in the case of an Event which is associated with a Group, the Group ID. Each Event is represented by an Event ID, and any information associated with the Event is associated with the Event ID.

The Date Polls database 203 stores information pertaining to the various Date Polls, including Date Poll Details and Date Poll Setup Options and, in the case of a Date Poll which is associated with a Group, the Group ID. Each Date Poll is represented by a Date Poll ID, and any information associated with the Date Poll is associated with the Date Poll ID.

The Profiles database 204 stores information pertaining to the various Profiles, such as name, contact information, and Membership history, including the ID of the Primary Entity with which a Profile is associated. Multiple names may be stored in a Profile if it is of the Family/Department Profile type. Each Profile is represented by a Profile ID, and any information associated with the Profile is associated with the Profile ID. Other types of information associated with each Group, Event, Date Poll, or combination thereof are described below or shown in the accompanying figures.

The server memory 108 also includes a database of User Accounts 208. Each User Account is identified by a unique identifier, such as an email address. The User Accounts database stores information about each User Account including email address, password (encrypted) and other information to facilitate validation of credentials, as well as other information related to the User, such as the User's phone number and mailing address. In an example of an embodiment, a User may link his or her User Accounts so that, upon logging in under one User Account, the User Home Page GUI will be display a consolidated view of the information pertaining to all such linked User Accounts.

Different roles for a Profile can include, for example, Administrator 205, Member 206, Invitee/Registrant 207 and Pollee 209. The roles for the Profiles are dependent on the type of Entity to which the Profile is associated. For example, a Member role is in relation to a Group; an Invitee/Registrant role is in relation to an Event; and a Pollee role is in relation to a Date Poll. There may be other roles for a Profile 210. The Administrator role can be in addition to any of the roles for the same Profile. This Profile information is associated with a User Account.

### Relationship of Users to Entities

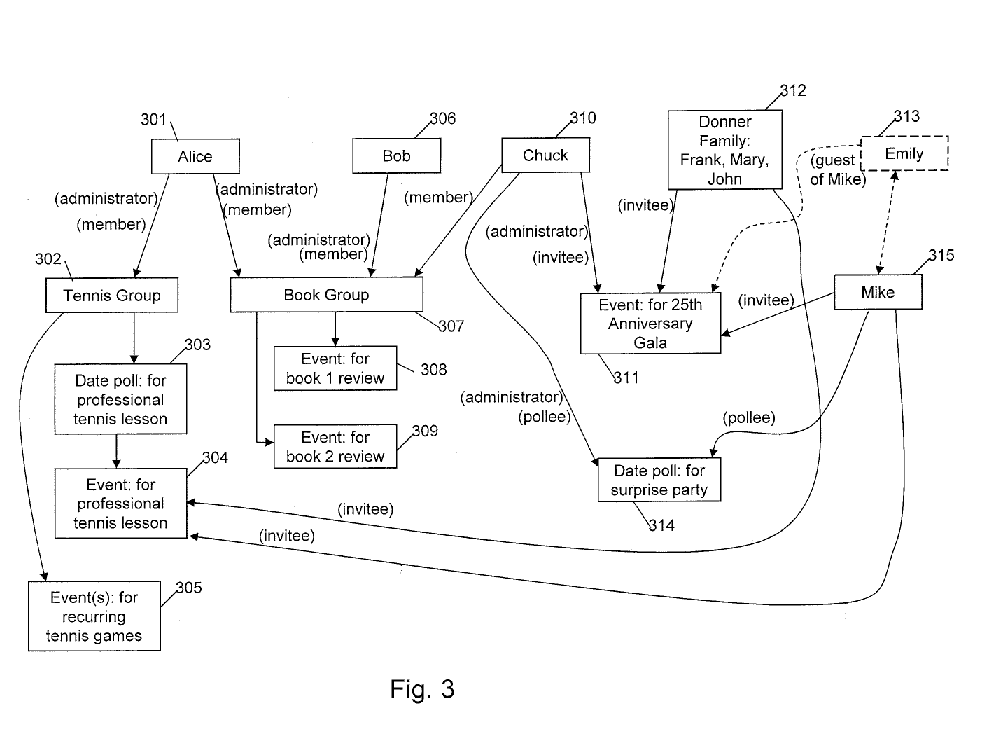

Turning to FIG. 3, an example embodiment is provided of Users (e.g. Alice, Bob, Chuck, Mike and the Donner Family) and their relationship to Groups, Events and Date Polls. Alice 301 is a User who is an Administrator and Member of the Tennis Group 302. In other words, her User Account is associated with a Profile of the Tennis Group, and such Profile has been designated as an Administrator and a current Member.

Within the Tennis Group, a Date Poll 303 (e.g. for a professional tennis lesson Event) is created. Selected Profiles within the Tennis Group are designated as Pollees, and can respond to the Date Poll. In an example embodiment, an address book containing contact information of Members and other past Invitees of the Tennis Group is presented, allowing the Administrator to designate Profiles from the address book as Pollees. The Administrator can convert the Date Poll into an Event 304 for the professional tennis lesson, such that relevant information provided in the Date Poll (possibly including one of the proposed dates set out in the Date Poll) is applied to the new Event. Members of the Tennis Group are by default, Eligible Attendees of the professional tennis Event 304, and may send an RSVP. For example, Profiles of Members of the Tennis Group are automatically obtained and associated with the professional tennis Event 304, or any other Entity created within context of the Tennis Group.

Another Profile of the Group is that of Mike 315. Another Profile of the Group is that of the Donner Family 312, which is a Family/Department Profile containing the names of three individuals—Frank Donner, Mary Donner and John Donner. Although neither the Mike Profile nor the Donner Family Profile are Members of the Tennis Group, they are invited to attend (e.g. they are Invitees) the Event 304 for the professional tennis lesson. Notwithstanding that the Donner Family consists of three individuals, it is possible that only a subset (e.g. Frank Donner and Mary Donner) will attend the Event. Multiple Events can be associated with the Tennis Group, including recurring tennis games 305. Members of the Tennis Group are Eligible Attendees of each Event created within the Tennis Group.

Continuing with FIG. 3, both Alice 301 and Bob 306 are Users that are both Administrators and Members of a Book Group 307. There can be more than one Administrator for a Group. Chuck 310 is another User who is a Member of the Book Group, but is not an Administrator. Multiple Events are associated with the Group 307, such as various book review Events 308, 309. Members of the Book Group are Eligible Attendees of each Event created within the Book Group.

Chuck 310 is also an Administrator and Invitee of a One-Off Event for a 25^{th} Anniversary Gala 311. Mike 315 is an Invitee of the One-Off Event 311. Mike 315 also invites a Guest 313, named Emily, to attend the Event 311. As a Guest, Emily does not need to be a User of the Event Organizing Software and does not interact with the Event Organizing Software. As no interaction is required, Emily's association to the Event 311 is shown in dotted lines.

Continuing with FIG. 3, Chuck 310 is also an Administrator and Pollee of a One-Off Date Poll 314 for a proposed Surprise Party. Mike 315 is selected by the Administrator to be a Pollee of the One-Off Date Poll 314.

It can therefore be appreciated that the Event Organizing Software 104 can accommodate many different Groups, Events and Date Polls involving many Users. Furthermore, the Event Organizing Software may have many Users who are associated with many Entities in which they have varying roles. The Event Organizing Software conveniently manages this complexity and ultimately gives each User a perspective on the Entities in which he or she is involved, even though such Entities may be completely unrelated to one another and managed by different Administrators. Thus the Event Organizing Software provides a simple way to organize, view information about, and communicate in relation to Groups, Events and Date Polls in which a User is involved.

### Home Page of Event Organizing Software

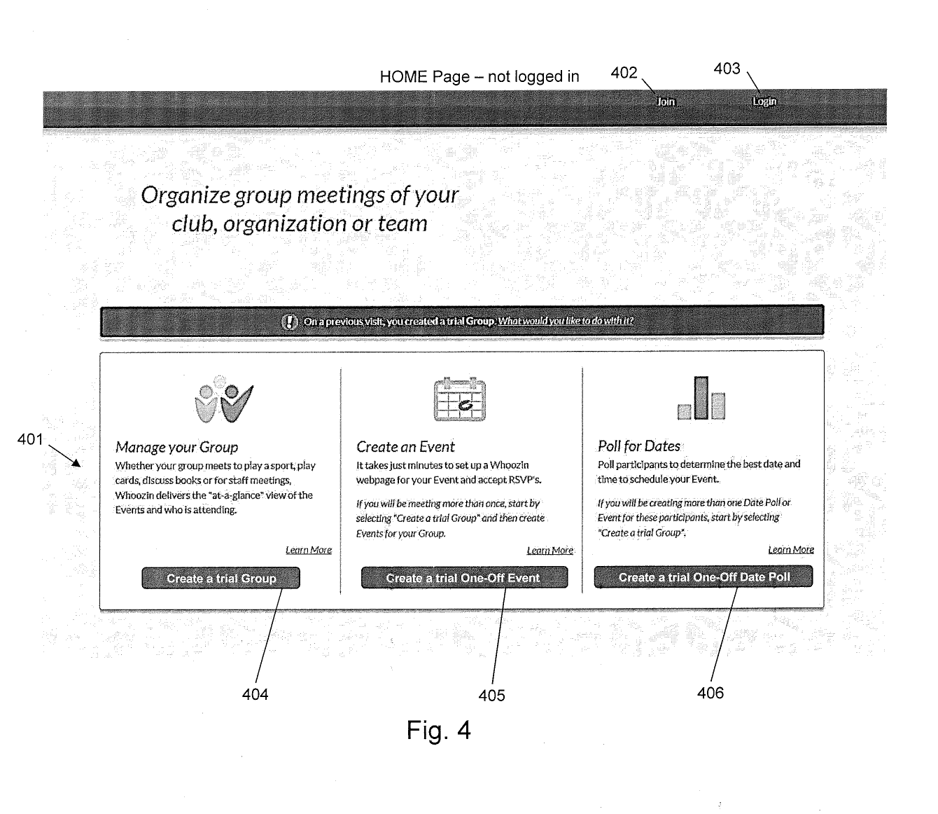

Turning to FIG. 4, an example embodiment of a Home Page graphical user interface (GUI) 401 for the Event Organizing Software is provided. Such a GUI is generated by the server 101 and displayed on an electronic device 110 when a User accesses the Event Organizing Software. In particular, a control 403 is provided in the home page GUI for a User with an existing User Account to Log in. After successful validation of the login credentials, the User Home Page GUI is displayed. A control 402 is also provided for a new User to create a User Account.

Controls are provided on the home page of the Event Organizing Software for a Demo User to create a Group 404 (including associated Events and Date Polls) or a One-Off Event 405 or One-Off Date Poll 406, without first Logging in or creating a new User Account.

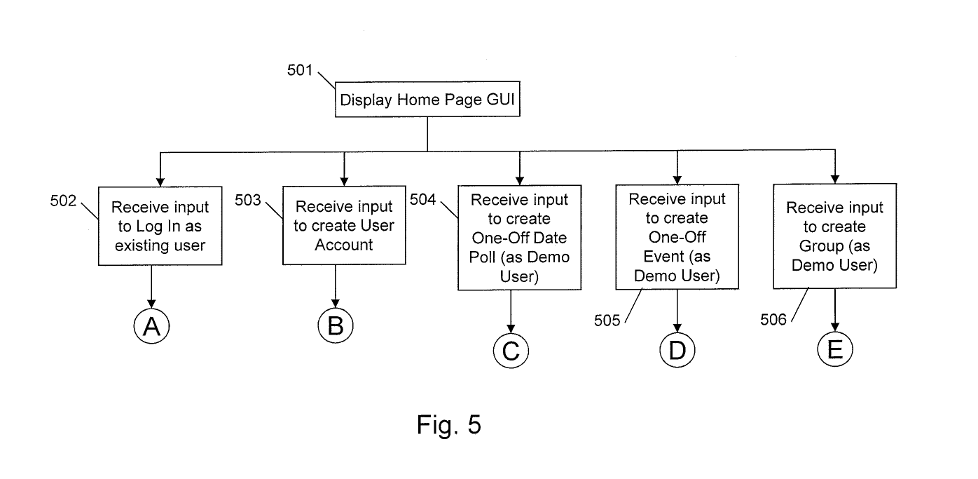

Turning to FIG. 5, an example of an embodiment of computer executable or processor implemented instructions are provided. At block 501 the server causes the Home Page GUI to be displayed. As described above, options are provided such that the server can receive any one of: an input to Log In as an existing user (block 502), which leads to further actions represented as circle “A”; an input to create a User Account (block 503), which leads to further actions represented as circle “B”; an input to create a One-Off Date Poll as a Demo User (block 504), which leads to further actions represented as circle “C”; an input to create a One-Off Event as a Demo User (block 505), which leads to further actions represented as circle “D”; and an input to create a Group as a Demo User (block 506), which leads to further actions represented as circle “E”.

### User Home Page GUI

The User Home Page GUI is presented to a User who has Logged in, for example, including by way of an Entity Page GUI Link. Once Logged in, if the User navigates away from the User Home Page GUI, he can easily return to it by clicking the “My Groups and Events” link.

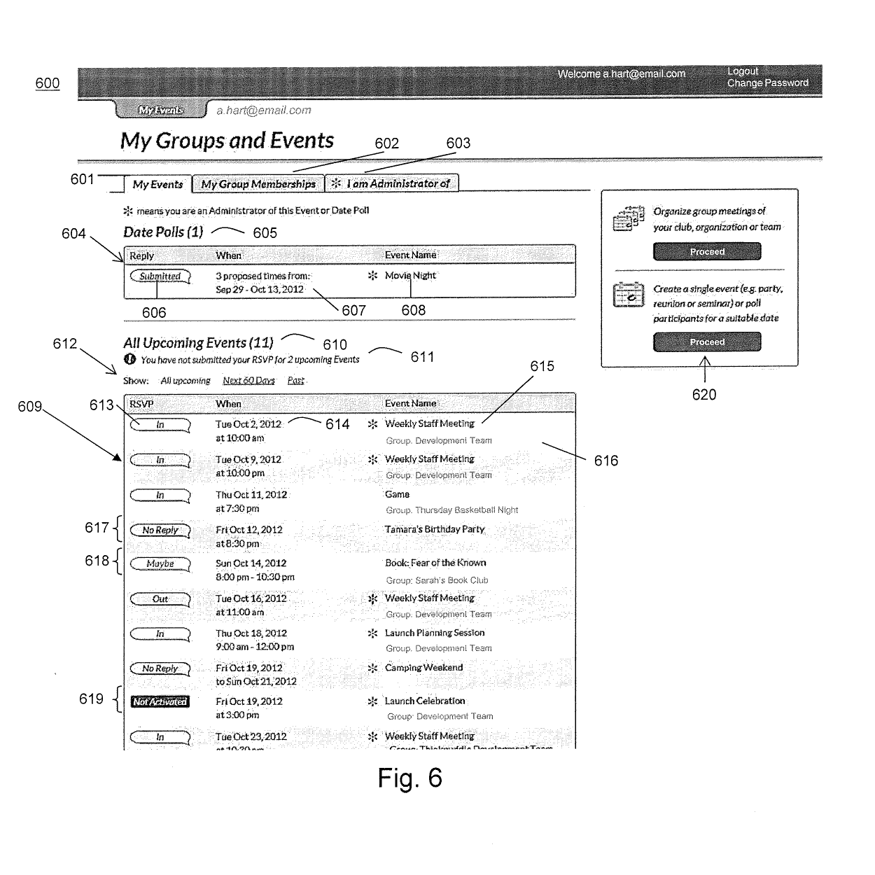

Turning to FIG. 6, an example embodiment of a User Home Page GUI 600 is provided. The User Home Page GUI is displayed on an electronic device when a User Logs in to the Event Organizing Software. The User Home Page GUI contains tabs for “my Events” 601, “my Group Memberships” 602, and “I am Administrator of” 603. There are also options to create a new Group or a new One-Off Event or a new One-Off Date Poll 620.

### “My Events” Tab

When the “my Events” tab is actively shown, qualifying Date Polls and Events (both One-Off and those which are associated with a Group) are displayed. For this purpose, a Date Poll qualifies if it is current, for example if at least one of the Polled Dates in the Date Poll has not yet passed, and the User Account is associated with a Profile that is either a Pollee or an Administrator of the Date Poll. An Event qualifies if it is or was scheduled within the specified date range and the User Account is associated with a Profile that is either an Eligible Attendee or an Administrator of the Event.

Continuing with FIG. 6, the “my Events” tab 601 is selected. The Date Poll section includes a heading indicating the number of qualifying Date Polls 605 as well as a table 604 which displays the following particulars of qualifying Date Polls: the Date Poll Response Value 606; summary information regarding the Polled Dates 607; the name of the proposed Event 608; and the associated Group, if any. In addition, an alert is displayed if the User is a Pollee of one or more Date Polls to which he has not yet submitted a Date Poll Response.

The summary information regarding the Polled Dates includes, for each Date Poll listed, the number of Polled Dates and the range of dates they cover. For example, if there are four Polled Dates in a Date Poll, then only the first and last of the dates are displayed. In an example of an embodiment, full detail as to Polled Dates is displayed if the mouse hovers over the entry.

If the User clicks on an entry in the table 604, the corresponding Date Poll Page GUI is presented. Provided that the User is entitled to view the Date Poll Page GUI in User Mode (i.e. the Date Poll Response Value is not “not Activated” or “ineligible”), then the page is presented in User Mode; otherwise it is presented in Administrator Mode.

The Event section includes a heading indicating the number of qualifying Events 610 as well as a table 609 which displays the following particulars of qualifying Events: the User's RSVP Value 613 (e.g. “in”), the Event Date 614, the Event name 615, and the associated Group 616, if any. In addition, an alert 611 is displayed if the User is an Eligible Attendee of one or more Events to which he has not yet submitted an RSVP. The alert may also specify the number of upcoming Events to which the User has not yet submitted a response.

If the User clicks on an entry in the table 609, the corresponding Event Page GUI is presented. If the RSVP Value is “ineligible” and the User involvement does not satisfy the requirements of the Privacy Level setting, or if the Event has not been Activated, the Event Page GUI will be opened in Administrator Mode; otherwise it is presented in User Mode.

Another example of an Event entry 617 in the table 609 shows that the RSVP Value is “No Reply”, the Event Date (e.g. including time), and the Event name. In this example entry 617, the Event is not associated with a Group and, therefore, no Group name is displayed.

Another example Event entry 618 shows the RSVP Value is “maybe”, the Event Date, the Event name (e.g. “Book: Fear of the Known”), and the associated Group (e.g. “Sarah's Book Club”).

Another example Event entry 619 shows that the RSVP Value is “Not Activated”. Although the Event is Not Activated, the proposed Event Date, proposed Event Name, and the associated Group is shown. In an example embodiment, a “Not Activated” Entity is only visible in GUIs while in Administrator Mode. In an example embodiment, an non-activated Entity will appear on the User Home Page GUI only if that user is the Administrator of such non-activated Entity.

### “My Group Memberships” Tab

When the “My Group Memberships” tab 602 is actively shown, Groups in which a Profile associated with the User Account is a current Member, are displayed.

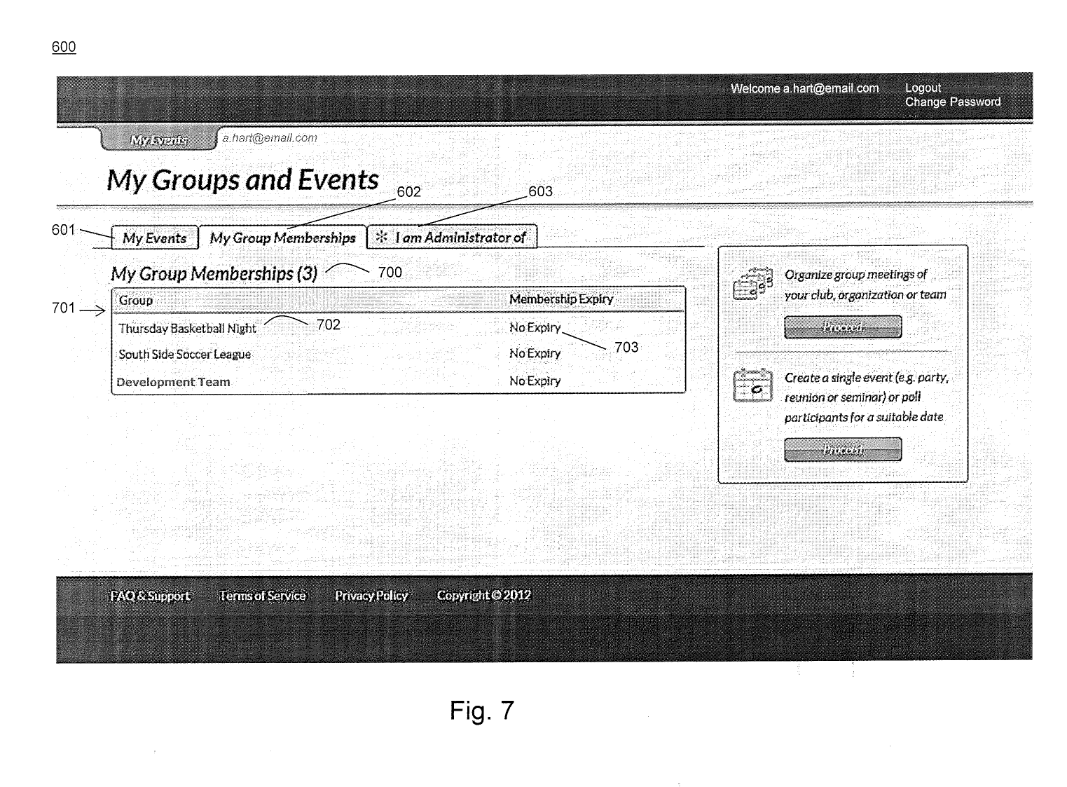

An example embodiment of the User Home Page GUI 600 showing a User's Group Memberships is shown in FIG. 7. It includes a heading indicating the number of such Groups 700 as well as a table 701 which displays the following particulars for each such Group: the name of the Group 702, the name of the class of Membership if the Administrator has created more than one class of Members, and the expiry date 703, if any, of the Membership.

If the User clicks on an entry in the table, the corresponding Group Page GUI is presented in User Mode.

### “I am Administrator” Tab

When the “I am Administrator of tab” 603 is actively shown, Groups, One-Off Events, and One-Off Date Polls (i.e. the Primary Entities) in which a Profile associated with the User Account is an Administrator, are displayed.

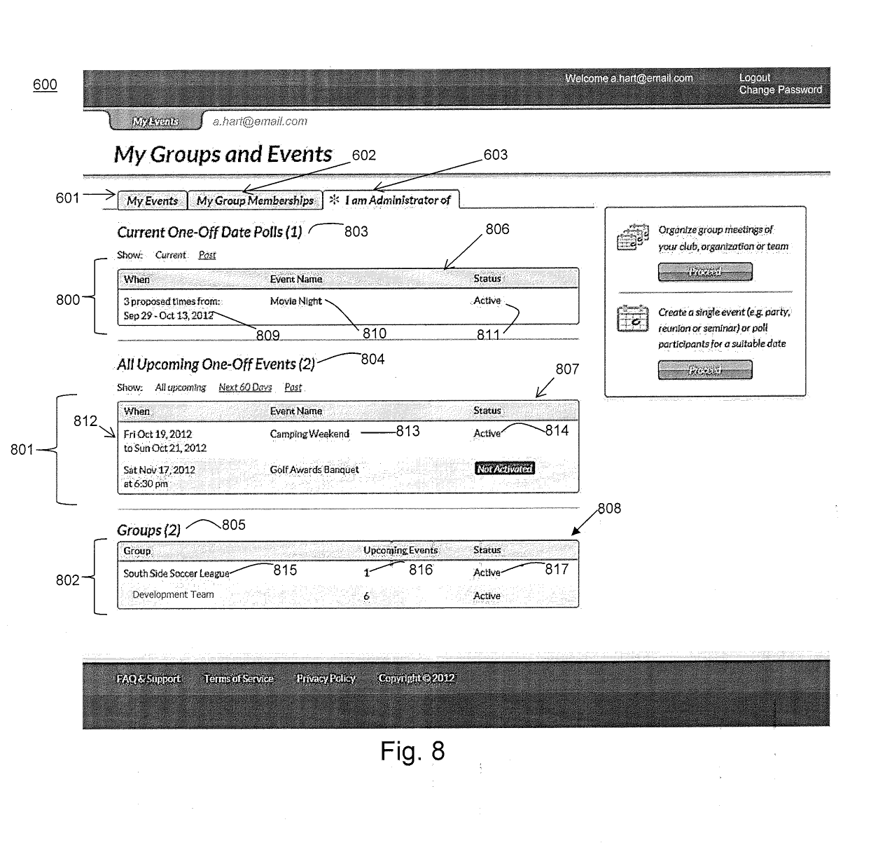

An example embodiment of the “I am Administrator of” tab 603 of the User Home Page GUI 600 is shown in FIG. 8. It includes separate sections for One-Off Date Polls 800, One-Off Events 801 and Groups 802. Each such section includes a heading indicating the number of such Entities 803, 804, 805 as well as a table 806, 807, 808 with particulars.

The table 806 listing One-Off Date Polls for which the User is an Administrator contains columns for summary information 809 regarding the Polled Dates (using the same format as described for the “my Events” tab), the Event name 810, and the Activation Status 811 of the Date Poll. The table 807 listing One-Off Events for which the User is an Administrator contains columns for the Event Date 812, the Event name 813, and the Activation Status 814 of the Event. The table 808 listing Groups for which the User is an Administrator contains columns for the Group name 815, the number of upcoming Events of the Group 816, and the Activation Status of the Group 817.

If the User clicks on an entry in any of the three tables 806, 807, 808, the corresponding Entity Page GUI will be presented in Administrator Mode.

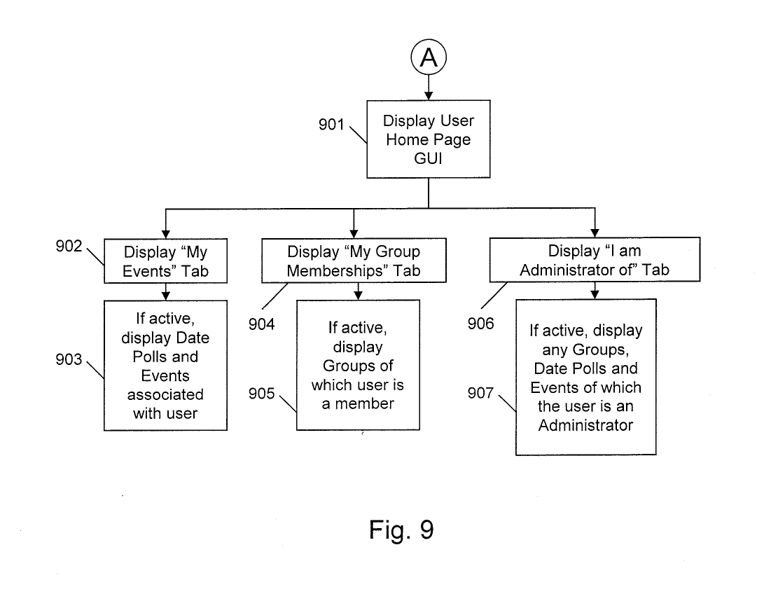

Turning to FIG. 9, an example embodiment of computer executable or processor implemented instructions are provided for displaying different aspects of the User Home Page GUI. The process continues from circle “A” in FIG. 5. At block 901, the server causes the User Home Page GUI to be displayed. This includes displaying the “My Events” tab (block 902), the “My Group Memberships” tab (block 904), and the “I Am Administrator of” tab (block 906). If the “My Events Tab” is active, then the Date Polls and Events associated with the User are shown (block 903). If the “My Group Memberships” tab is active, then the Groups of which the User is a Member are shown (block 905). If the “I Am Administrator of” tab is active, then any Groups, One-Off Date Polls, and One-Off Events of which the User is an Administrator are shown (block 907).

### User Accounts, Entities and Profiles (Creation and Activation)

A User Account is created upon a User completing the process to “create User Account” or “join”. The User, for example, provides an email address amongst other information. The process for creating a User Account can be invoked at circle “B”, using the Home Page GUI, in FIG. 5. In addition, each time that a Profile is created in association with a Primary Entity, it is also associated with the User Account having the same email address; and if no such User Account is already in existence, a new User Account, containing the same email address as the new Profile, will be automatically created by the Event Organizing Software.

Each Profile is associated with a single Primary Entity and with a single User Account. Also, it should be noted that Profiles (and therefore, User Accounts) may be created by third parties. For example, in order to add them as Invitees to an Event, User “A”, the Administrator, may create Profiles for User “B” and User “C”, and if such Profiles cannot be associated with existing User Accounts, then new User Accounts will be created for User “B” and User “C”.

Similarly, if an Event supports “Online Registration by the Public”, then upon submission of a Registration, a Profile is created unless one already exists for that name and email address. If a new Profile is created, the above steps are followed so that the Profile is associated with the User Account for that email address, if one exists; otherwise, a new User Account is automatically created and associated with the Profile for which the Registration was submitted. A randomly generated password is generated for each automatically created User Account.

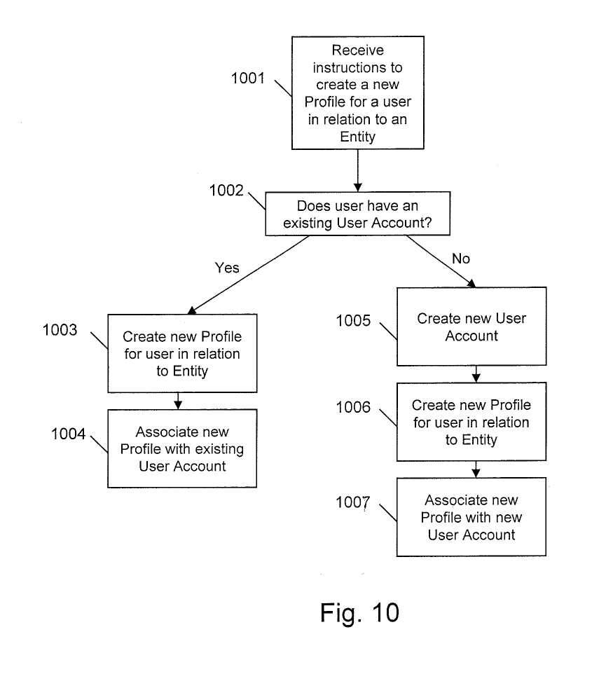

Turning to FIG. 10, an example embodiment of computer executable or processor implemented instructions are provided for creating a new Profile and, under certain circumstances, a new User Account. At block 1001, the server receives instructions to create a new Profile for a User in relation to an Entity. The server determines whether or not the User has an existing User Account (block 1002). If so, then the server creates a new Profile for the User in relation to the Entity (block 1003) and associates the Profile with the existing User Account (block 1004). If not, then the server creates a new User Account (block 1005), creates a new Profile for the User in relation to the Entity (block 1006), and associates the new Profile with the new User Account (block 1007). In this way, a new User Account is automatically created if needed when generating a Profile.

A User Account may be associated with many Profiles reflecting the fact that a User may have involvement in many Groups, Events and Date Polls. The nature of the User's involvement, for example, Member, Invitee, Registrant, Pollee, or Administrator, may vary among such plurality of Entities. For example, a User may be an Administrator and Member of one Group, a Registrant for an Event within another Group and an Invitee of a One-Off Event.

One User Account can be associated with a particular email address, but such User Account can be associated with many Profiles within many Primary Entities. Therefore, different unrelated Administrators can create Profiles for the same individual within different Primary Entities, and such Profiles, in order to be identified, need not share any common information other than the email address, even the name of the individual may vary. Also, when an individual Logs in, the Event Organizing Software can identify the Profiles sharing the same email address as the User Account, and proceed to display information about the various Groups, Events and Date Polls with which the User Account is associated. It is by virtue of this relationship structure that the Event Organizing Software is able to present the information present in the User Home Page GUI.

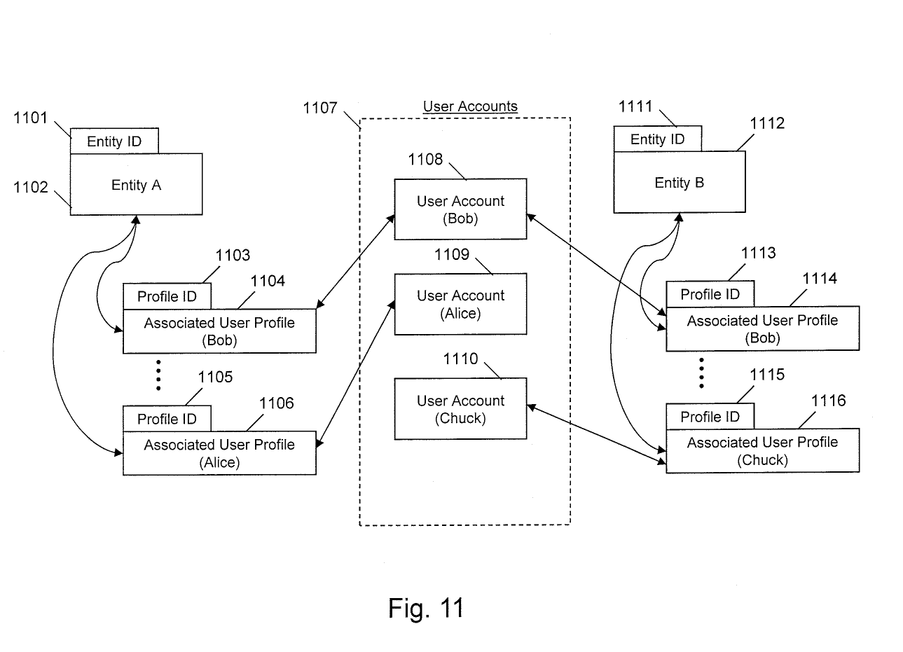

An example of an embodiment showing the data relationships between User Accounts, Profiles and Entities is shown in FIG. 11. Entity A (1102) has an Entity ID (1101). Entity A (1102) is associated with a User Profile for Bob (1104), which is identified by a Profile ID (1103). The User Profile for Bob (1104) is also associated with, or linked to, a User Account for Bob (1108). Another User Profile for Alice (1106), having its own Profile ID (1105), is associated with the Entity A (1102). The User Profile for Alice (1106) is also associated with, or linked to, a User Account for Alice (1109).

There may be multiple User Accounts 1107, and each one may be linked to one or more Profiles. The User Account for Bob (1108) is linked to a second User Profile (1114), having a Profile ID (1113); the User Profile for Bob (1114) is associated with Entity B (1112) having its own Entity ID (1111). Another User Profile for Chuck (1116), identified by a Profile ID (1115), is also associated with the Entity B (1112). The User Profile for Chuck (1116) is also linked to the User Account for Chuck (1110).

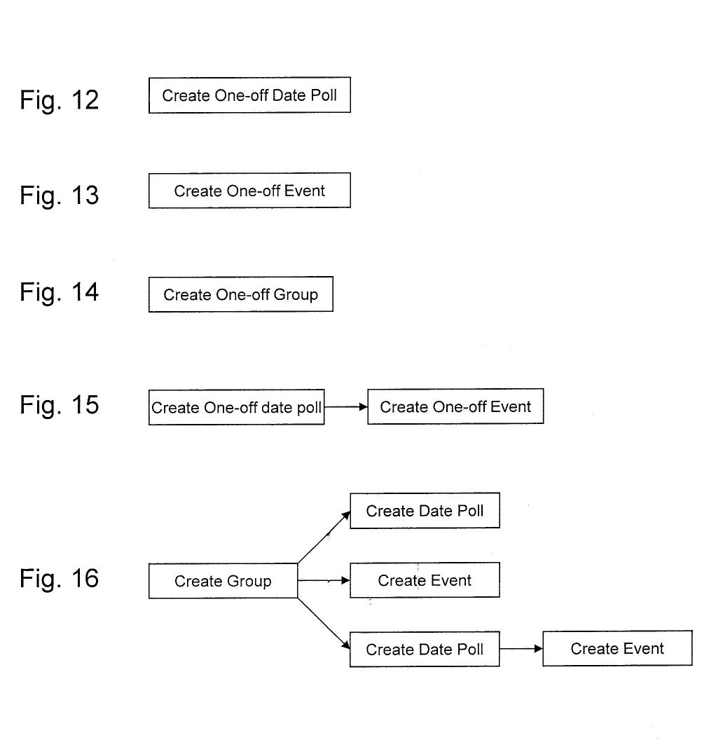

FIG. 12 to FIG. 16 show processes for creating different types of data objects using the Event Organizing Software, specifically Groups, Events and Date Polls. In some example embodiments, Events and Date Polls can be created independently (as One-Offs), and in some other example embodiments, such data objects are created in association with a Parent Group.

Turning to FIG. 12, a One-Off Date Poll can be created as a Primary Entity. For example, a User can create a new Date Poll, enter Date Poll Details and Date Poll Setup Options, add Profiles (which are Pollees), and Activate the Date Poll. After Activating the Date Poll. the Event Organizing Software will send email notification of the Date Poll, containing Personal Date Poll Page GUI Links, to Pollees. In an example of an embodiment, this process is a continuation of circle “C” from FIG. 5.

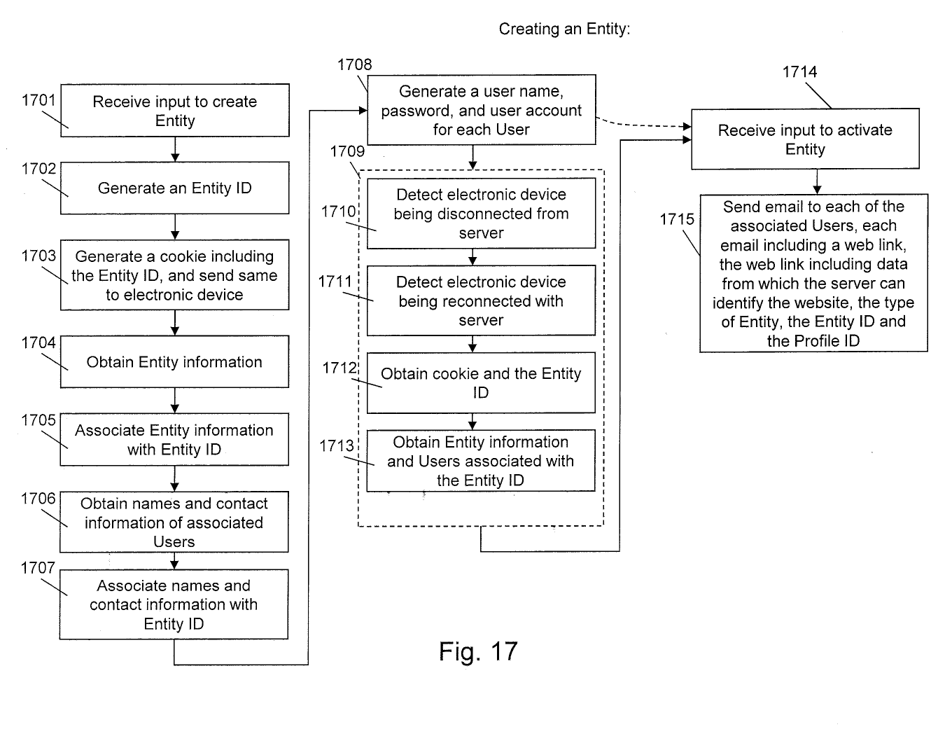

Turning to FIG. 13, in another example embodiment, a One-Off Event can be created as a Primary Entity. For example, a User can create a new Event, enter Event Details and Event Setup Options, add Profiles (which are Invitees), and Activate the Event, whereupon the Event Organizing Software will send an email notification of the Event, containing Personal Event Page GUI Links, to Invitees. In an example of an embodiment, this process is a continuation of circle “D” from FIG. 5.

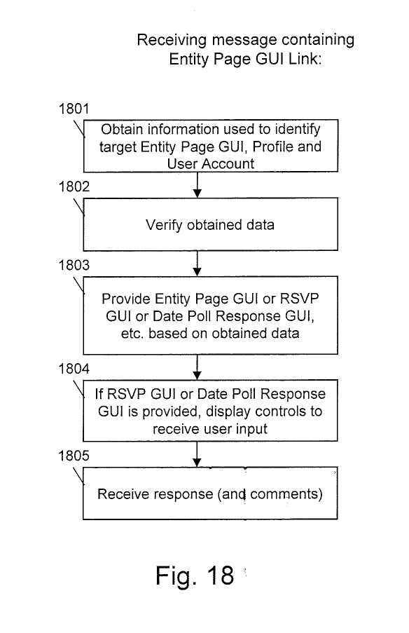

Turning to FIG. 14, in another example of an embodiment, a Group can be created. For example, a User can create a new Group, enter Group Details and Group Setup Options, add Profiles (which are Members), and Activate the Group, whereupon the Event Organizing Software will send email notification of the Group, containing Personal Group Page GUI Links, to Members. In an example of an embodiment, this process is a continuation of circle “E” from FIG. 5.

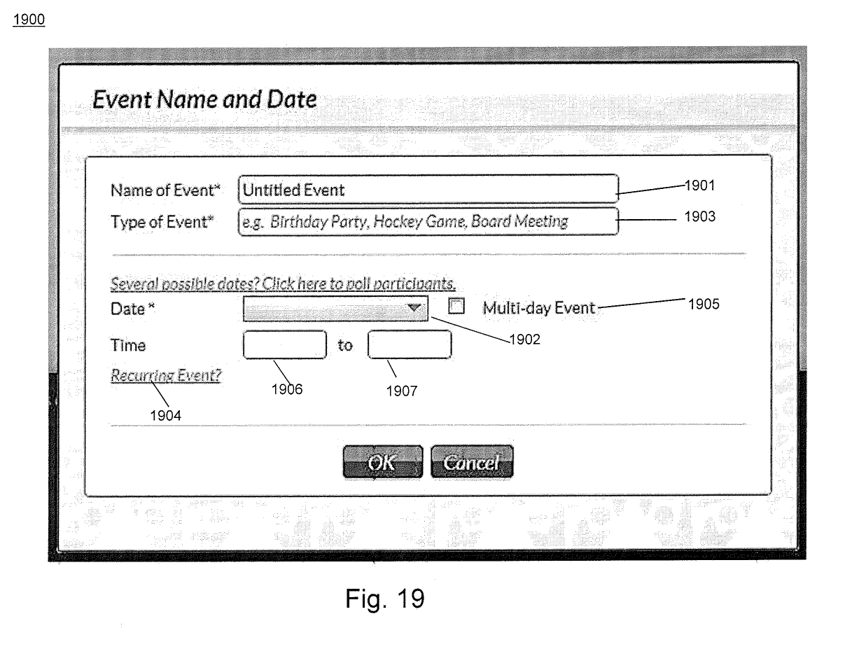

Turning to FIG. 15, in an example embodiment, an existing One-Off Date Poll is used to create a One-Off Event. In this way, Date Poll Details, together with the Profiles associated with the Date Poll, are applied or copied to the newly-created Event. In an example embodiment, the Administrator may direct that Pollees of the Date Poll be converted to Invitees of the Event. If so, the Administrator may further determine whether responses of Pollees should be converted into RSVPs to the Event. In an example of an embodiment, the newly created. Event is an independent Entity and is not associated with the Date Poll from which it was originally created.

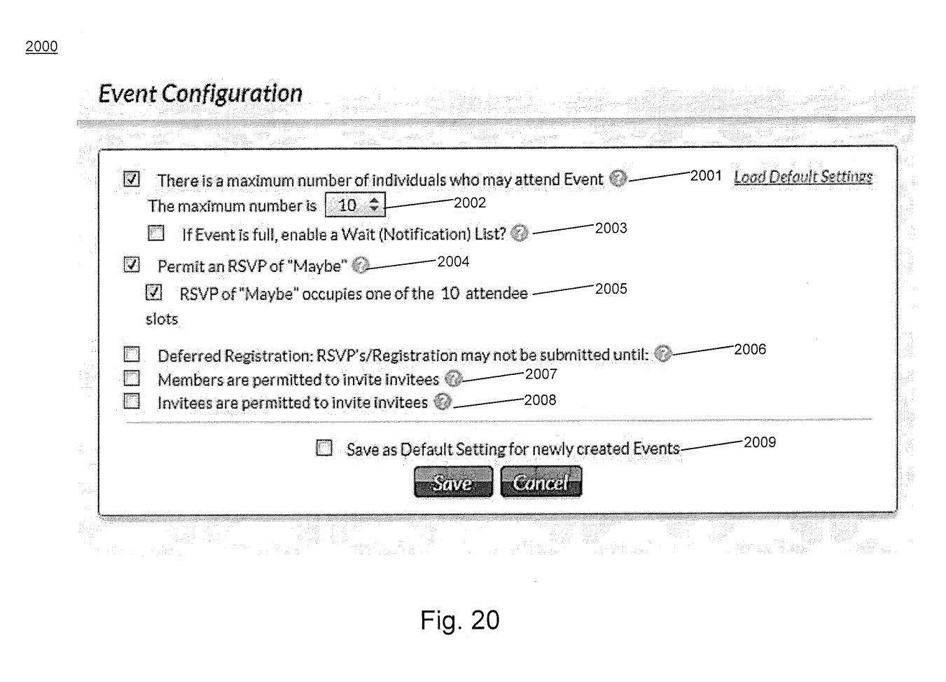

Turning to FIG. 16, the Event Organizing Software can be used to create Events and/or Date Polls within the context of an existing Group. The process by which an Event or Date Poll is set up and Activated is as described above, except that the Profiles it references are those of the Parent Group; and if a new Pollee or Invitee Profile is created, it is a Profile of the Group. In an example of an embodiment, a Date Poll is created, set up and Activated. Subsequently, the Date Poll is used to create an Event; such Event is not associated with the Date Poll from which it was created, but the Event does remain associated with the Parent Group.

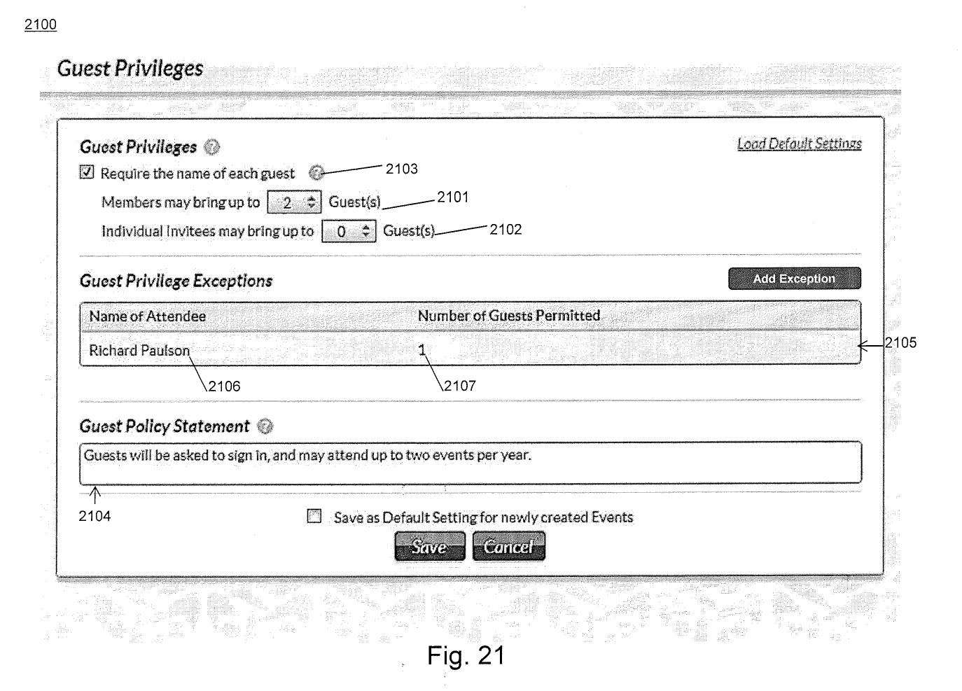

Turning to FIG. 17, an example embodiment of computer executable or processor implemented instructions is provided for creating an Entity. The type of Entity, including whether it is, in the case of an Event or Date Poll, a One-Off or associated with a Group, is determined by the control from which the process is launched. Thereafter, the process, as described below, is essentially the same whatever the Entity.

At block 1701, the server 101 receives an input to create an Entity. The input can be provided from the electronic device 110. In an example of an embodiment, the input includes minimum Entity details. In an example of another embodiment, such as when copying an Entity or converting a Date Poll to an Event, the minimum Entity details are retrieved from the server's memory and copied for the new Entity.

At block 1702, the server generates an ID for the Entity. In the case of an Event or Date Poll which is associated with a Group, a reference to the Primary Entity is saved. In the case of a Demo User who is creating a Primary Entity, the server generates a cookie, which includes a reference to the Entity ID, and sends the cookie to the electronic device for storage in the electronic device (discussed in greater detail below).

The newly created Entity has an Activation Status of “not Activated”. Until it has been Activated, such Entity can be accessed only by an Administrator of the Entity. The User who creates a Primary Entity is, initially, its sole Administrator. Administrative rights may be added to, or removed from, other Profiles, by an Administrator, either before or after Activation of the Entity.

Data pertaining to an Entity may be entered, modified and deleted as required by any Administrator. Such changes can be effected in one or many sessions, and need not be performed in any particular sequence.

In some cases, the server generates a cookie including the Entity ID and sends the same to the electronic device (block 1703).

At block 1704, the server obtains Entity Details, and at block 1705, the Entity Details are associated with the Entity ID.

At block 1706, the server obtains the data to create Profiles. At block 1707, an ID is assigned to each new Profile. The data saved in relation to a Profile includes a reference to the Entity ID with which the Profile is associated. In this way, the data to create the Profiles is associated with the Entity ID. In the case of an Event or Date Poll which is created in the context of a Group, the Entity so referenced is that of the Parent Group.

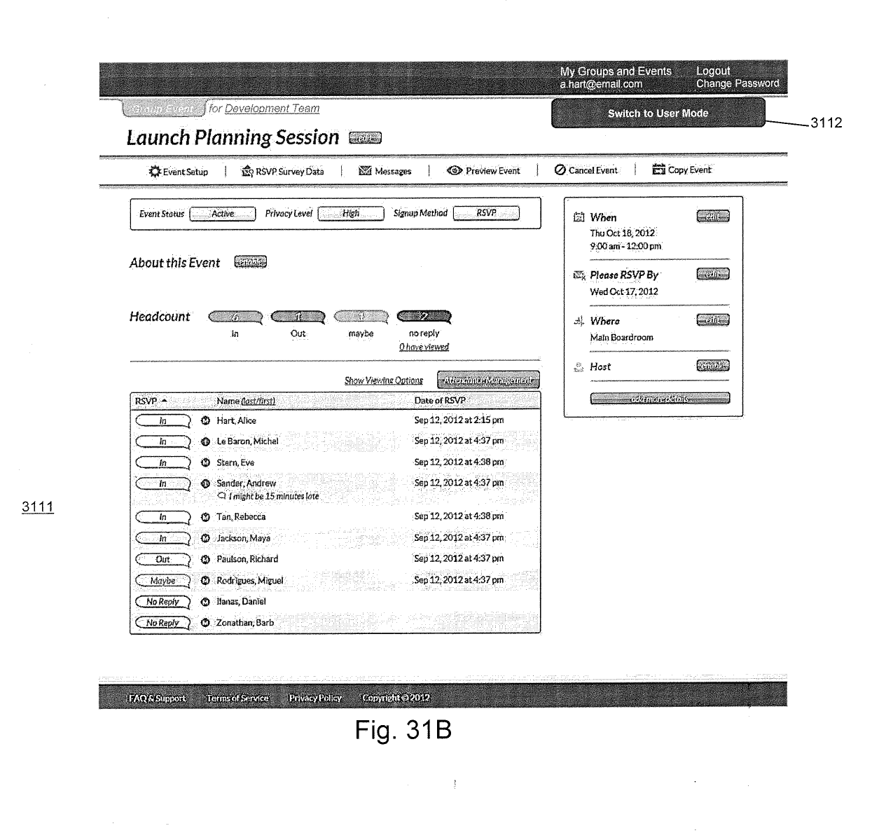

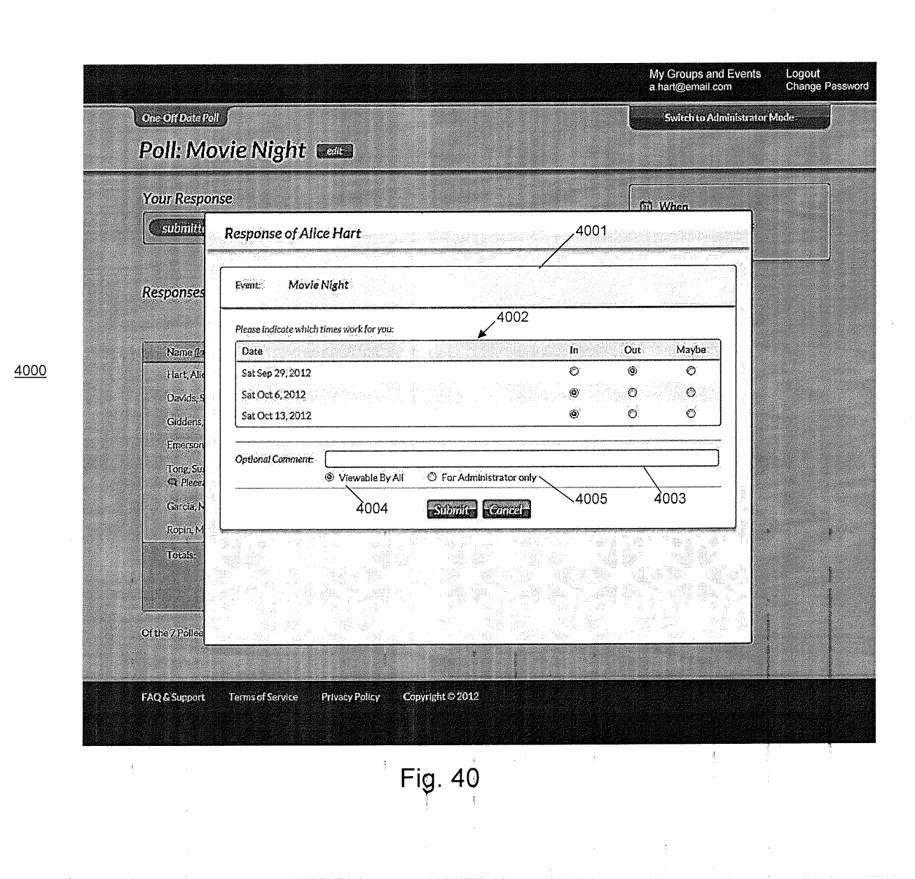

In an example of an embodiment of creating a new Entity, such as an Event or a Date Poll, within the context of a Group, the server automatically associates the Profiles of the Group, and the corresponding profile IDs, with the entity ID of the new Entity. This association, of itself, does not determine which Profiles may access the new Entity after it is Activated. This association does, however, enable the complete list of Profiles to be displayed to the Administrator when setting up the new Entity. In the case of an Event, the Administrator may, using Attendance Management as shown in FIG. 28, select which Profiles may attend the Event and which may not attend the Event. In the case of a Date Poll, the Administrator may, using Pollee Management as shown in FIG. 38, select which Profiles are to be Pollees of the Event.

In an example of an embodiment, Members of the Group are, by default, eligible to attend the Event. In this example embodiment, a newly created Event will, without input by the Administrator, be set up so that Profiles which are Members are eligible to attend the Event, and Profiles which are not Members are not eligible to attend the Event. In an example of such an embodiment, an Administrator who creates an Event within a Group does not need to manually specify which Users are eligible to attend the Event and accordingly, are eligible to RSVP to the Event. This reduces the number of steps for the Administrator and gives predictability that Members of the Group are automatically eligible to participate in Events in the context of the Group. These benefits may be further appreciated when there are multiple or recurring Events within the context of the Group.

In another example of an embodiment, when selecting which Profiles may attend an Event within the context of a Group, the Administrator may make such selection using an option control displayed adjacent to the name of each Profile. Profiles of Members may be set to “eligible to attend” by default, but the Administrator may use such option control to impose a restriction which renders a Member ineligible to attend. Similarly, the Administrator may use such option control to make a non-Member eligible to attend as an Invitee. Similarly, the Administrator may use such option control to “uninvite” an Invitee.

Continuing with FIG. 17, at block 1708, for each such Profile which contains an email address for which there is not an existing User Account, the server creates a new User Account with the same email address and a randomly-generated password, and associates the Profile with such new User Account. In an example of an embodiment, the randomly-generated password is temporary. If the email address within the Profile matches that of an existing User Account, the Profile is associated with that User Account.

At block 1714, the server receives an input to Activate the Entity.

In the case of an Event or Date Poll which is associated with a Group, the server verifies that the Group has been Activated and has not been terminated.

Upon Activation of the Entity, at block 1715, the server sends an electronic message, such as an email notification, which includes a Personal Entity Page GUI Link that includes data from which the server can identify the website, the type of Entity, the Entity ID and the Profile ID. In the case of Activation of a Group, an electronic message is sent to Members of the Group. In the case of Activation of a Date Poll, the electronic message is sent to Pollees. In the case of Activation of an Event, an electronic message is sent to Invitees and, at the option of the Administrator in the case of an Event which is associated with a Group, Members of the Group.

Block 1709 is a set of computer executable or processor implemented instructions that can be used to save and retrieve information while in the process of creating an Entity, should the electronic device be suddenly disconnected from the server. This helps to recover the information inputted by a User or Demo User. This is particularly useful when a Demo User creates an Entity, and will be discussed below.

In an example of an embodiment, when a new Entity is created by an Administrator having a User account, the Administrator's contacts to other Users can be associated with the new Entity. For example, an Administrator is creating a new Event. The Administrator has a User Account that is also associated with an existing Entity, which may not have any relationship to the new Entity. The existing Entity, for example, is a Group. The Group is associated with another User. Based on a selection input from the Administrator, or based on automatic rules, the server associates the other User, who is associated with the existing Group, with the new Event. In other words, the other User is associated with the entity ID of the new Event. The server also generates another profile and another profile ID for the other User and specific to the new Event. This other profile and other profile ID are associated with the entity ID of the new Event. The other User is able to access the new Event after the new Event is Activated. This example of creating a new Entity allows an Administrator to use existing contacts from other Entities, even if the new Entity and existing Entities have no relationship to each other. The Administrator does not need to re-enter contact information for such existing contacts.

In an example of another embodiment, if a User Account is not created by the User but by an Administrator who has created a Profile referencing that User's email address, then Log in credentials (e.g. a password) are sent by email to such User. The credentials may only be sent once (but can be changed using the “Change Password” functionality). The credentials are sent when the User Account is first associated with an Activated Entity. Therefore, the trigger for sending the credentials can be either Activation of the Entity or, in the case of a Profile which is added to an already Activated Entity, the creation of the Profile.

Automatic creation of User Accounts for Profiles created by an Administrator may facilitate rapid adoption of the Event Organizing Software by more Users. For example, an Administrator may add Members, Invitees or Pollees who are not existing Users. Upon creation of such Profiles, User Accounts are also created. Upon Activation of the Entity, emails are sent which solicit the participation of the recipients and which contain credentials and Personal Entity Page GUI Links through which such recipients may Log in.

In an example of an embodiment, when different Administrators create different Entities that are associated with a same User, that User will be able to view the different Entities when they are Activated. For example, the server receives data from an Administrator to create an Event. The data includes a unique identifier of the User, such as an email address. The data may also include the Minimum Event Details. The server creates the Event and creates a User account based on the unique identifier. The server associates the Event with the User Account.

Continuing with the example, another Administrator, which may or may not have any knowledge of the Event, provides other data to create a Date Poll, such as the Minimum Date Poll Details. The Date Poll and the Event may not have any relationship to each other. The other Administrator wishes to invite the same User to participate as a Pollee for the Date Poll. The server receives the unique identifier of that User. The server creates the Date Poll. The server also identifies the User Account of the same User using the unique identifier and associates the Date Poll with the same User account. Therefore, when the User accesses his or her User account using the unique identifier, the server enables access to the Event and the Date Poll. The User can view information about both Entities, even though they were created by different Administrators and may not have any relation to each other.

Other combinations and permutations of different types of Entities can be used, in addition to the Event and the Date Poll described in the above example. The Event Organizing Software allows a User to conveniently view multiple Events, Date Polls and Groups in a consolidated interface, even if the Events, Date Polls and Groups may not have any relation to each other.

In another aspect of the example, the Administrator Profile of the Date Poll and the Administrator Profile of the Event are associated with the same User Account. This may happen if same person created the Event and the Date Poll and wanted the same User to participate in both. However, the Administrators can also be different people.

### RSVP's and Date Poll Responses

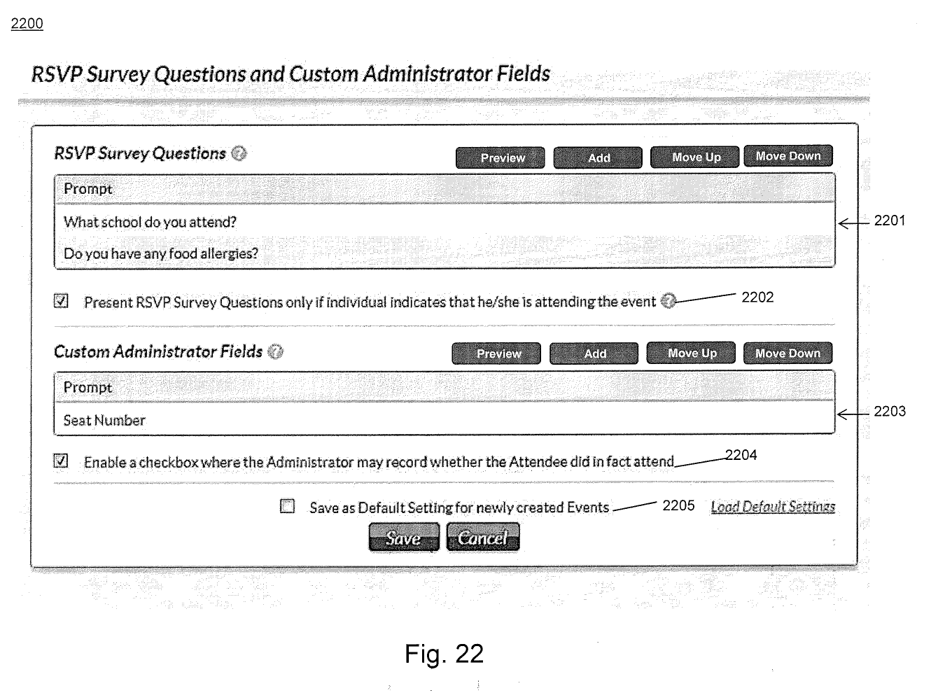

Turning to FIG. 18, an example of an embodiment of computer executable or processor implemented instructions is provided for the recipient of an email containing an Entity Page GUI Link to access the Entity Page GUI and, if applicable, to submit an RSVP for an Event or submit a Date Poll Response. A recipient of an email containing a Personal Entity Page GUI Link, for example, as sent at block 1715, may click or access the Personal Entity Page GUI Link on his or her electronic device. The electronic device then sends a message to the server, which includes data to identify the target Entity Page GUI (e.g. using the Entity ID), the Profile of the User (e.g. using the Profile ID) and its associated User Account. In an example of an embodiment, the User who follows the Entity Page GUI Link does not need to enter any information (credentials or otherwise) to access the Entity Page GUI. At block 1801, the server receives this data and, after validating it (block 1802), provides the Entity Page GUI, and/or the RSVP GUI or the Date Poll Response GUI, with such GUI elements as are appropriate according to the particular User's Profile and its associated viewing rights (blocks 1803 and 1804).

At block 1805, the server receives the RSVP or the Date Poll Response from the User (via the electronic device 110).

Associated with each Eligible Attendee of an Event, and with each Pollee of a Date Poll, is information about when the email notification of the Event or Date Poll was sent, whether/when the recipient viewed the Entity Page GUI, whether/when the recipient replied, and all data relating to such reply.

### Demo Users

In an example embodiment, a Demo User who wishes to try out the Event Organizing Software, creates an Entity (the Demo Entity). For example, this process of circle “C”, “D” or “E” of FIG. 5 can be invoked from the Home Page GUI. The server generates a cookie, which includes a reference to the ID of the Demo Entity, and sends the cookie to the electronic device for storage in the electronic device (see block 1703). A cookie, also known as an HTTP cookie, a web cookie, or a browser cookie, is data sent from a website and stored in a User's internet browser while a User is browsing a website. With the exception of adding Administrators and Activating the Entity, the Demo User may perform all actions in relation to the Demo Entity that would be available had such User first Logged in to the Event Organizing Software, including the entry of Entity Details and Entity Setup Options, the creation of associated Profiles and, in the case of a Group, the creation of Events and Date Polls within such Group. At the point that the Demo User seeks to Activate the Demo Entity, the Demo User will be prompted to create an account and/or Log in in order to proceed.

In an example of an embodiment, the cookie expires after a certain period if the Demo Entity is not “adopted” by a User Account. If the Demo Entity is adopted by a User Account, the cookie is deleted. A Demo Entity is adopted for this purpose if the Demo User has or creates a User Account and Logs in under such account, and when prompted at Log in, responds in the affirmative when prompted as to whether to import (adopt) the Demo Entity. In another example embodiment, if the User rejects the Demo Entity by responding in the negative to such prompt presented at time of login, the cookie is deleted.

In an example of an embodiment, turning back to FIG. 17, if the Demo User has disconnected from the server, and subsequently reconnects with the server, the process may continue from where the Demo User had left off, provided that a valid cookie is found on the electronic device. Block 1709 represents a set of instructions used when the Demo User (e.g. the electronic device 110) is disconnected with the server 101. The instructions of block 1709 can occur in various contexts, including in the example of an embodiment context of FIG. 17.

At block 1710, the server detects that the electronic device is disconnected or unable to communicate with the server. At block 1711, the server detects that the electronic device has reconnected with the server. At block 1712, the server obtains the cookie, which includes a reference to the Entity ID. If the server determines that the cookie has not expired, then a control is presented in the GUI whereby the User can open the Demo Entity and, if the User proceeds in this manner, at block 1713, the data required to generate the Entity Page GUI is obtained from the server's memory.

The process of creating the Demo Entity can then resume at block 1714. In this way, even if the Demo User disconnects from the server, the Demo User can still reconnect with the server at a later time and continue creating the Demo Entity. Such benefits are provided even if the Demo User has not provided his or her name or email address. Even without such information, the Demo User's inputs can be saved and later automatically recovered based on identifying the Demo User with the cookie. The email address of the Demo User is not required until he or she wishes to Activate the Demo Entity. This allows potential Users to easily adopt the Event Organizing Software.

### Processing an Event—GUI Elements

Creating an Event.

There are different starting approaches to Creating an Event. In an example of an embodiment, from the User Home Page GUI, a User who has Logged in can select to create a One-Off Event. In another example of an embodiment, a Demo User can select to create a One-Off Event from the publicly visible home page of the Event Organizing Software (e.g. circle “D” in FIG. 5). In another example of an embodiment, the Administrator of a Group can select to create a new Event for such Group from the Group Page GUI in the Administrator Mode.

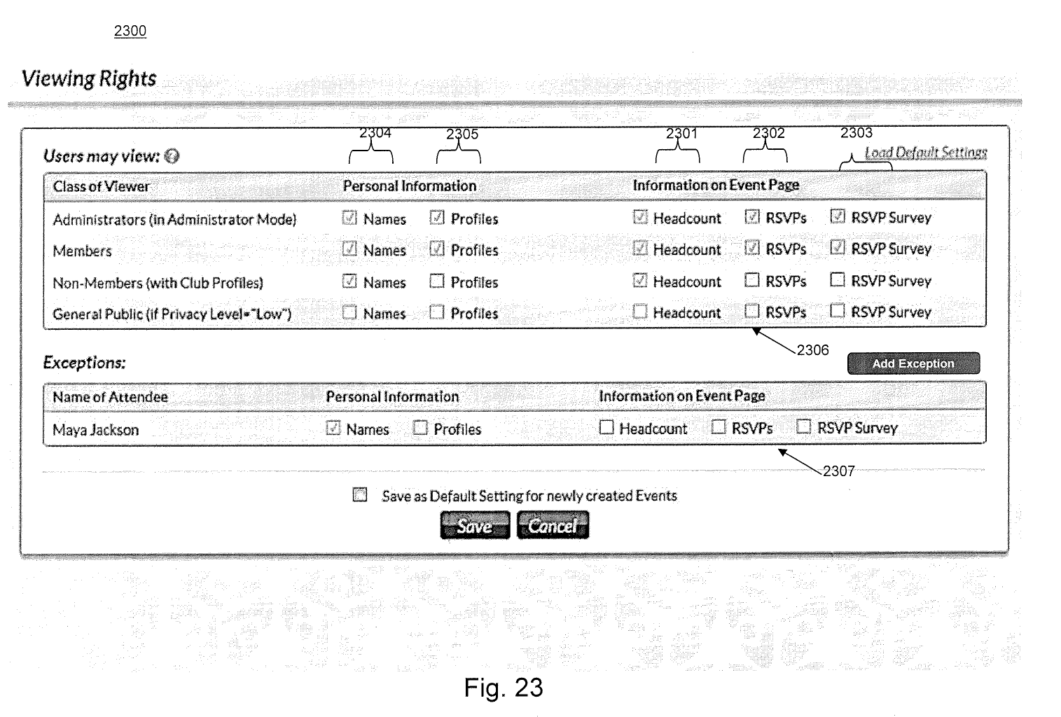

After selecting any of these above starting approaches to create an Event, a GUI is displayed which prompts for the Minimum Event Details. An example embodiment of the GUI 1900 is shown in FIG. 19. The GUI allows the User to provide: the name of the Event 1901, the Event Date 1902 and, in the case of a One-Off Event, the type of Event 1903. The procedure for creating recurring Events can also be displayed by clicking on the “Recurring Event?” link 1904. There is an option to specify whether the Event is a multi-day Event 1905, and an option to specify a start time 1906, an end time 1907, or both. If the multi-day option is selected, then there is a field into which the end date can be entered. This information is received by the server and is used to create the Event. After saving the data, the server executes instructions to assign an Event ID which uniquely identifies the Event. The server also executes instructions to automatically create a Profile for the User, which the server also designates as an Administrator of the Event.

Event Setup—Event Configuration Screen.

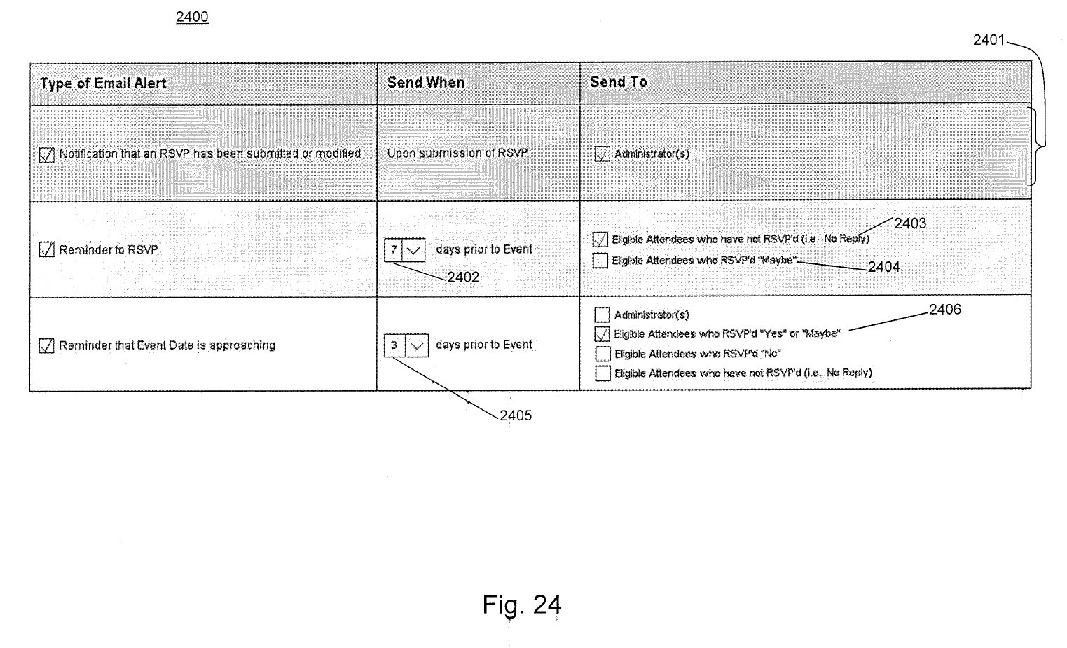

An example of an embodiment of a GUI 2000 for Event Setup Options for configuring the Event is shown in FIG. 20. In this example embodiment, the options for configuring the Event include the ability to set if there is a maximum number of attendees 2001, and if so to specify the maximum number of attendees 2002 for the Event; if there is a fixed maximum number of Attendees, whether to enable “wait list” functionality 2003; whether to permit an Eligible Attendee to respond “maybe” 2004; if the Event attendance is capped with a maximum of 10 attendees, and if there are 9 “in” responses and 1 “maybe” response, whether to permit someone else to RSVP “in” and displace the individual who responded “maybe” (or otherwise permit the individual who responded “maybe” to lock up that spot) 2005; whether RSVPs or Registrations are deferred, that is cannot be submitted until a specified date 2006; whether, in the case of a Group, Members may invite Invitees 2007; and whether Invitees may invite Invitees 2008.

In another example of an embodiment, a minimum number of attendees, a quorum, may be designated in order that alerts may be sent to the Administrator if such quorum has, or has not, been achieved. In the case of an Event associated with a Group, based on input from the Administrator (e.g. option box 2009), the server may be configured to save a completed Event configuration screen as the default for newly created Events. Accordingly, newly created Events use the saved default settings.

Event Setup—Guest Privileges Screen.

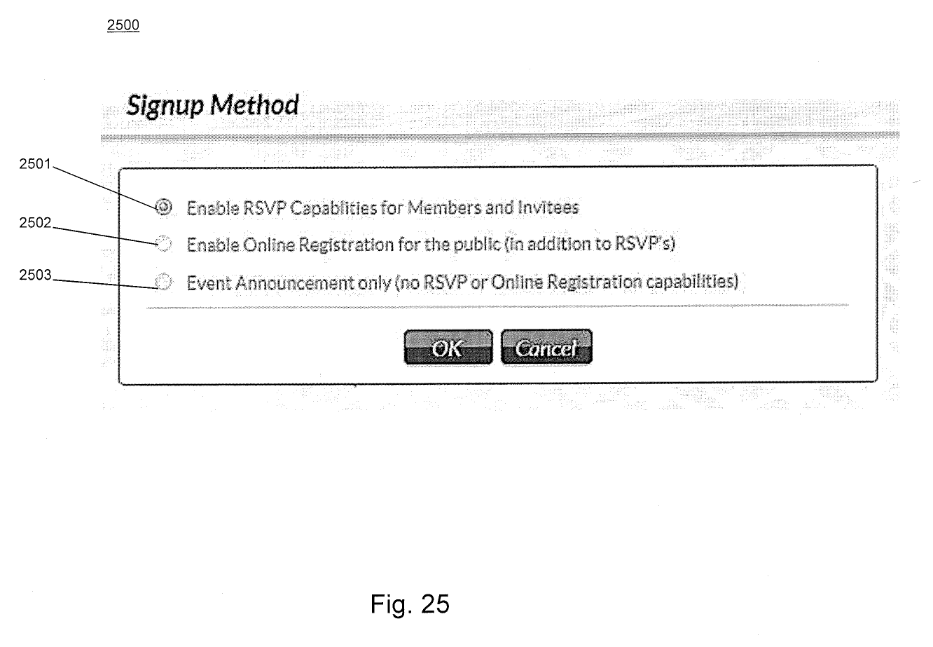

An example of an embodiment of a GUI 2100 for Event Setup Options relating to Guest privileges is shown in FIG. 21. In this example of an embodiment, the server receives input from the Administrator a designation of the number of Guests which Eligible Attendees may bring, according to their Class of Profiles (and subject to Class Exceptions). For example, Members may bring up to a specified number of Guests 2101 (e.g. including the number “0”), while individual Invitees may bring up to another specified number of Guests 2102.

In addition, the server can receive input from the Administrator to configure the RSVPs to require that the person sending an RSVP identify any Guests by name 2103, as opposed to merely indicating the number of Guests. The server can also receive from the Administrator a brief “Guest policy statement” 2104 (e.g. “Guests will be asked to sign in, and may attend up to two event per year” or “Guests are limited to close friends and family”), which the server will display to an Eligible Attendee whose RSVP indicates an intention to bring Guests. In the case of an Event associated with a Group, the Administrator may invoke the server to save a completed Guest privileges screen as the default for newly created Events.

The Administrator can also configure the server to provide exceptions to the Guest Privileges for certain Attendees. For example, although generally an Attendee may bring up to two guests, certain specified Attendees can bring more or less than two guests. A table 2105 shows the name of the Attendee 2106 who is an exception and the maximum of Guests 2107 that the Attendee can invite.

Event Setup—RSVP Survey Questions and Custom Administrator Fields Screen.

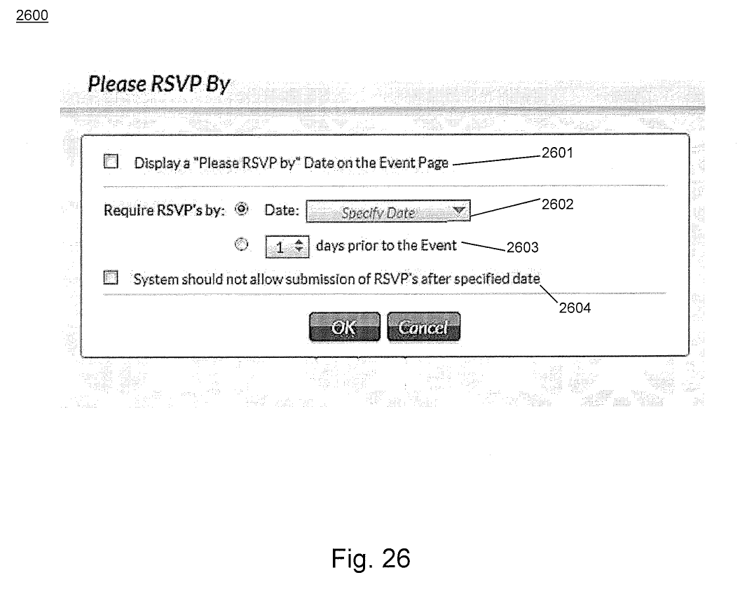

An example of an embodiment of a GUI 2200 for Event Setup Options relating to RSVP survey questions and custom Administrator fields is shown in FIG. 22. In this example of an embodiment, the server will receive from the Administrator one or more questions which the server will display in the RSVP GUI for completion by an Eligible Attendee (e.g. Do you have any food allergies? What will you bring to the potluck dinner?). For each such survey question, the Administrator provides the wording of the prompt to be presented to the User and the format of the response data (e.g. text, number, dropdown) and, if applicable, the dropdown options. The prompts or questions are shown in a table 2201.

In an example of an embodiment, the server receives from the Administrator input 2202 specifying whether such survey questions should be presented even if the RSVP Value is “out”, for example, based on whether the individual indicates he/she is attending the Event. The Administrator may setup similar questions which may be viewed by, and responded to, only by the Administrator so that the Administrator may record notes associated with each RSVP. Such Administrator prompts are shown in a table 2203. The server may also provide the option 2204 to the Administrator to enable a checkbox to track whether Eligible Attendees actually attended the Event. In the case of an Event associated with a Group, the Administrator may save a completed RSVP survey questions and custom Administrator fields screen as the default for newly created Events 2205.

Event Setup—Viewing Rights Screen.

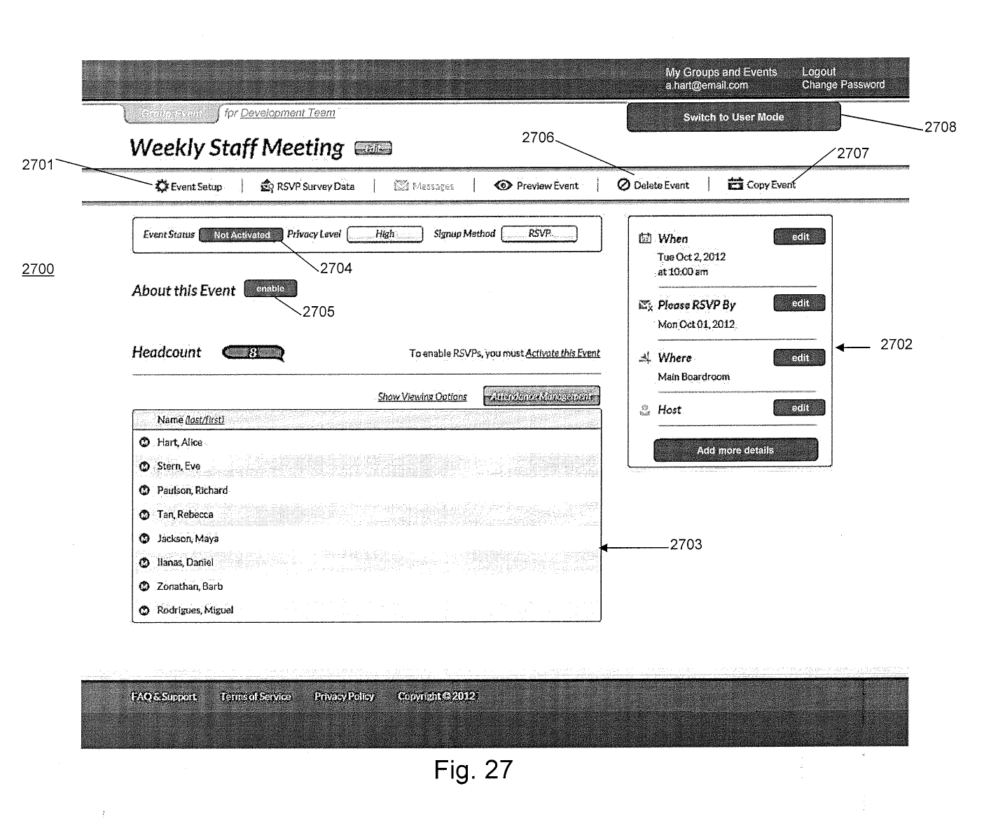

An example of an embodiment of a GUI 2300 for Event Setup Options relating to viewing rights is shown in FIG. 23. In this example of the embodiment, the server receives from the Administrator input specifying which information in the Event Page GUI may be viewed by Users, according to their Class of Profiles, subject to Class Exceptions. A table 2306 shows different Classes, including, for example, Administrators (in Administrator Mode), Members, Non-Members (with Group Profiles), and General Public (e.g. if Privacy Level=Low). For example, the Administrator can use the table 2306 to determine whether a Class of Profiles may view the headcount 2301; each individual's RSVP Value 2302; and/or responses to survey questions contained in each RSVP 2303. The Administrator may also specify whether Users may view the names 2304 and Profile information 2305 associated with other Profiles (in the case of a Group, this setting determines the rights of the User for the entire Group and all of its associated Events and Date Polls). In the case of an Event associated with a Group, the Administrator may invoke the server to save a completed viewing rights screen as the default for newly created Events. The GUI 2300 also includes a table 2307 to specify which Attendee or Attendees are exceptions to the viewing rights for the Class of Profile, and allows the Administrator to provide different viewing rights to the Attendees who are exceptions.

Event Setup—Member Eligibility Restrictions Screen.

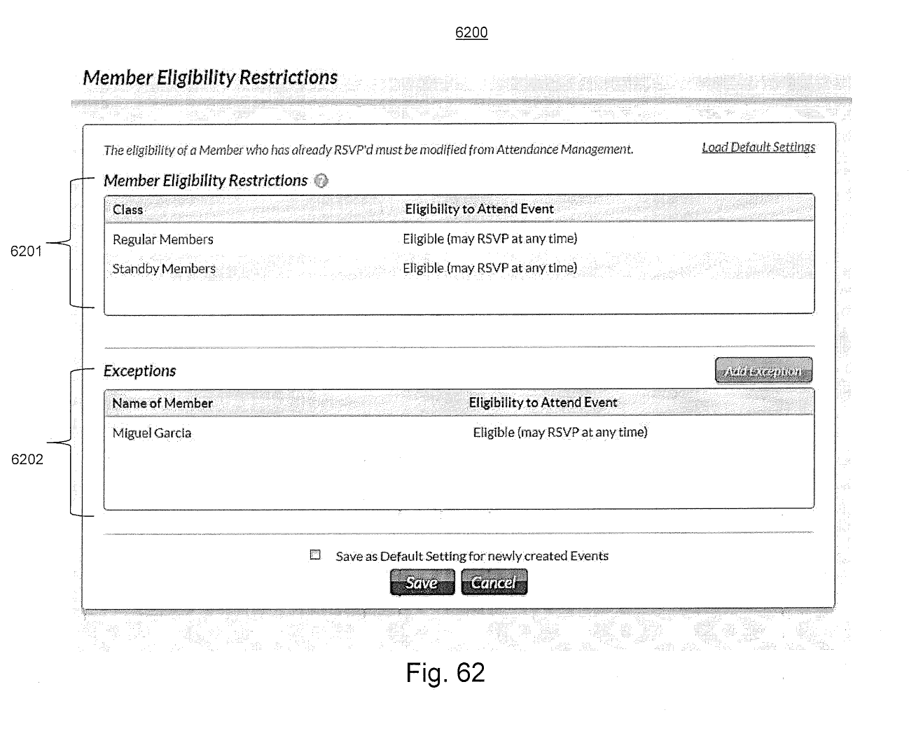

An example of an embodiment of a GUI 6200 for Event Setup Options relating to Member eligibility restrictions is shown in FIG. 62. This screen applies only in the case of an Event which is associated with a Group. In this example embodiment, the server provides controls 6201 for an Administrator to specify whether a particular class of Members may, by default, attend the Event, for example, by being eligible to RSVP; may not attend the Event, by not being eligible to RSVP; or may become eligible to RSVP at a designated point in time, for example, 5 days prior to the Event. This default setting may be overridden for a particular Member by creating a Class Exception 6202. In the case of an Event associated with a Group, the Administrator may invoke the server to save a completed Member eligibility restrictions screen as the default for newly created Events.

Event Setup—Alerts Screen.

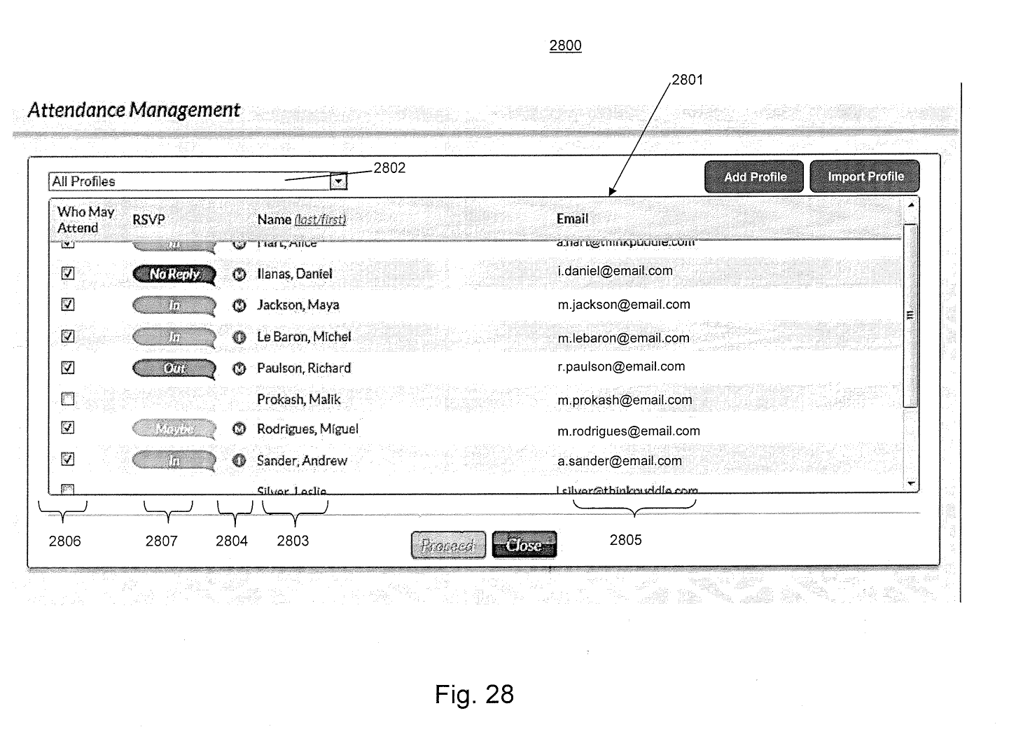

The Administrator may configure the Event Organizing Software to send automated alerts, or email notifications, upon the occurrence of specified trigger conditions. Alerts use the Messaging functionality of the Event Organizing Software. An example of an embodiment of a GUI 2400 for Event Setup Options is shown in FIG. 24 in which the server receives input from the Administrator specifying that the server send email alerts. An alert may be sent to the Administrator, each time that an RSVP is submitted or modified 2401. An alert may be sent a specified number of days 2402 prior to the Event, to those Eligible Attendees who have not replied 2403, or who have replied “maybe” 2404. An alert may also be sent a specified number of days 2405 prior to the Event to remind Eligible Attendees, except, for example, those who have replied “out”, of the upcoming Event 2406. In the case of an Event associated with a Group, the Administrator may save a completed alerts screen as the default for newly created Events.

Privacy Level.

In an example of an embodiment, an Event may have a Privacy Level of “high” if the Event Page GUI is viewable only by Invitees and, in the case of an Event within a Group, current Members; or a Privacy Level of “low” if the Event Page GUI is viewable by the general public. In the case of an Event with a Privacy Level of “low”, upon Activation of the Event, the server presents the Public Event Page GUI Link in the Event Page GUI in order that it may be disseminated, for example, by email or by publishing it on a website, to the intended recipients or general public.

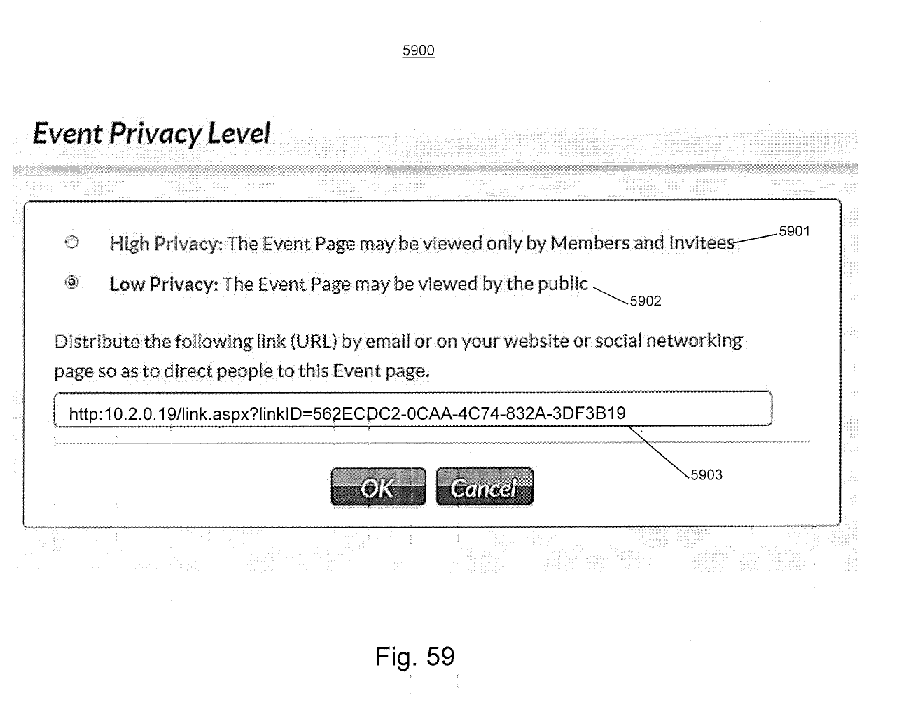

Turning to FIG. 59, an example GUI 5900 is provided showing options for an Administrator to select a high Privacy level 5901 or a low Privacy level 5902. The server also generates and displays a URL link in a field 5903 which can be distributed by email, website, or other communication media so as to direct people to the Event Page. For example, a URL link can be copied from the field 5903 and pasted into other communication media.

RSVPs, Registrations and Signup Method.

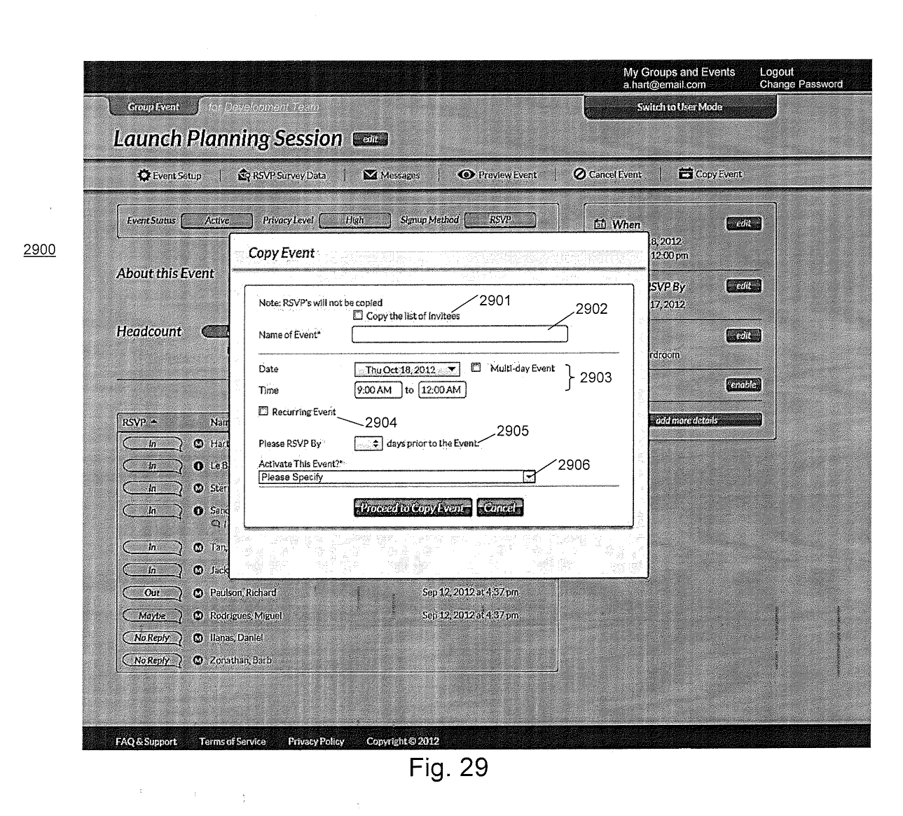

By default, an Event is set up to support a process whereby Eligible Attendees may send an RSVP. FIG. 25 shows an example GUI 2500 by which the Administrator may set up the Event differently. In addition to the default of “Enable RSVP Capabilities for Members and Invitees” 2501, in an example of an embodiment which would be suitable for say a seminar, lecture or concert, the Administrator provides an input to the server to enable “Online Registration by the Public” 2502. This option, for example, is available only if the Privacy Level of the Event is first set to “low”. Once enabled, anyone who follows the Public Event Page GUI Link may access the Event Page GUI and register for the Event.

In another example of an embodiment, if there is unrestricted admission to such a seminar 2503, with no need to register, then the Administrator provides input to the server to configure the Event with a Privacy Level of “low” and with both RSVP's and Online Registration disabled. This permits anyone who follows the Public Event Page GUI Link to access the Event Page GUI. In this case, the Event Page GUI serves as an announcement page only, and does not support RSVP's or Registrations.

“RSVP by” Date.

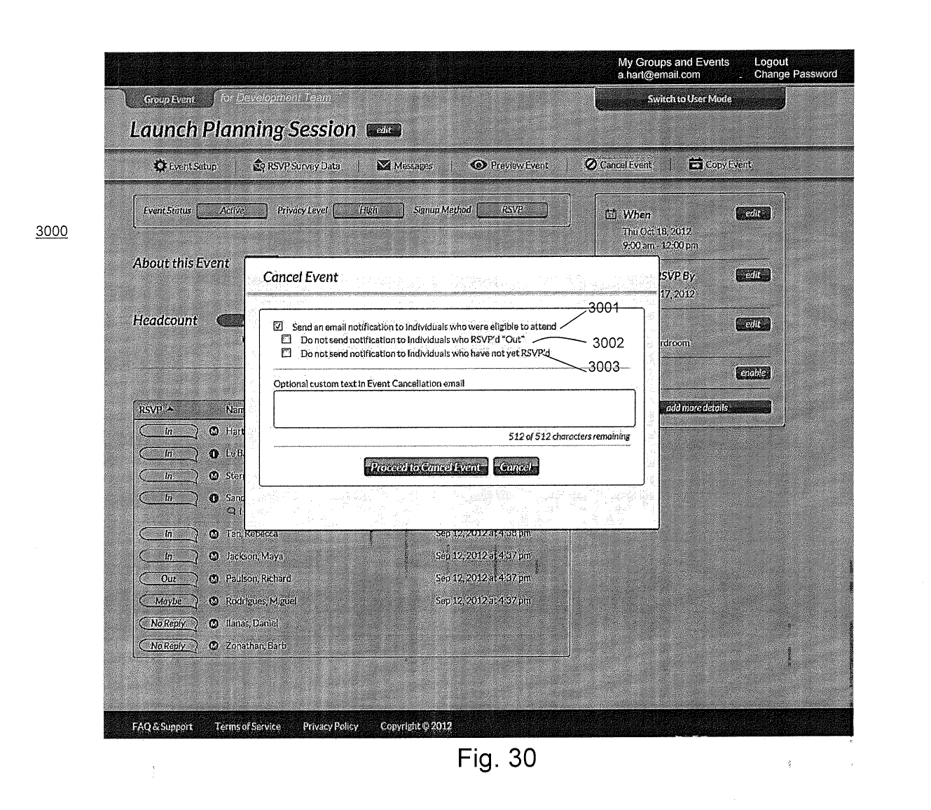

From within the Event Configuration screen, the Administrator may set a date prior to which Users cannot RSVP to, or register for, an Event. In addition, a GUI 2600, as shown in FIG. 26, allows the Administrator to determine whether an “RSVP by” date is to be displayed on the Event page 2601 and, if so, whether it should be a fixed date or a date calculated by the system as being a specified number of days prior to the Event. At the option of the Administrator 2604, “RSVP by” date may be enforced by the Event Organizing Software so that late RSVPs cannot be submitted.

Event Page GUI—Administrator Mode.

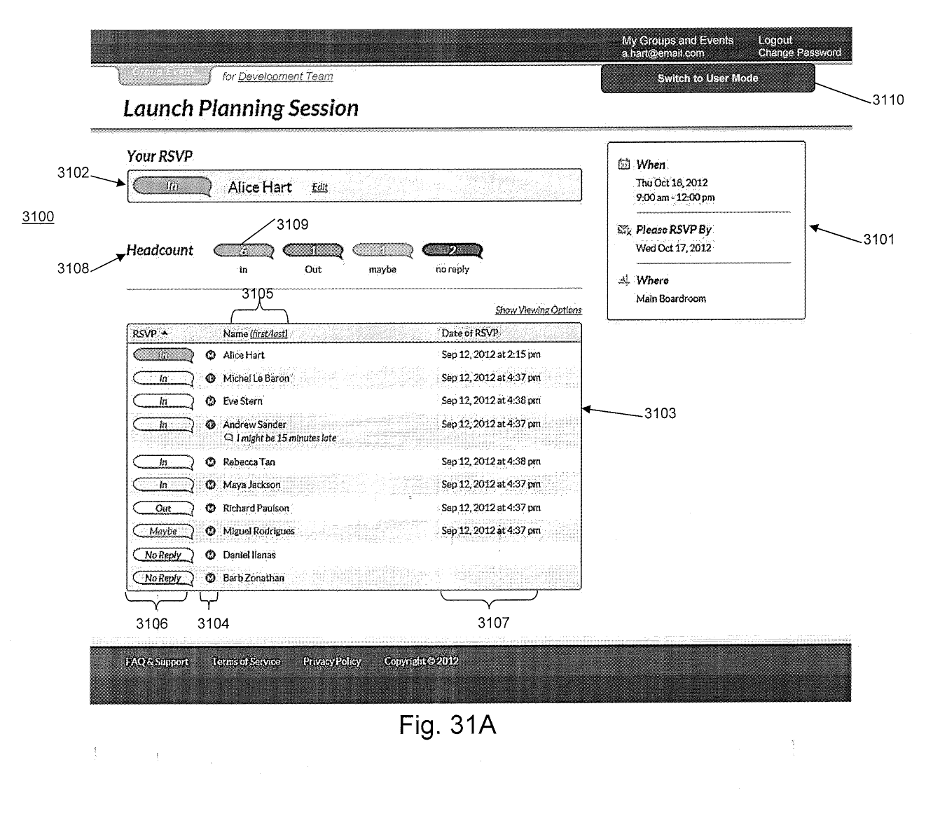

After the Minimum Event Details have been submitted, the Event Page GUI can be displayed. An example of an embodiment of such a GUI is shown in FIG. 27. Until the Event has been Activated, the Event Page GUI can be viewed in Administrator Mode only. In Administrator Mode, the Event Page GUI includes controls to modify Event Details 2702, Event Setup Options 2701 and Profiles 2703. The Activation Status 2704 of the Event is also displayed.

There are also controls by which the Administrator can Activate an Event. In an example of an embodiment, the Activation control and the Event Status 2704 are one and the same. By selecting the control 2704 the Event is activated. There are other controls to delete an unactivated Event or to cancel an Activated Event 2706. By selecting control 2705, the description of the Event is enabled for display. Event Details, Event Setup Options and Eligible Attendees can be added, deleted or modified from time to time, as the Administrator sees fit, both before and after Activation. Following Activation, the Event Page GUI is updated by the server to display the RSVP Values of the Eligible Attendees and the headcount or tally of responses, in the same manner as described below for User Mode. There is also a control for copying an Event 2707.

Attendance Management.

From the Event Page GUI, Administrator Mode, an Administrator may select “Attendance Management”. An example of the “Attendance Management” GUI 2800 is shown in FIG. 28. In an example of an embodiment, subject to the ability of the User to filter 2802 the list, all Profiles of the Primary Entity are displayed in the rows of a table 2801. If the Date Poll has not been Activated, the table contains columns for name 2803, Affiliation Icon 2804, email address 2805 and a checkbox 2806 to signify whether the Profile is an Eligible Attendee. Until the Date Poll has been Activated, the server will allow the Administrator to check and uncheck the checkbox to add or remove Eligible Attendees.

The Administrator may also add new Profiles. Following Activation, the table will contain an additional column for the RSVP Value 2807 of Eligible Attendees. In Administrator Mode, clicking on the RSVP Value will open the RSVP GUI, which may then be completed or modified by the Administrator on behalf of the Eligible Attendee. Clicking elsewhere in the row will invoke the server to display the Profile. The effect of checking or unchecking the Eligible Attendee checkbox varies according to the affiliation of the Profile with the Event. For example, if a checkbox is checked for a non-Member, the server adds the Profile as an Invitee. If the checkbox is unchecked for an Invitee, the server deletes the RSVP, if submitted, and sets the Profile to “uninvited”. If the checkbox is unchecked for a Registrant, the server deletes the Registration. By default, the Eligible Attendee checkbox would be checked for a current Member. Unchecking or checking the box for a Member causes the server to set the Class Exception for Member eligibility restrictions, thereby making the Profile ineligible or eligible to attend. Similarly, if the Membership of a current Member expires prior to the Event Date, based on the checkbox, the server will determine whether the individual is eligible or ineligible to attend.

Activating the Event.

When the Event Page GUI has been configured in terms of Event Details, Event Setup Options, Eligible Attendees, etc., to his or her satisfaction, the Administrator can provide an input to the server to Activate the Event. Until Activated, the server will only allow the Event Page GUI to be viewed by an Administrator, in Administrator Mode. After the server Activates the Event, the server transmits appropriate communications containing Personal Event Page GUI Links, and the Event may be viewed either in User Mode, by any User who qualifies based on the Privacy Level set for the Event, or in Administrator Mode, provided that the User is an Administrator. Eligible Attendees may view the Event Page GUI and the RSVP GUI in User Mode and may submit or amend their RSVPs. If an Event has a Privacy Level of “low”, following Activation, the server will facilitate the display of a Public Event Page GUI Link in the Event Page GUI in order that the link may be disseminated in the manner desired by the User, for example, by email, web link, social network page, etc. An individual who is entitled to view the Event Page GUI in both Administrator Mode and User Mode may switch modes using the control 2708 provided for this purpose. An Event which is associated with a Group cannot be Activated unless the Group itself has first been Activated.

Notifying Eligible Attendees.

Eligible Attendees may be added or removed both before and after Activation of the Event. Invitees are sent notification of, for example, invitations to, the Event at the time that the Event is Activated. If a Profile is added as an Invitee following Activation, then the server sends such notification at the time that the Profile is added. The notification sent to the Invitee contains a Personal Event Page GUI Link. The Invitee may click on the link, or Log in to the Event Organizing Software, to view the Event Page GUI and the RSVP GUI. In the case of an Event within a Group, at the time that the Event is Activated, the Administrator may provide input to the server specifying whether or not notification of the Event should be sent to Members. If it is a Group that meets very regularly, for example, every Wednesday evening, there may be no need to send Event-by-Event notifications to Members. Rather, the Members may simply know to Log in to RSVP. If the server determines that an Individual becomes a Member after the Event has been Activated, the server will provide notification of the new Membership, which will include information as to upcoming Events as well as a Personal Group Page GUI Link which will direct the User to the Group Page GUI which is an access point for upcoming Events. The date and time of transmitting each such email notification is saved to the server memory, and may be viewed by the Administrator.

Copy Event.

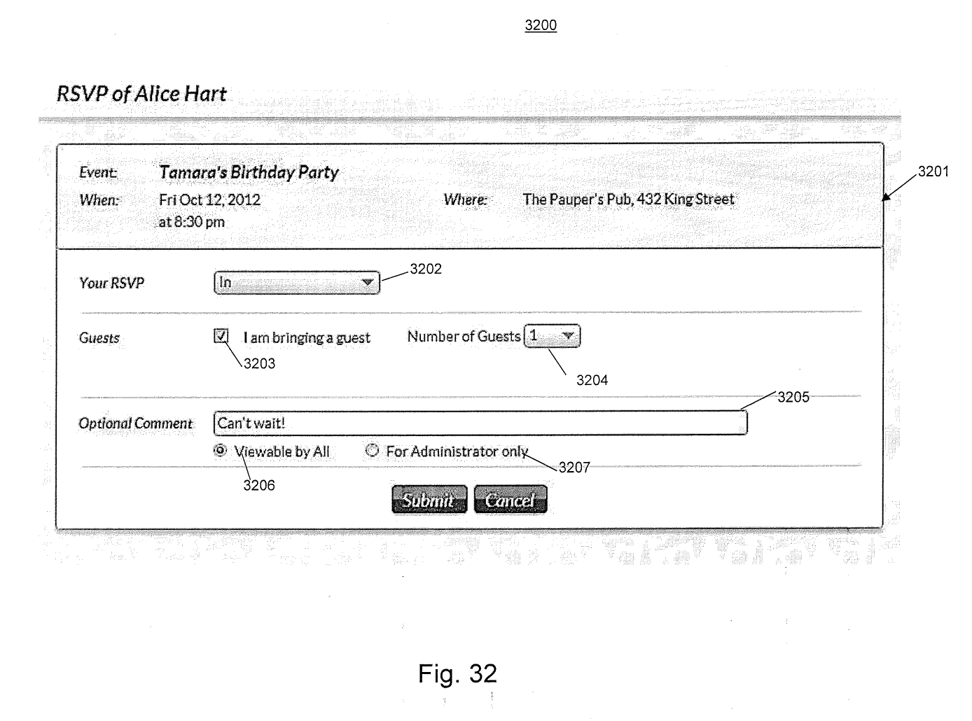

From the Event Page GUI, Administrator Mode, a control 2707 is provided which enables the Event to be copied. An example of an embodiment of a “copy Event” GUI 2900, in which the Administrator may modify any of the Minimum Event Details, is shown in FIG. 29. For example, there are options to modify the Name of the Event 2902, the Date and Time of the Event 2903, whether the Event is recurring 2904, an RSVP by date 2905, and whether to Activate the Event 2906. When creating an Event in other scenarios, an Administrator would open the Event Page GUI to activate the Event. However, since copying supports creation of recurring Events, option 2906 allows the Administrator to Activate the new Event(s), as part of the copy process, in order to reduce the number of steps, for example, by avoiding opening numerous newly-created Event Page GUIs. By default, such information will be copied from the originating Event, although the information can be modified. The Administrator may also provide an input through an option box 2901 to the server indicating whether Invitees of the original Event are to be Invitees of the new Event.

Upon proceeding, the server creates and saves a new Event, with its own Event ID. The resulting new Event will contain a copy of the Event Details and Event Setup Options of the original Event. In the case of a One-Off Event, the Profiles will be copied, including information as to their affiliation with the Event, for example, as the Administrator or an Invitee. RSVPs are not copied. In the case of a One-Off Event, the new Event is a completely independent Entity, and does not reference the original Event or its Profiles. The copied Profiles, however, reference common User Accounts. Similarly, in the case of a Group, the new Event does not reference the one which was copied, but both are under the same Group and therefore share the same Profiles.

Cancel/Delete Event.

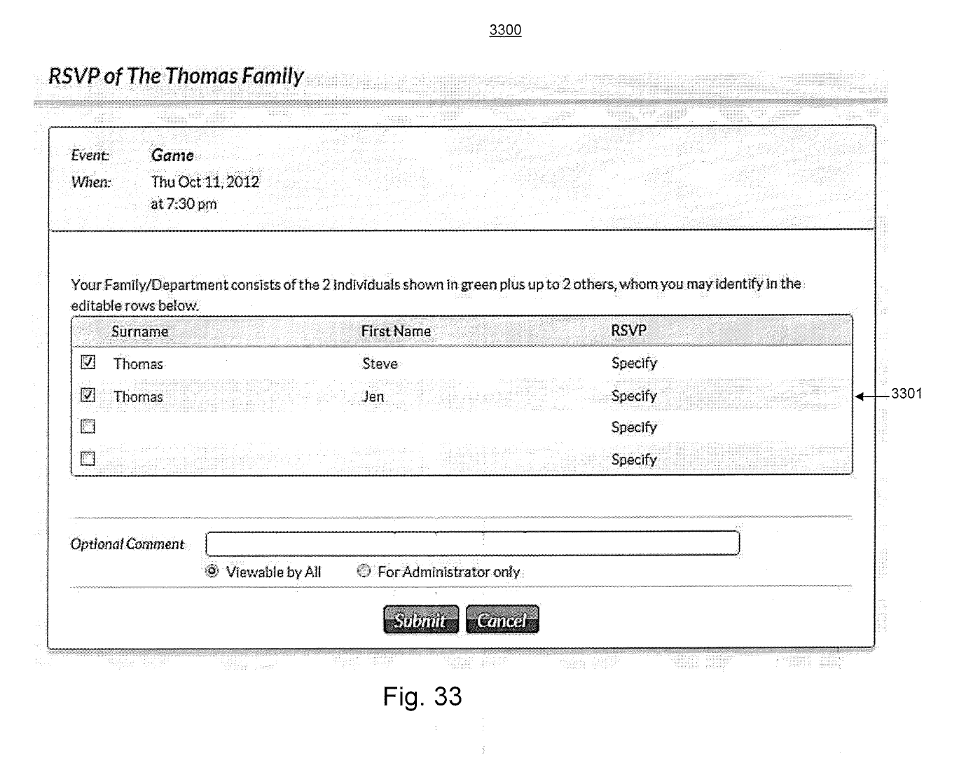

An Administrator may delete an Event which has not yet been Activated. An Administrator may cancel an Event which has been Activated, in which case the server will display a prompt, as shown in the example embodiment GUI 3000 in FIG. 30, as to which Profiles to notify, by email, of such cancellation. Based on the prompt provided by the server, the Administrator may provide inputs that configure the server to notify no one; all Eligible Attendees, for example, by using option box 3001; or all Eligible Attendees except for those with RSVP Values of “out” and/or “no reply”, for example, by using any one, both, or none of option boxes 3002 and 3003.

Messaging.

An Administrator may use the Messaging functionality provided by the server in order to transmit an email message to some or all Eligible Attendees, and such message will include the Personal Event Page GUI Link by which the Eligible Attendee can access the Event Page GUI. In an example of an embodiment, the Administrator may opt to send himself or herself a copy of the message. The copy identifies which Profiles were recipients of the message. In another example of an embodiment, the server provides the option to the Administrator to permit Eligible Attendees to message one another in this same manner.

Preview Page.

In order to facilitate setting up the Event, whether before or after Activation, the server provides options to an Administrator to preview the Event Page GUI and/or the RSVP GUI, as it will appear to a User who accesses such page in User Mode.

Event Page GUI—User Mode.

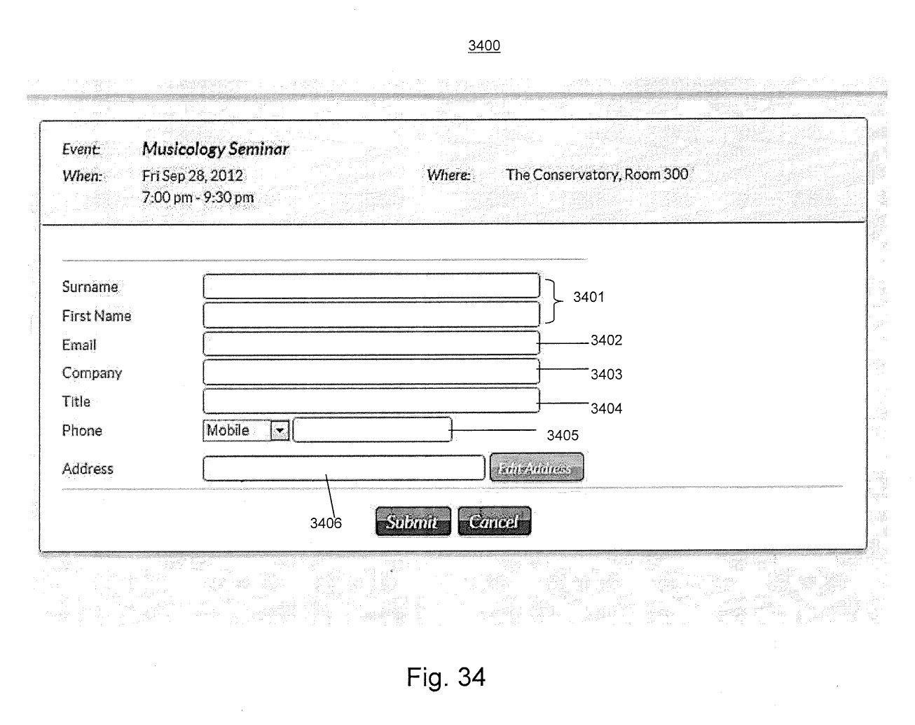

The server allows the Event Page GUI to be viewed in User Mode provided that server has determined the Event has been Activated and further provided that the User is an Eligible Attendee or, if not an Eligible Attendee, the Profile of the User satisfies the criteria of the Privacy Level setting. Subject to any restrictions on viewing rights which may apply to a User pursuant to the Event Setup Options, the following applies to the Event Page GUI when viewed in User Mode. In an example of an embodiment of an Event Page GUI 3100 shown in FIG. 31A, the Event Details 3101 specified by the Administrator are displayed. Provided that the User is an Eligible Attendee, the server causes the User's RSVP Value 3102 to be displayed, and the server will allow the User to access the RSVP GUI so as to submit an RSVP, or a modified RSVP, as the case may be.

The Event Page GUI also contains a table 3103 listing the Eligible Attendees 3105 of the Event, and showing their respective Affiliation Icons 3104, RSVP Values 3106 and RSVP dates 3107. Also, to facilitate interpretation of the results, the “headcount” section 3108 of the Event Page GUI displays each of the possible RSVP Values and the number of individuals associated with each RSVP Value. If the User clicks on one of the RSVP Values in the headcount section 3108, the server causes a table listing the individuals represented by such RSVP Value to be displayed. For example, a control 3109 displays that six individuals have provided the RSVP of “in” and, after selecting this control 3109, the names of the individuals will be displayed. In the table of Eligible Attendees and the headcount tables, the server counts each Guest as a separate Eligible Attendee, although the relationship to the person who sent the RSVP is made clear to the viewer.

Similarly, in the case of a Family/Department Profile for which an RSVP has been submitted, the various individuals represented by the RSVP are shown individually, although the relationship to the Family/Department Profile is made clear to the viewer. A Family/Department Profile for which an RSVP has not been submitted is shown in the Eligible Attendees table as a single entry with a notation which might, for example, read “up to 4 individuals”. The headcount section for “no reply” in this case would show both the number of outstanding RSVPs as well as the maximum number of individuals, excluding Guests, represented by such outstanding. RSVPs.

If the table associated with the headcount section for “no reply” is viewed, it indicates when such Eligible Attendee viewed the Event Page GUI, if at all. If the Event is associated with a Group, the server provides a link identifying the Group by name that can be clicked for quick access to the Group Page GUI, provided that, in the case of User Mode, the User qualifies under the Privacy Level set for the Group.

If the User is also an Administrator of the Event, a control 3110 stating “Switch to Administrator Mode” is displayed to allow the User to switch between displaying the Event Page GUI 3100 in User Mode to Administrator Mode. FIG. 31B shows an example embodiment of an Event Page GUI in Administrator Mode 3411, for the same Event. More controls are provided to modify the Event, copy the Event, etc. Selecting the control 3112 (e.g. “Switch to User Mode”) in FIG. 31B displays the Event Page GUI 3100 of FIG. 31A.

RSVP GUI.

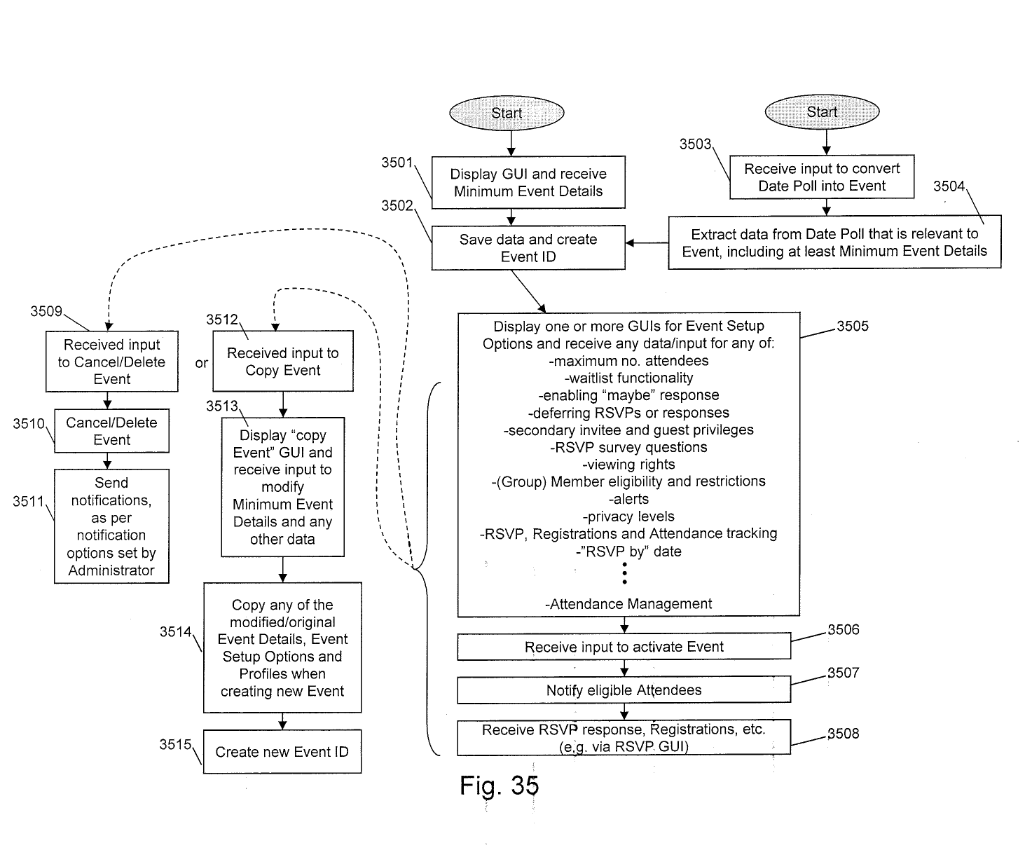

An example of an embodiment of a RSVP GUI for an individual 3200 is shown in FIG. 32. Certain data may be displayed in a read-only format to provide context to the User, such as the name of the Event, the Event Date and its location 3201. The first field 3202 contains the User's response as to whether he or she will attend the Event, that is, the RSVP Value. If the server determines that the Event Setup Options permit the User to bring Guests, the server displays fields allowing the User to indicate whether the User will bring Guests 3203; the number of Guests 3204; the Guest names, if the Event setup so requires; and a link to view the Guest policy, if the Administrator has specified one. There is a field for an optional comment 3205 and a choice as to whether such comment is to be posted and visible to all who may access the Event Page in User Mode 3206, or a choice where it is for the Administrator only 3207. Based on display settings, the server may determine that the comment is intended for viewing solely by the Administrator. If the Event Setup Options contain RSVP survey questions, there will be one field per question.

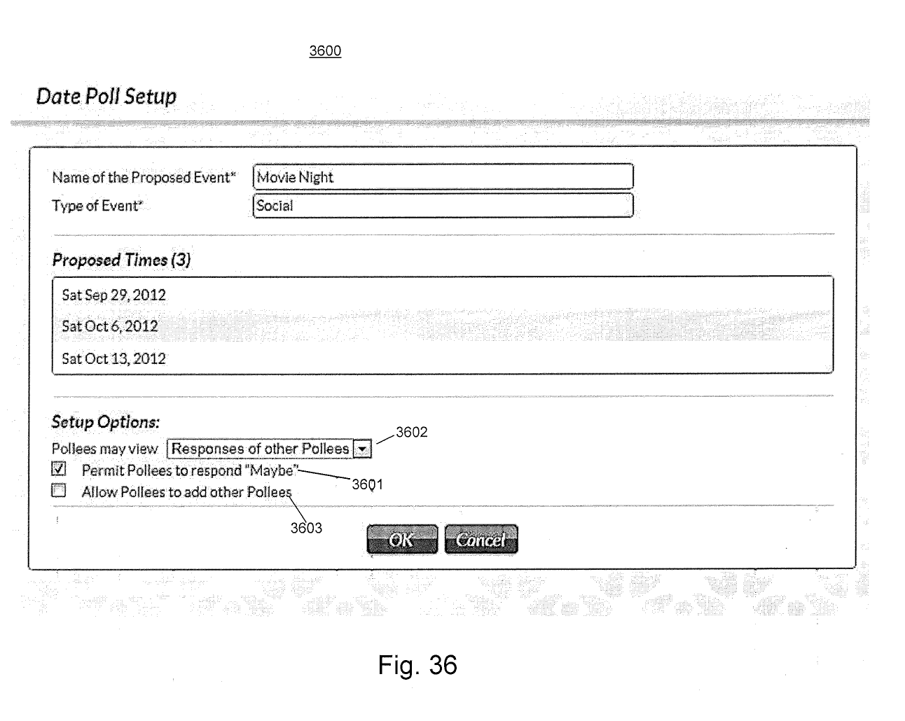

An example of an embodiment of a RSVP GUI for a Family/Department Profile 3300 is shown in FIG. 33. Rather than one field for RSVP Value, there is a table 3301 of names and their respective RSVP Values. The setting in the Family/Department Profile determines the maximum number of individuals represented by the Profile. If the Administrator has not assigned names to all such individuals, the User may add names in the RSVP GUI, up to the maximum number permitted. In an example of an embodiment, to submit an RSVP, the server requires that an RSVP Value, other than “No Reply”, must be provided for each individual named. Other aspects of the RSVP GUI, for example, read-only information, Guests, survey questions, and optional comment, are the same as for the RSVP GUI of an individual Profile.

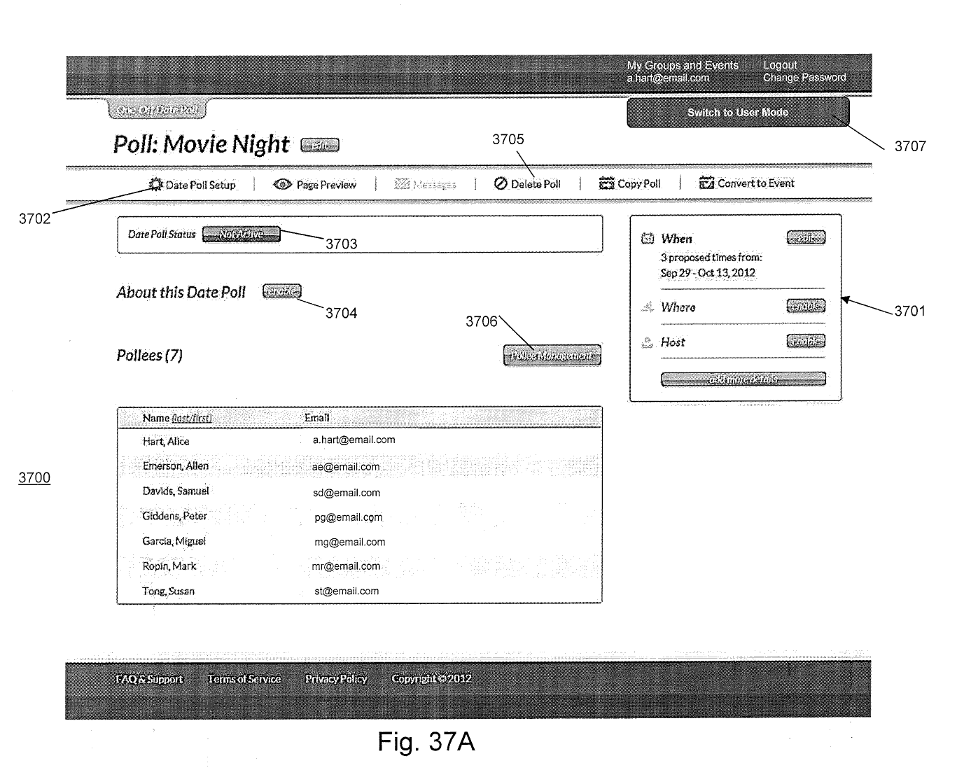

An example of an embodiment of a RSVP GUI for a Registrant 3400 is shown in FIG. 34. Unlike a standard RSVP, a Registration is from an unknown party in that the User submitting the Registration may not already have a Profile within the Primary Entity and need not be Logged in to the Event Organizing Software in order to submit the Registration. This RSVP GUI contains mandatory fields for a name 3401 and an email address 3402, as well as fields for such additional information as the Administrator specifies, for example, a company/organization 3403, title 3404, phone number 3405 and address 3406. Other aspects of the RSVP GUI, for example, read-only information, Guests, survey questions, and optional comment, are the same as for the RSVP GUI of an individual Profile. In an example of an embodiment, the optional comment of a Registrant, if one is submitted, can be directed to the Administrator only. The date and time of each RSVP is saved to the server memory, and may be viewed by a User.

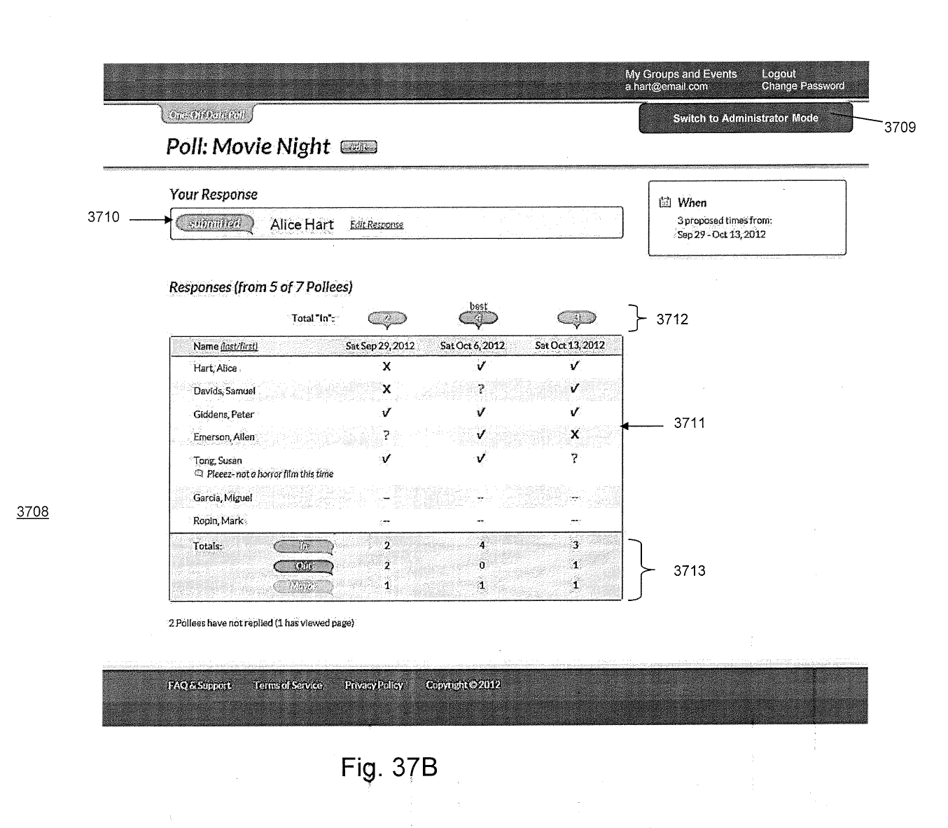

Turning to FIG. 35, an example embodiment of computer executable or processor implemented instructions are provided for creating an Event. The process can start at block 3501 by displaying a GUI for the server to receive Minimum Event Details. The server then saves the data and creates an Event ID (block 3502). The process can alternatively start by the server receiving an input to convert a Date Poll into an Event (block 3503) and the server extracting data from the Date Poll that is relevant to the Event (block 3504). In an example of an embodiment, the extracted data includes at least the Minimum Event Details. Block 3504 continues to block 3502. The process continues by the server displaying one more GUIs for Event Setup Options and receiving data or input related to, among other data, any of: maximum number attendees, waitlist functionality, enabling “maybe” response, deferring RSVPs or responses, secondary invitee and guest privileges, RSVP survey questions, viewing rights, (Group) Member eligibility and restrictions, alerts, privacy levels, RSVPs, Registrations and the Signup Method, “RSVP by” date, and Attendance Management (block 3505). These are non-limiting examples.

The server receives an input to activate the Event (block 3506) and then notifies eligible Attendees (block 3507). The server then receives RSVP responses, Registrations, etc. (block 3508). The server can facilitate the receipt of this information by displaying RSVP GUIs.

Throughout any of blocks 3505, 3506, 3507, and 3508, the server can also receive an input to Cancel or Delete the Event (block 3509), or receive an input to copy the Event (block 3512). In the case of block 3509, the server then Cancels or Deletes the Event (block 3510) and sends notifications as per notification options set by the Administrator (block 3511).

In the case of block 3512, the server displays a “copy Event” GUI and receives input to modify Minimum Event Details and any other data (block 3513). The server then copies any of the modified or original data, or both, pertaining to the Event, including the Profiles, when creating the new Event (block 3514). The server also creates a new Event ID (block 3515).

### Processing a Date Poll—GUI Elements

Creating a Date Poll.

There are different starting approaches to creating a Date Poll. In an example of an embodiment, from the User Home Page GUI, a User who has Logged in can select to create a One-Off Date Poll. In another example of an embodiment, a Demo User can select to create a One-Off Date Poll from the home page of the Event Organizing Software. In another example of an embodiment, the Administrator of a Group can select to create a new Date Poll for such Group from the Group Page GUI, Administrator Mode.

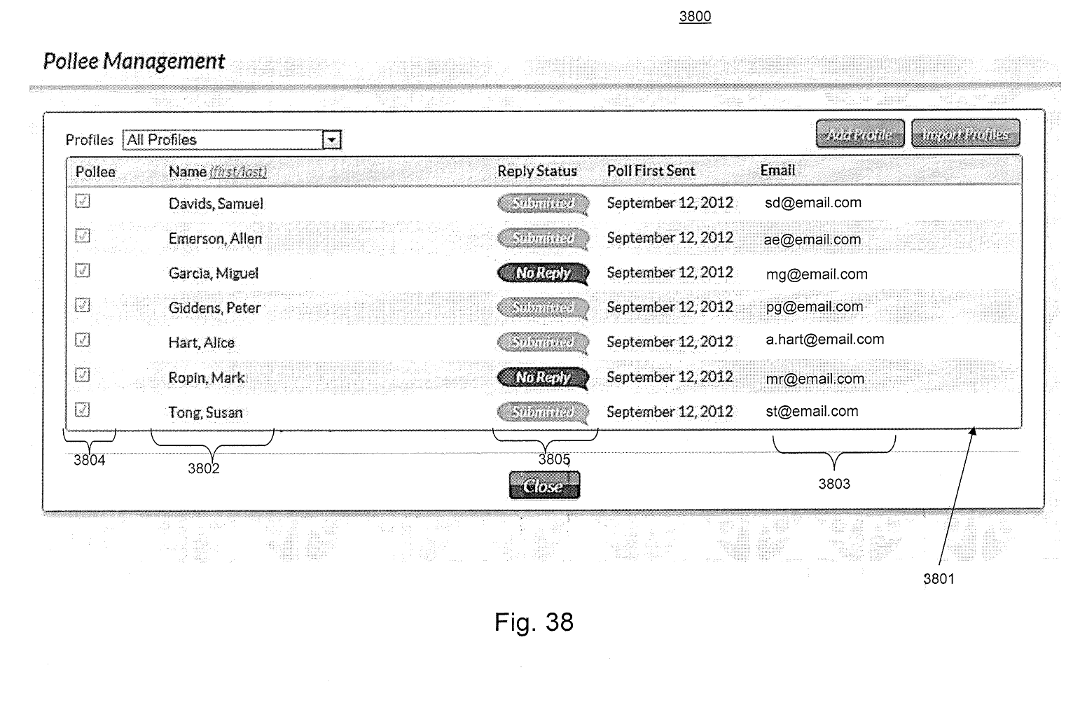

After selecting any of these starting approaches to create a Date Poll, a GUI is displayed which prompts for the Minimum Date Poll Details. Such an example of an embodiment of a GUI is shown in FIG. 36. The GUI allows the User to provide: the name of the proposed Event, one or more Polled Dates, and options for configuring the Date Poll. In the case of a One-Off Date Poll, the User is also prompted for the type of Event to which the Date Poll relates. This information is received by the server and is used to create the Date Poll. After saving the data, the server assigns a Date Poll ID which uniquely identifies the Date Poll. The server automatically creates a Profile for the User and the server designates it as an Administrator of the Date Poll.

Configuring the Date Poll.

An example of an embodiment of a GUI for selecting the options for configuring the Date Poll 3600 is shown in FIG. 36. In an example of an embodiment, the options for configuring the Date Poll include permitting a Pollee to respond “maybe” for any Polled Dates 3601 (if not permitted, then the Pollee must respond either “in” or “out”); setting the viewing rights of Pollees with respect to the results of the Date Poll 3602, for example, to view each Date Poll Response, to view the tally only, or to view neither; and specifying whether Pollees may add other Pollees 3603.

Date Poll Page GUI—Administrator Mode.

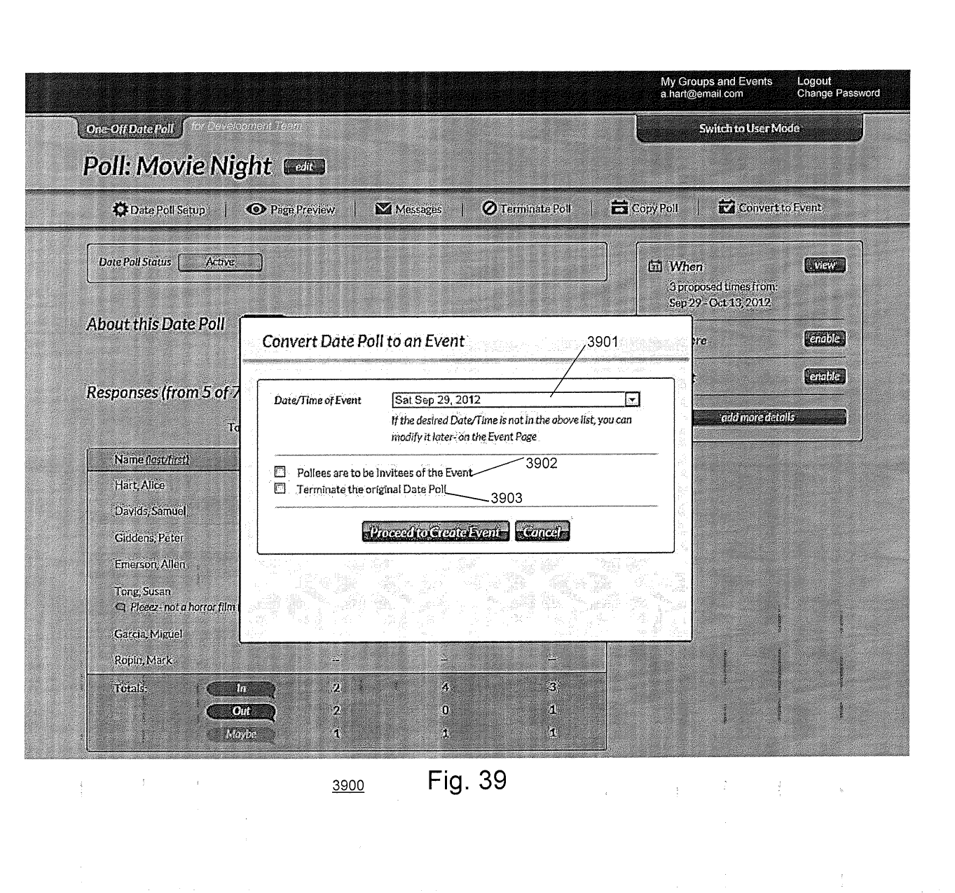

After the Minimum Date Poll Details have been submitted to the server, the server allows the Date Poll Page GUI to be displayed. An example of an embodiment of such a GUI 3700 is shown in FIG. 37A. Until the Date Poll has been Activated, the server only allows the Date Poll Page GUI to be viewed in Administrator Mode. In Administrator Mode; the server provides the Date Poll Page GUI that includes controls to modify Date Poll Details 3701, Date Poll Setup Options 3702, and Profiles. The Activation Status 3703 of the Date Poll is also displayed.

There are also controls by which the Administrator can Activate a Date Poll. In an example of an embodiment, the control for Activating the Date Poll is 3703, which also provides the Activation Status. There are other controls to delete an unactivated Date Poll 3705 or to terminate an Activated Date Poll. Control 3704 enables the display of Date Poll information. Date Poll Details and Date Poll Setup Options can be added, deleted or modified from time to time, as the Administrator chooses, both before and after Activation. In an example of an embodiment, following Activation of the Date Poll, the server does not allow the Administrator to perform certain functions such as modifying Polled Dates or “uninviting” Pollees. Following Activation, the Date Poll Page GUI is updated to display the current results of the Date Poll (e.g. responses of Users relating to each of the Polled Dates) in the same manner as described below for User Mode.

If the Administrator selects the control “Switch to User Mode” 3707, the server will cause the Date Poll GUI in Administrator Mode 3700 to switch to a Date Poll GUI in User Mode 3708 for the same Date Poll, as shown in FIG. 37B.

In FIG. 37B, the Date Poll GUI in User Mode 3708 includes a control 3709 to switch the display back to Administrator Mode (3700). In User Mode, an indicator as to whether the User has responded to the Date Poll 3710 is shown. A table 3711 also shows a summary of the Pollees, and their responses with respect to each of the one or more Polled Dates. A summary 3712 shows the total number of positive responses with respect to each of the Polled Dates. For example, there may be a total of two positive responses for a first Polled Date, and a total of four positive responses for a second Polled Date. Another summary 3713 shows the total number of positive responses (e.g. “in”), the total number of negative responses (e.g. “out”), and the total number of “maybe” responses with respect to each Polled Date.

Pollee Management.

From the Date Poll Page GUI, in the Administrator Mode, an Administrator may select “Pollee Management” 3706. An example of the “Pollee Management” GUI 3800 is shown in FIG. 38. In an example of an embodiment, subject to the ability of the User to filter the list, all Profiles of the Primary Entity are displayed in the rows of a table 3801. If the server detects that the Date Poll has not been Activated, the server displays the table containing columns for name 3802, email address 3803 and a checkbox 3804 to signify whether the Profile is a Pollee. Until the Date Poll has been Activated the server allows the Administrator to check and uncheck the checkbox to add or remove Pollees. The Administrator may also add new Profiles. Following Activation, the server provides a table that contains an additional column for the Date Poll Response Value 3805. In Administrator Mode, clicking on the Date Poll Response Value causes the server to display the Date Poll Response GUI, which may then be completed or modified by the Administrator on behalf of the Pollee. Clicking elsewhere in the row will open the Profile.

Activating the Date Poll.

When the Date Poll Page GUI has been configured to the Administrator's satisfaction, in terms of Date Poll Details, Date Poll Setup Options, Pollees, etc., the Administrator can Activate the Date Poll. Until Activated, the server only allows the Date Poll Page GUI to be viewed by an Administrator, in Administrator Mode. Once Activated, the server transmits the appropriate communications containing Personal Date Poll Page GUI Links, and the server allows the Date Poll Page GUI to be viewed in either User Mode, by a Pollee, or in Administrator Mode, provided that the User is an Administrator. Pollees may view the Date Poll Page GUI and the Date Poll Response GUI in User Mode and may submit or amend their Date Poll Responses. An individual who is entitled to view the Date Poll Page GUI in both Administrator Mode and User Mode may switch modes using the control provided for this purpose. The server does not permit a Date Poll which is associated with a Group to be Activated unless the server detects that the Group itself has first been Activated.

Notifying Pollees.

Pollees may be added both before and after Activation of the Date Poll. The server sends notification of the Date Poll to Pollees at the time that the Date Poll is Activated. If a Profile is added as a Pollee following Activation, then the server sends such notification at the time that the Profile is added. The server includes in the notification, sent to the Pollee, a Personal Date Poll Page GUI Link. The Pollee may click on the link, or Log in to the Event Organizing Software, to view the Date Poll Page GUI and respond to the Date Poll. The date and time of transmitting each such email notification is saved to the server memory, and may be viewed by the Administrator.

Copy Date Poll.

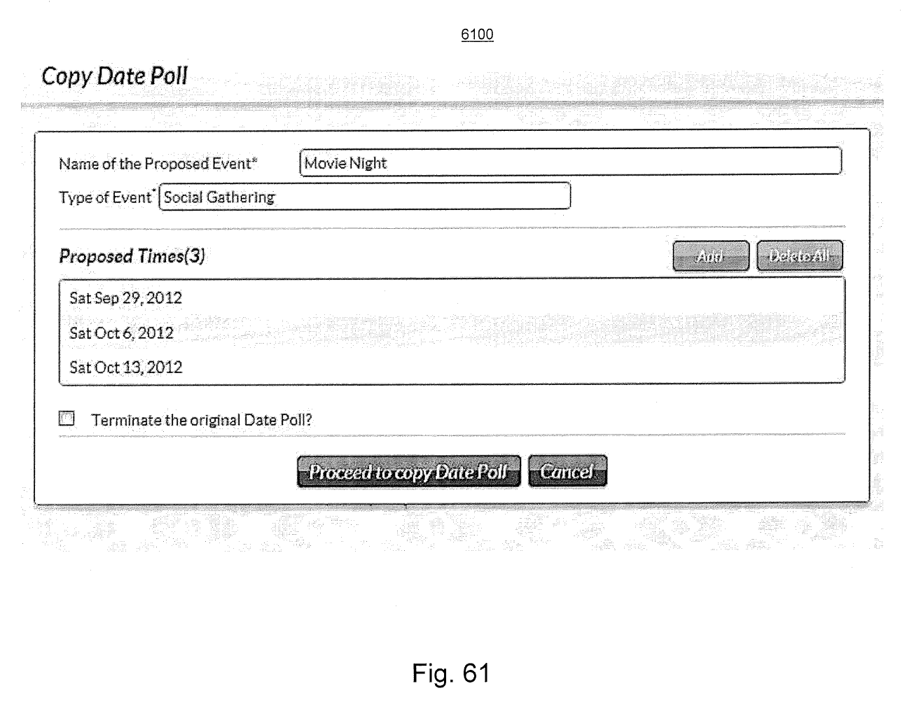

From the Date Poll Page GUI, in the Administrator Mode, a control is provided which enables the Date Poll to be copied. An example embodiment of a “copy Date Poll” GUI 6100, in which the Administrator may modify any of the Minimum Date Poll Details, is shown in FIG. 61. For example, the name of the proposed Event, the type of Event, and Polled Dates may be added or deleted. The Administrator may also indicate whether to terminate the original Date Poll. After the server receives an input to proceed with copying the Date Poll, the server creates and saves a new Date Poll, with its own Date Poll ID.

The resulting new Date Poll contains a copy of the Date Poll Details and Date Poll Setup Options of the original Date Poll. In the case of a One-Off Date Poll, the server copies the Profiles, including information as to their affiliation with the Date Poll, for example, the Administrator and the Pollee(s). In the case of a Date Poll associated with a Group, the server copies from the original Date Poll information as to which Profiles are Pollees. Date Poll Responses are not copied. Regardless of what the Activation Status of the original Date Poll, the server sets the new Date Poll to a state of “not Activated”. In the case of a One-Off Date Poll, the new Date Poll is a completely independent Entity, and does not reference the original Date Poll or its Profiles, although the copied Profiles will reference common User Accounts. Similarly, in the case of a Group, the new Date Poll does not reference the one which was copied, although both are under the same Group and therefore share the same Profiles.

Terminate/Delete Date Poll.

An Administrator may delete a Date Poll which has not yet been Activated. An Administrator may terminate a Date Poll which has been Activated.

Converting a Date Poll to an Event.

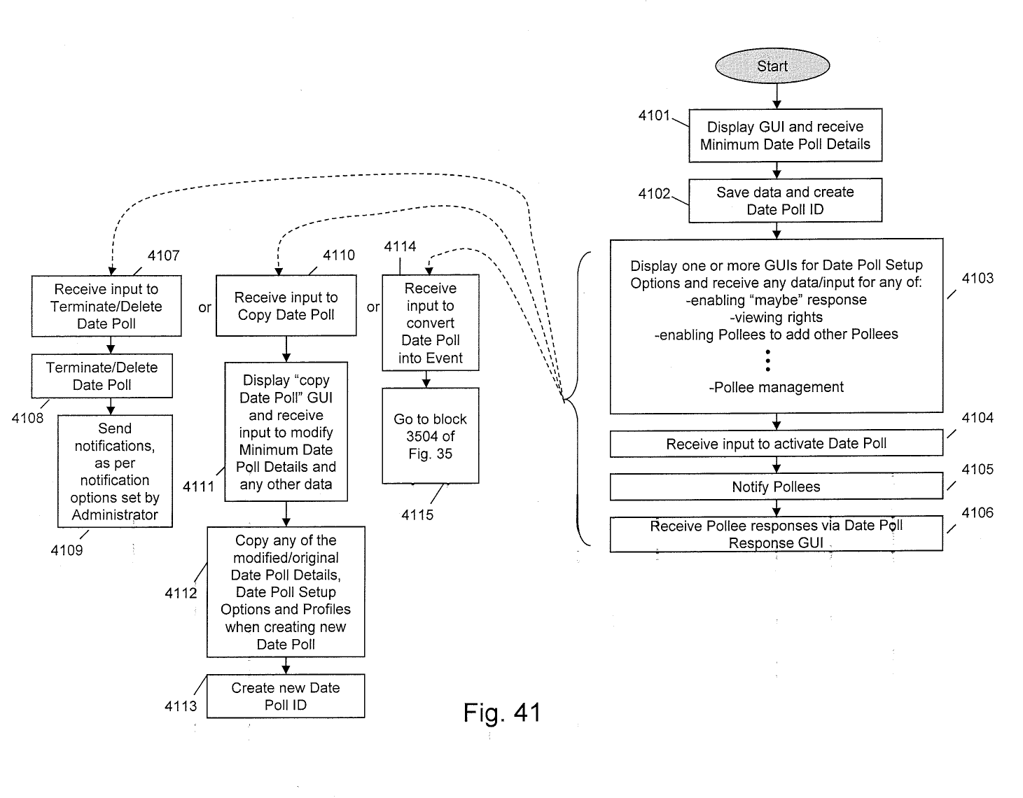

From the Date Poll Page GUI, in the Administrator Mode, a control is provided which enables the Date Poll to be converted into an Event. An example of an embodiment of a “convert to Event” GUI 3900 is shown in FIG. 39. A selection control 3901 is provided to allow the Administrator to pick one of the Polled Dates to be the Event Date. If the server detects that the Pollees are not Members of the Parent Group, the server also allows the Administrator to designate that such Pollees of the Date Poll are to be Invitees of the Event 3902. In an example of an embodiment, if the Administrator does direct that Pollees be converted to Invitees, the Administrator can also determine whether the Pollee's response to the selected Polled Date should be converted into an Event RSVP. The Administrator may also indicate whether to terminate the original Date Poll 3903. After the server receives an input to proceed with converting the Date Poll to an Event, the server creates and saves a new Event with its own Event ID.

The server copies Date Poll Details, and uses this information as Event Details within the new Event. In the case of a One-Off Date Poll, the Profiles are copied. The server sets the new Event to a state of “not Activated”. In the case of a One-Off Date Poll, the new Event is a completely independent Entity, and does not reference the original Date Poll, although the copied Profiles reference common User Accounts. Similarly, in the case of a Group, the new Event does not reference the Date Poll which was copied, although both are under the same Group and therefore share the same Profiles.

Messaging.

An Administrator may use the Messaging functionality to transmit an email message to some or all Pollees, and the server includes in such message the Personal Date Poll Page GUI Link by which the Pollee can access the Date Poll Page GUI. In an example of an embodiment, the Administrator may opt to send to himself or herself a copy of the message. The copy of the message also identifies the Profiles which are recipients of the message. In another example of an embodiment, the Administrator may provide an input to the server to permit Pollees to message one another in this same manner.

Preview Page.

In order to facilitate setting up the Date Poll, whether before or after Activation, an Administrator may choose to preview the Date Poll Page GUI and/or the Date Poll Response GUI, as it would appear to a Pollee who accesses such page in User Mode.

Date Poll Page GUI—User Mode.

If the server detects that the Date Poll has been Activated and is current, for example, not all Polled Dates have passed, the server allows the Date Poll Page GUI to be viewed by a Pollee in User Mode. Subject to any restrictions on viewing rights which may apply to a User, the following applies to the Date Poll Page GUI when viewed in User Mode. The server displays the Date Poll Details as specified by the Administrator. The User's Date Poll Response Value is displayed and the User may access the Date Poll Response GUI so as to submit a Date Poll Response, or a modified Date Poll Response, as the case may be.

The Date Poll Page GUI contains a table for which there is one row per Pollee and one column per Polled Date. For each cell where a Polled Date intersects with a Pollee who has replied to the Date Poll, the Pollee's response, whether “in”, “out” or “maybe”, with respect to the particular Polled Date, is displayed. To facilitate interpretation of the results, the server tallies and displays the responses for each Polled Date. The server also determines whether a Pollee who has not submitted a Date Poll Response has viewed the Date Poll Page GUI, and the server may display this status information to the User. Whether in Administrator Mode or User Mode, if the Date Poll is associated with a Group, a link identifying the Group by name may be clicked for quick access to the Group Page GUI, provided that, in the case of User Mode, the User qualifies under the Privacy Level set for the Group.

Date Poll Response GUI.

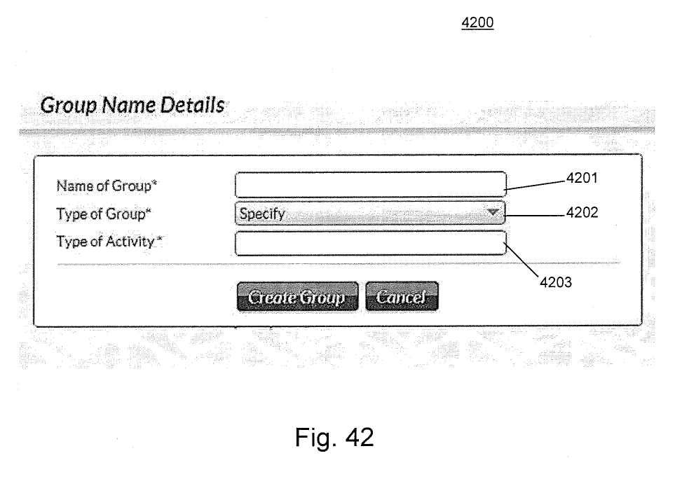

An example of an embodiment of a Date Poll Response GUI 4000 is shown in FIG. 40. Certain data 4001 may be displayed in a read-only format to provide context to the User, for example the name and the location of the proposed Event. For each Date Polled, the server requires the User to submit a response as to whether the User intends to attend, does not intend to attend or, if permitted in the Date Poll Setup Options, may attend 4002. After such response is received, the server accepts the Date Poll Response from the User. There is a field for an optional comment 4003 and a choice as to whether such comment is to be posted and visible to all who may access the Date Poll Page in User Mode 4004, or whether it is intended for viewing solely by the Administrator 4005. The date and time of each Date Poll Response is saved to the server memory, and may be viewed by a User.

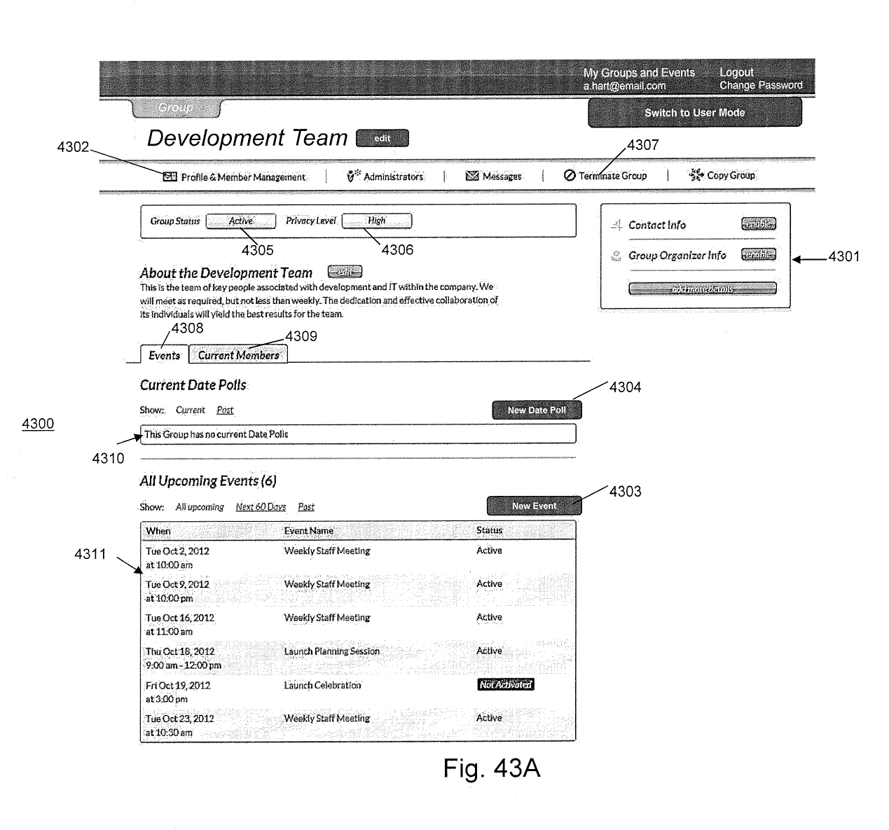

Turning to FIG. 41, an example of an embodiment of computer executable or processor implemented instructions is provided for creating a Date Poll. At block 4101, the server displays a GUI and receives the Minimum Date Poll Details. The server saves the data and creates a Date Poll ID (block 4102). At block 4103, the server displays one or more GUIs to receive any data or input related, by way of example, to any of: enabling a “maybe” response, viewing rights, enabling Pollees to add other Pollees, and Pollee management. These examples are non-limiting. After receiving an input to activate the Date Poll (block 4104), the server notifies Pollees (block 4105). The server receives Pollee responses, for example, facilitated through a Date Poll Response GUI (block 4106). Throughout blocks 4103, 4104, 4105 and 4106, the server can receive an input for any of the following: to terminate or delete the Date Poll (block 4107); to copy the Date Poll (block 4110); and to convert the Date Poll into an Event (block 4114).

If an input is received as per block 4107, the server terminates or deletes the Date Poll (block 4108) and sends notifications as per the notification options set by the Administrator (block 4109).

If an input is received as per block 4110, then the server displays a “copy Date Poll” GUI and receives input to modify Minimum Date Poll details and any other data (block 4111). The server copies any of the modified or original data, or both, and the Profiles, when creating the new Date Poll (block 4112). The server also creates a new Date Poll ID (block 4113). In an example of an embodiment, the Profiles would only be copied in the case of a One-Off Date Poll. Otherwise, the Group Profiles which were Pollees of the original Date Poll are set as Pollees of the new Date Poll.

If an input is received as per block 4114, the process continues to block 3504 of FIG. 35 (block 4115).

### Processing a Group—GUI Elements

Creating a Group.

There are different starting approaches to creating a Group. In an example of an embodiment, from the User Home Page GUI, a User who has Logged in can select to create a new Group. In another example of an embodiment, a Demo User can select to create a Group from the home page of the Event Organizing Software.

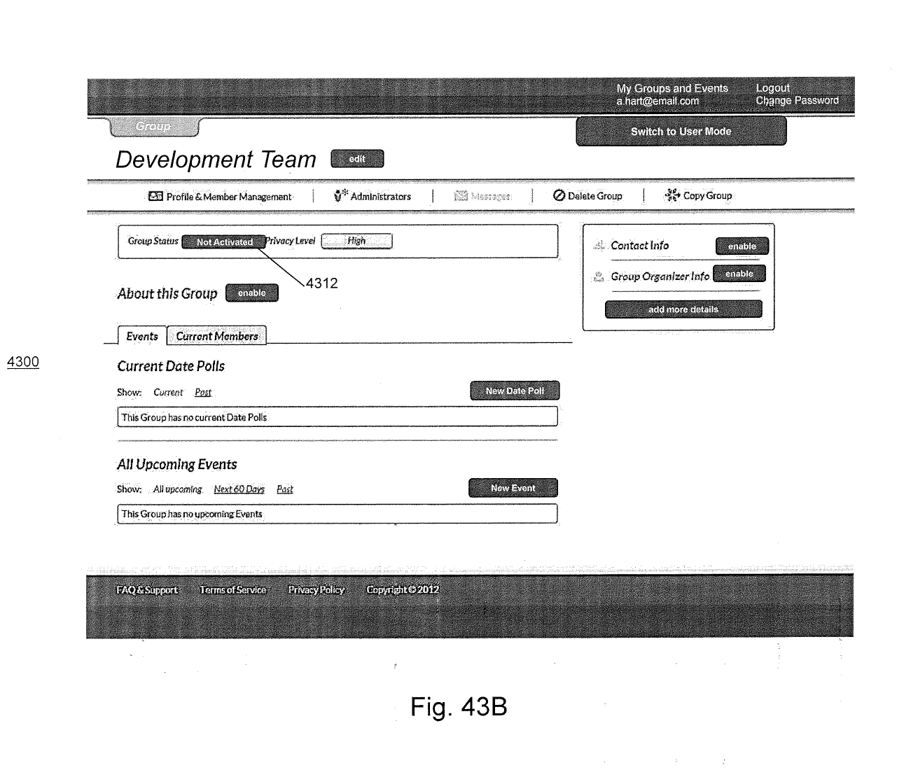

After selecting to create a Group using one of these approaches, the server displays a GUI which prompts for Minimum Group Details. An example of an embodiment of a GUI 4200 is shown in FIG. 42. The GUI allows the User to provide: the name of the Group 4201 and the type of Group 4202, for example, sport, academic, etc. Other information can include the type of activity 4203. This information is received and saved by the server and is used to create the Group. The server assigns a Group ID which uniquely identifies the Group. A Profile for the User is created automatically by the server and is designated by the server as an Administrator of the Group.

Privacy Level.

In an example of an embodiment, a Group may have a Privacy Level of “high” if the Group Page GUI is viewable by current Members only; a Privacy Level of “medium” if the Group Page GUI is viewable by anyone with a Profile within the Group, whether or not a current Member; or a Privacy Level of “low” if the Group Page GUI is viewable by the general public. If the server detects that a Group has a Privacy Level of “low”, after Activation of the Group, the server displays the Public Group Page GUI Link in the Group Page GUI in order that it may be disseminated, for example, by email or by publishing it on a website, to the intended recipients or general public.

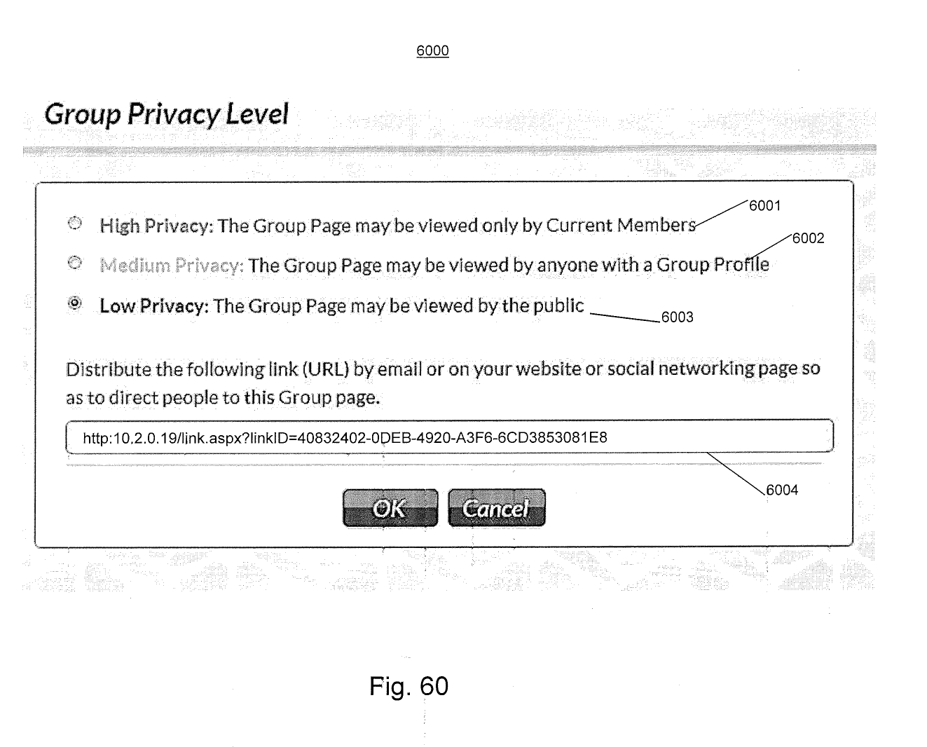

Another setting relating to privacy is the setting which determines whether Users may view the names and Profile information associated with other Profiles. These rights are assigned by Member Class, subject to Class Exceptions, and are applied to all Events and Date Polls associated with the Group. An example of an embodiment of a GUI 6000 in FIG. 60 shows option for setting the Group Privacy Level to one of High 6001, Medium 6002, or Low 6003. The server also generates a URL link and displays it in a field 6004. The URL link can be distributed to direct people to the Group page. The URL link can be copied from the field 6004 and pasted into communication media.

Group Page GUI—Administrator Mode.

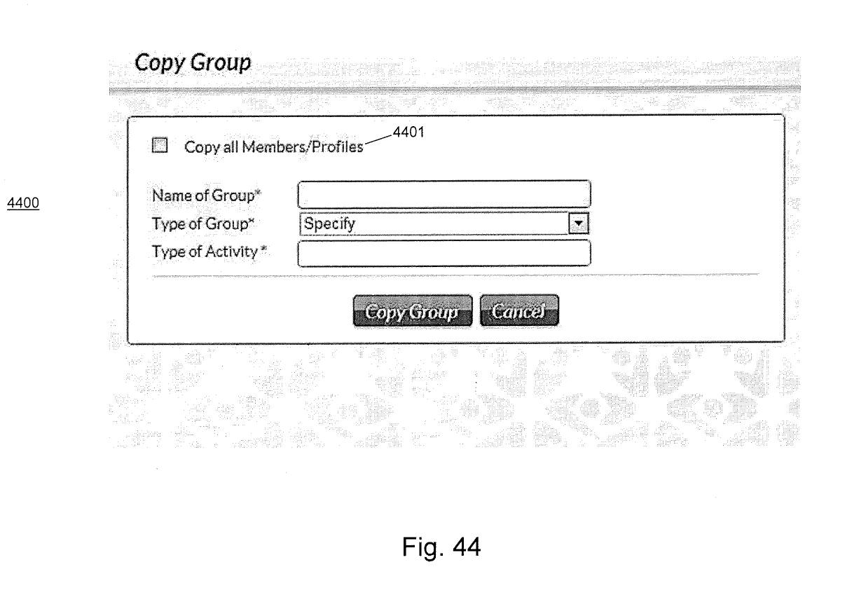

After the minimum Group Details have been received by the server, the server displays the Group Page GUI. An example embodiment of such a GUI 4300 is shown in FIG. 43A. Until the server detects that the Group has been Activated, the server will only allow the Group Page GUI to be viewed in the Administrator Mode. In the Administrator Mode, the server provides a Group Page GUI that includes controls to modify Group Details 4301 and to create and manage Profiles and Memberships 4302 as well as controls to create Events 4303 and Date Polls 4304 associated with the Group. The Activation Status 4305 and the Privacy Level 4306 of the Group are also displayed. There are also controls by which the Administrator can Activate a Group, delete an unactivated Group, or terminate an Activated Group 4307. Group Details can be added, deleted or modified from time to time, as the Administrator sees fit, both before and after Activation. The Group Page GUI contains two tabs, an “Events” tab 4308 and a “Current Members” tab 4309.

The “Events” tab contains a Date Polls table 4310 and an Events table 4311, which lists the Date Polls and the Events, respectively, of the Group. In the Administrator Mode, the server displays a Date Polls table that shows, for each Date Poll, the proposed Event name, the number and range of Polled Dates and the Activation Status of the Date Poll. The Events table shows, for each Event, the Event name, the Event Date and the Activation Status of the Event. Clicking any row opens the selected Date Poll or Event.

The other tab, being the “Current Members” tab, lists, by name and email address, all of the current Members of the Group. Clicking any row will open such Profile. The “Profile and Member Management” control enables the Administrator to add, delete or modify Profiles and/or Memberships from time to time, as the Administrator chooses, both before and after Activation of the Group. This is discussed in more detail in the “Profiles and Memberships” section below.

FIG. 43B shows another example of an embodiment of the Group Page GUI 4300, although it has not yet been activated. It includes, among other things, a control 4312 for Activating the Group.

Activating the Group.

When the Group Page GUI is configured, in terms of Group Details, Memberships, etc., to the satisfaction of the Administrator, the Administrator can Activate the Group. Until Activated, the Group Page GUI can be viewed only by an Administrator, in the Administrator Mode. After the server detects that the Group has been Activated, the server transmits appropriate communications containing Personal Group Page GUI Links, and the server allows the Group Page GUI to be viewed in either User Mode, by any User who qualifies based on the Privacy Level set for the Group, or in Administrator Mode provided that the User is an Administrator. If the server detects that a Group has a Privacy Level of “low”, following Activation, the server causes a Public Group Page GUI Link to be displayed in the Group Page GUI in order that the link may be disseminated in the manner desired by the User, for example, by email, web link, social network page, etc. An individual entitled to view the Group Page GUI in both the Administrator Mode and the User Mode may switch modes using the control provided for this purpose. The server does not allow Date Polls and Events which are associated with the Group to be Activated unless the server detects that the Group itself has first been Activated.

Notifying Members.

Memberships may be created, terminated or modified both before and after Activation of the Group. This functionality is described in greater detail in the “Profiles and Memberships” section below. If Membership is created before activation, the server sends to new Members notification at the time that the Group is Activated. If a Membership is created following Activation, then such notification is sent at the time that the Membership is created, and the server includes in the notification information about the number of upcoming Events for which the individual is an Eligible Attendee. The server includes a Personal Group Page GUI Link in the notification sent to the Member. The Member may click on the link, or Log in to the Event Organizing Software, to view the Group Page GUI. The date and time of transmitting each such email notification is saved to the server memory, and may be viewed by the Administrator.

Copy Group.

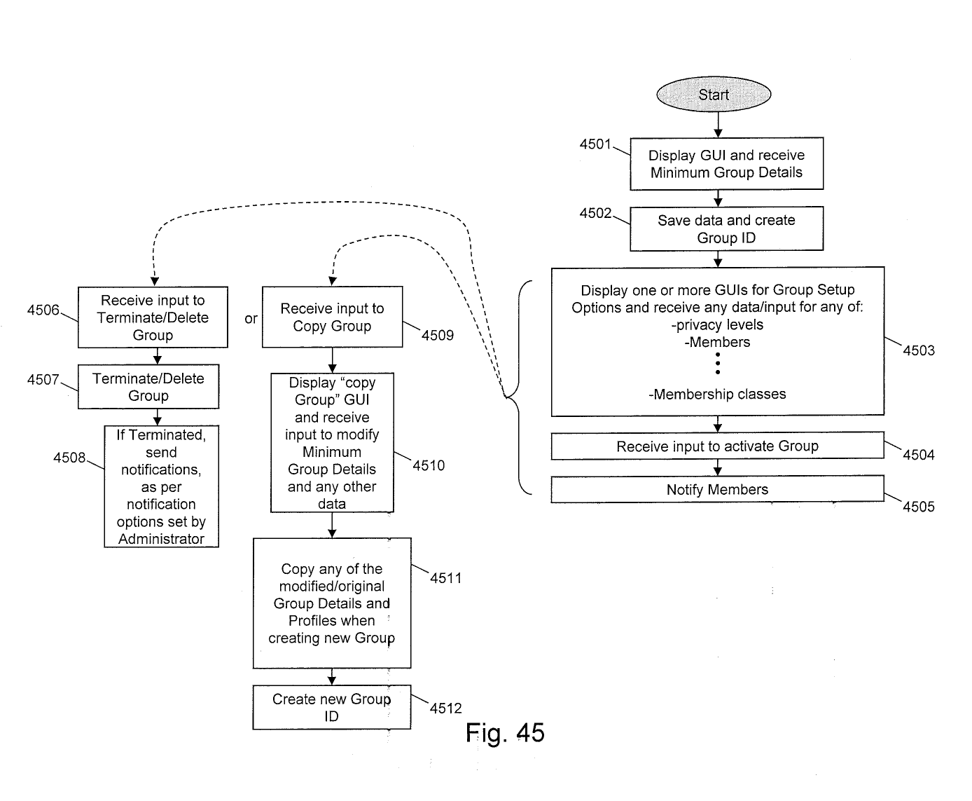

From the Group Page GUI, in the Administrator Mode, a control is provided which enables the Group to be copied. However, in an example of an embodiment, copying the Group does not include copying its associated Events and Date Polls. An example of an embodiment of a “copy Group” GUI 4400, in which the Administrator may modify any of the Minimum Group Details, is shown in FIG. 44. Details, for example, name, type, group description, etc., can be copied or modified through the GUI 4400. The Administrator may also indicate whether Profiles of the original Group are to be copied to the new Group 4401. After the server receives an input to proceed with copying the Group, the server creates and saves a new Group with its own Group ID. The resulting new Group contains a copy of the Group Details of the original Group, and any modifications thereof. If so specified, the server copies the Profiles. In an example of an embodiment, no matter what the Activation Status of the original Group, the new Group is set by the server to a state of “not Activated”. The new Group is a completely independent Entity, and does not reference the original Group or its Profiles, although the copied Profiles will reference common User Accounts.

Terminate Group.

An Administrator may delete a Group which has not yet been Activated. An Administrator may terminate a Group which has been Activated, in which case the Administrator is prompted to choose whether email notification of such termination should be sent to all Profiles of the Group, to current Members only, or to no one.

Messaging.

An Administrator may use the Messaging to transmit an email message to some or all Profiles associated with the Group. Such message includes the Personal Group Page GUI Link by which the individual can access the Group Page GUI. In an example of an embodiment, the Administrator may opt to send himself or herself a copy of the message. The copy of the message also identifies the Profiles which are recipients of the message. In another example of an embodiment, the Administrator may specify the server to permit specified Classes of Profiles to message one another in this same manner.

Preview Page.

To facilitate setting up the Group, whether before or after Activation, an Administrator may choose to preview the Group Page GUI, as it would appear to a User who accesses such page in User Mode.

Group Page GUI—User Mode.

If the server detects that the Group has been Activated and has not been terminated, and the Profile of the User satisfies the criteria of the Privacy Level setting of the Group, the server allows the Group Page GUI to be viewed by the User in User Mode.

When the Group Page GUI is viewed in the User Mode, the server displays Group Details specified by the Administrator. The Group Page GUI is essentially as described above for the Administrator Mode except that the Date Poll and Event tables do not contain a column for the Activation Status of the Entity. However, the Date Poll and Event tables do contain a column for the Date Poll Response Value or the RSVP Value, as the case may be, for such User. In an example of an embodiment, past Date Polls may not be viewed in the User Mode. The ability of the User to click a row to open a Date Poll, an Event or a Profile is subject to the right of the User to view such data. If the server detects that the User is also an Administrator, and if there are Events or Date Polls which have not been Activated, a notice to this effect is displayed by the server in the User Mode. For example, the notice instructs the User to change to the Administrator Mode to access such unactivated Entities.

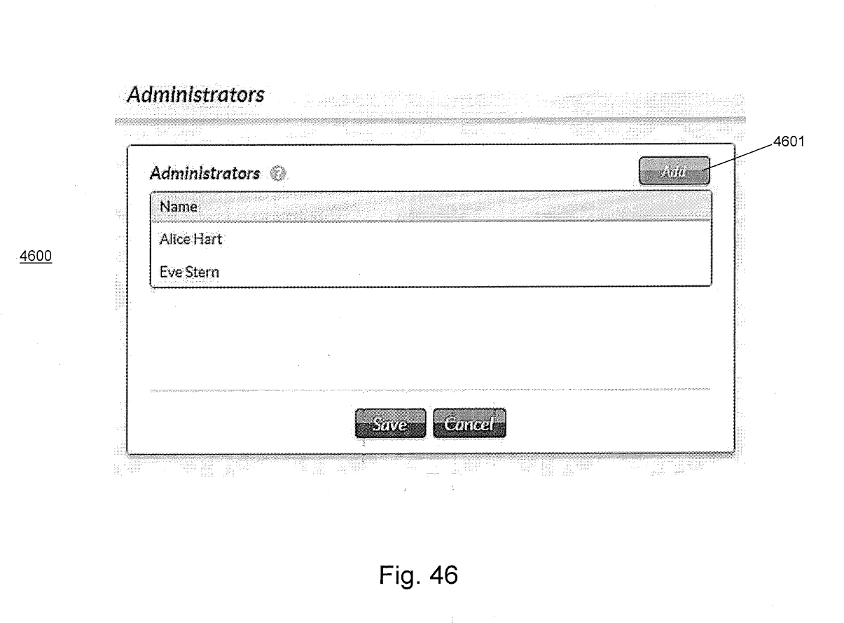

Turning to FIG. 45, an example embodiment of computer executable or processor implemented instructions is provided for creating a Group. At block 4501, the server displays a GUI and receives minimum Group Details. The server saves the data and creates a Group ID (block 4502). The server displays one or more GUIs to receive data or input, or both, related to any of: privacy levels, Members, and Membership classes (block 4503). These examples are non-limiting. The server then receives an input to activate the Group (block 4504) and accordingly notifies the Members (block 4505). Throughout any of blocks 4503, 4504, and 4505, the server can also receive an input to terminate or delete the Group (block 4506) or to copy the Group (block 4509). In following block 4706, the server terminates or deletes the Group (block 4507). If terminated, the server sends notifications as per notification options set by the Administrator (block 4508),

In following block 4509, the server displays a “copy Group” GUI and receives input to modify Minimum Group Details and any other data (block 4510), The server copies any of the modified or original Group Details and Profiles when creating the new Group (block 4511), and creates a new Group ID (block 4512).

### Administrators

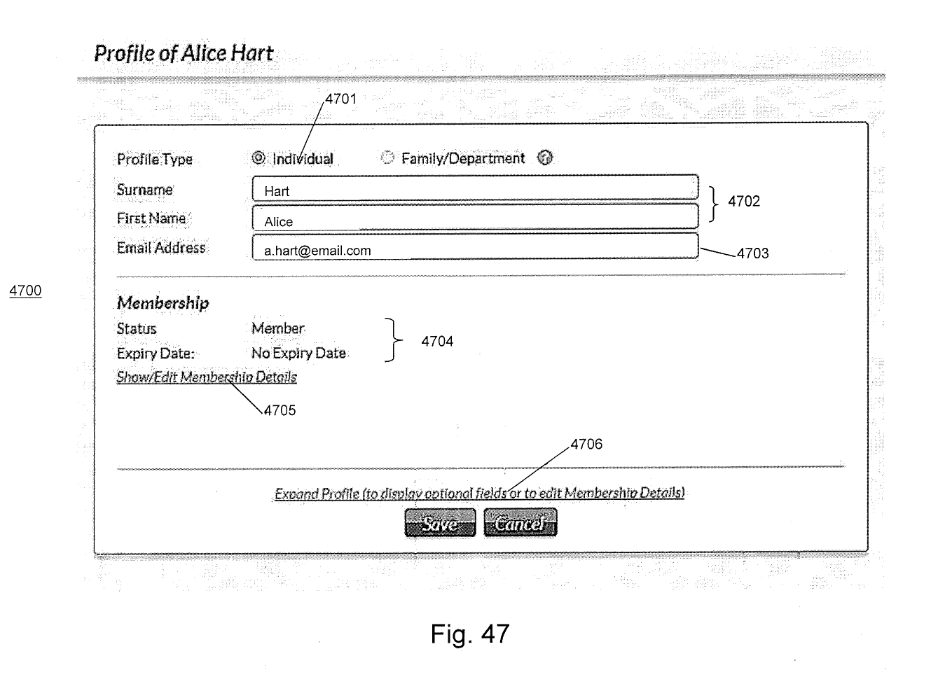

Administrators are associated with the Primary Entity. Refer to the section “Terminology” in this application, which includes information about an Administrator, the first Administrator and the role of the Administrator. An example of an embodiment of a GUI 4600 relating to Administrators is shown in FIG. 46. In this example of the embodiment, the Administrator may add or remove Administrators using control 4601. In another example of an embodiment which may be applied to a Group, the Administrator may designate who shall be Administrators according to their Class of Profiles, subject to Class Exceptions. An Administrator can remove or terminate any Administrator, including himself or herself, provided that there is at least one Administrator remaining thereafter. The control which opens this GUI is in the Entity Page GUI of the Primary Entity, for example, the Group Page GUI or the One-Off Event Page GUI or the One-Off Date Poll Page GUI. In the case of a Group, the Administrator of the Group also administers all Events and Date Polls associated with such Group.

### Profiles, Profile Management and Member Management

Profiles.

A “Profile” stores information about a particular individual or, in the case of a Family/Department Profile, about a plurality” individuals with a commonality. When a User selects to create a new Profile or to access the GUI of an existing Profile, for simplicity, a “contracted” view of the Profile is presented. The “contracted” view displays a summary of certain key information, for example, the name, the email address, and the current Membership within the Group. A link is presented by which the User may expand and contract the Profile to show more or fewer data fields.

Individual Profiles.

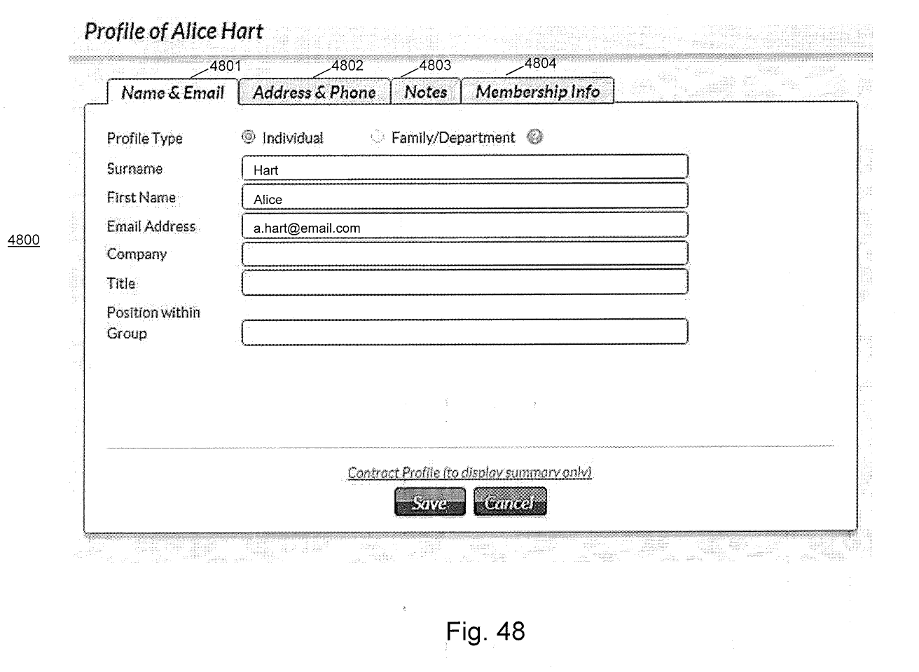

An individual Profile stores information about a particular individual. An example of an embodiment of a GUI 4700 relating to a contracted individual Profile is shown in FIG. 47. An indicator 4701 shows that the Profile is for an individual. Other information includes the name 4702, email address 4703, and membership information 4704, including the membership status and the membership expiry date. A control 4705 allows a User to show or edit the Membership Details. Another control 4706 allows a User to expand the Profile for the given individual.

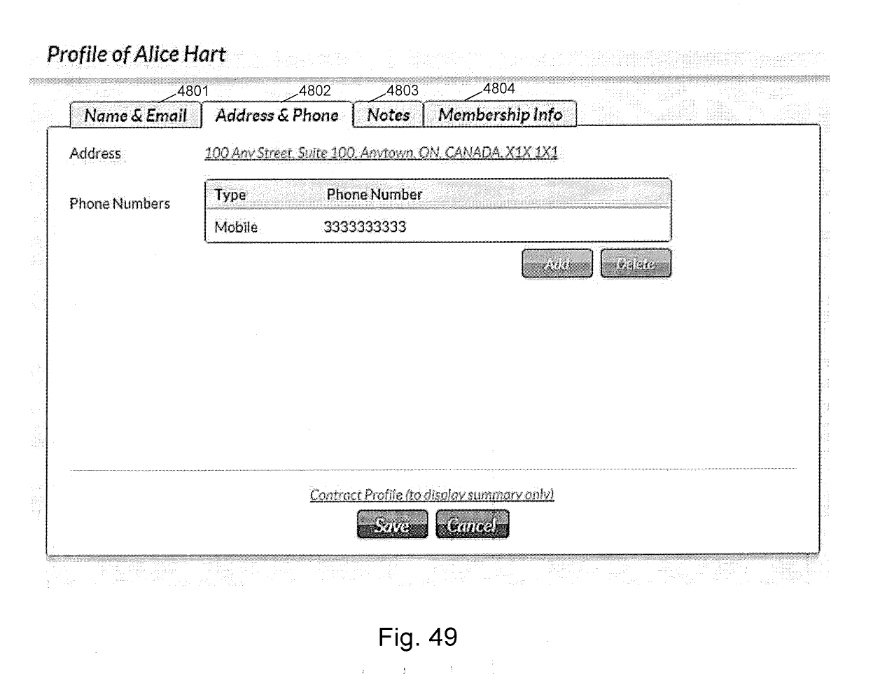

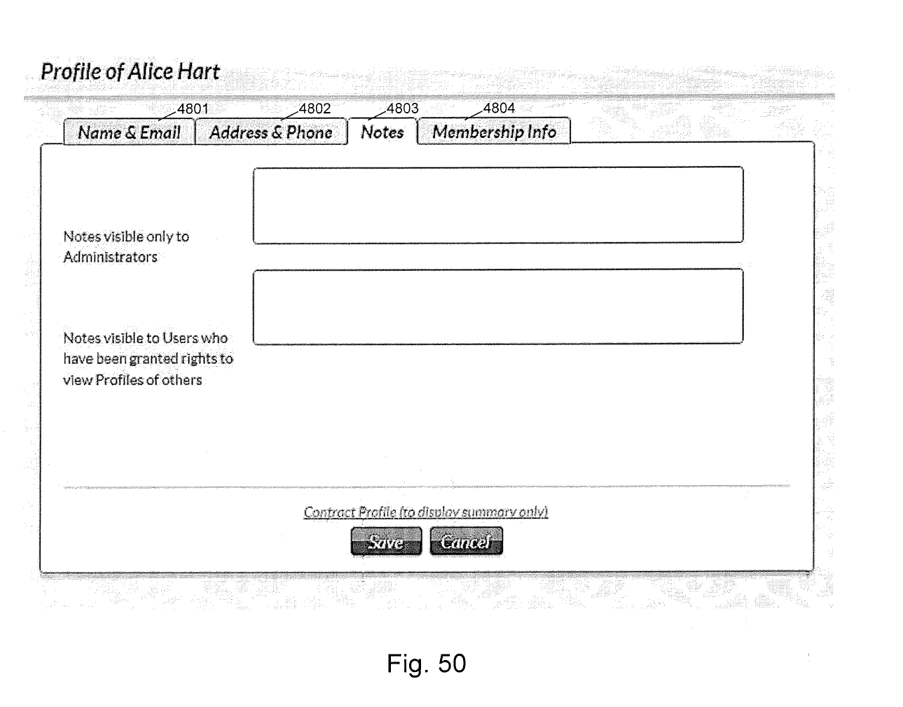

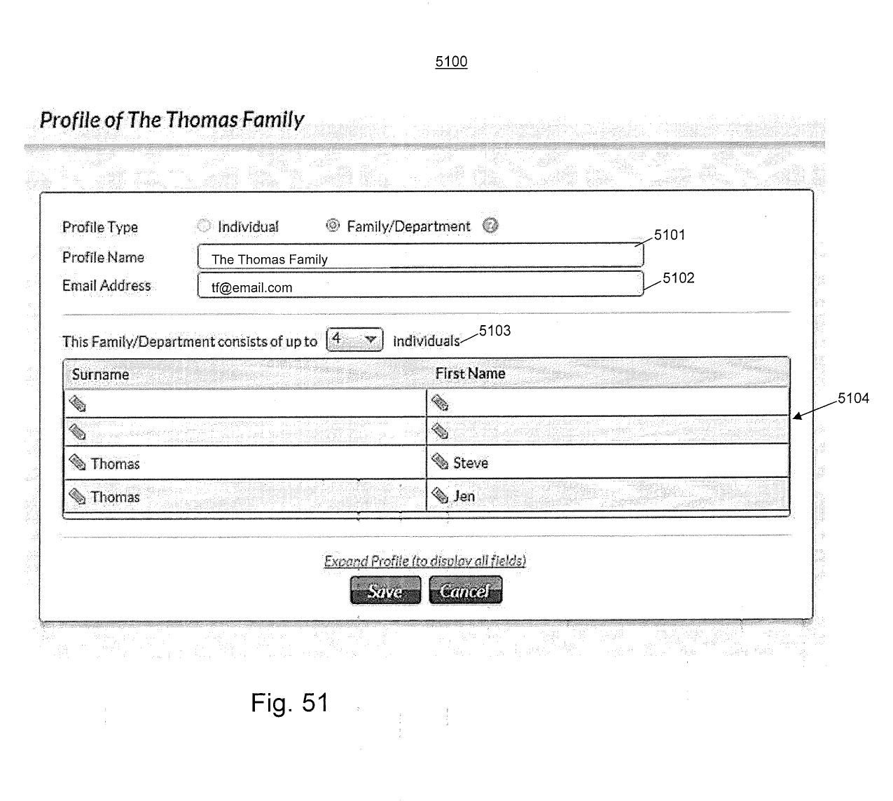

Examples of embodiments of a GUI 4800 relating to an expanded individual Profile is shown in FIGS. 48, 49 and 50. Tabs are shown for the name and the email address 4801, the address and the telephone number 4802, the notes 4803, and the membership information 4804. In FIG. 48, the tab for the name and the email 4801 is actively displayed. In FIG. 49, the tab for the address and the telephone number 4802 is actively displayed. In FIG. 50, the tab, for the notes 4803 is actively displayed.

Family/Department Profiles.

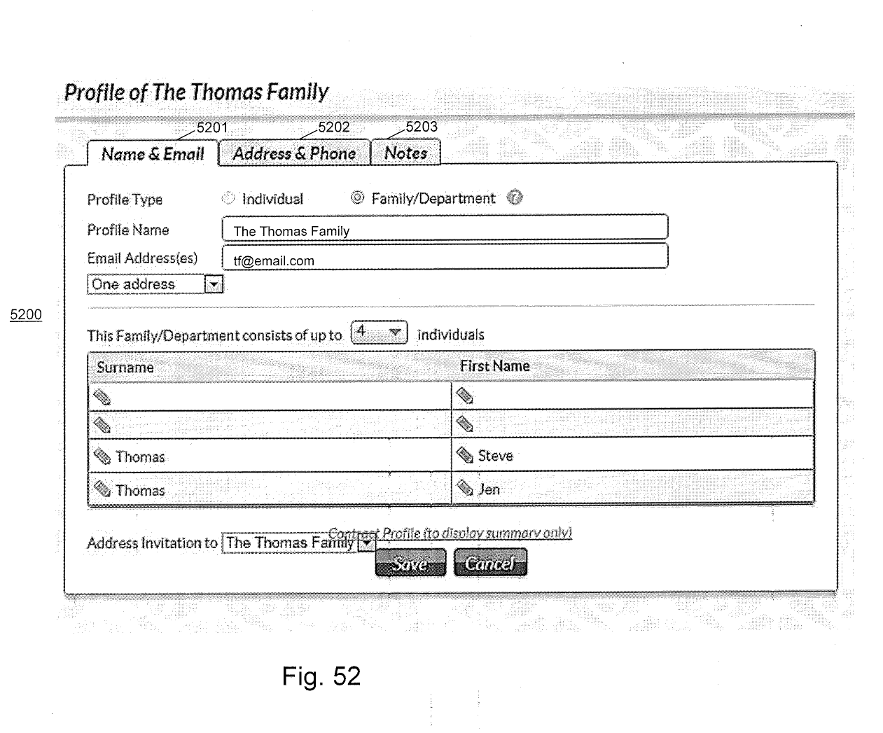

An example of an embodiment of a GUI 5100 of the contracted view of a Family/Department Profile is shown in FIG. 51. There are several key differences between an individual Profile and a Family/Department Profile. The name of the Family/Department Profile is stored in a single field, for example, The Thomas Family or Sales Department 5101. There can be more than one email address associated with a Family/Department Profile, for example, if there are to be multiple proxy contacts 5102. There is a field to set the maximum number of individuals represented by a Family/Department Profile 5103. Names of individuals, up to a specified maximum, can be entered into the Family/Department Profile 5104. However, it is not necessary to enter any or all such names. To the extent that the maximum number of people represented by the Family/Department Profile exceeds the number of names entered, the person who sends the RSVP on behalf of the family or department may enter names of individuals in the remaining slots.

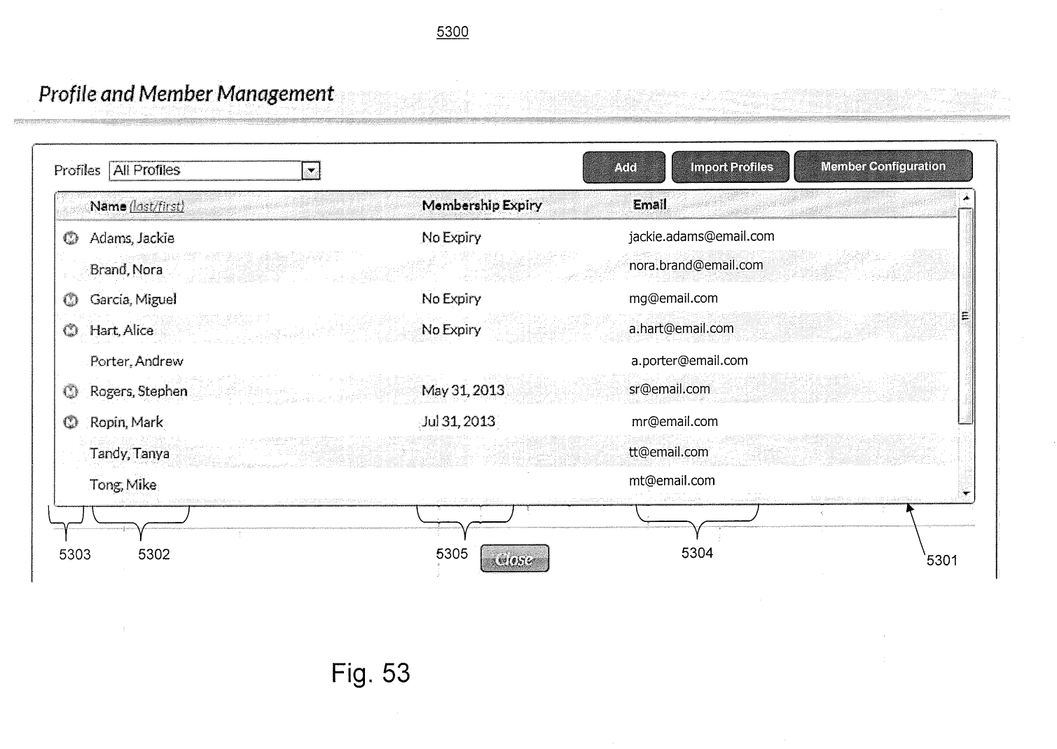

An example of an embodiment of the “Name & Email” tab 5201 of an expanded Family/Department Profile GUI 5200 is shown in FIG. 52. Other tabs include the address and the telephone information 5202 and notes 5203.

Profile Management.

Profile Management functionality can be accessed from the Administrator Mode in any of the Group Page GUI, the Event Page GUI and the Date Poll Page GUI. In the case of an Event or Date Poll which is associated with a Group, Profiles listed and created are associated with the Group, even though that the Profile Management functionality may be called from the Event Page GUI or the Date Poll Page GUI. Limited Profile Management functionality can also be accessed from the User Mode of an Event Page GUI or Date Poll Page GUI—solely to enable the User to add Invitees or Pollees where the Administrator has granted such authority in the Entity Setup Options.

There are different variations of the dialog depending on the GUI from which it is called but, in all cases, the functionality includes the ability to create, import and modify Profiles. If called from an Event Page GUI, the dialog is called “Attendance Management” and its functionality is described in the discussion of “Events” above. If called from a Date Poll Page GUI, the dialog is called “Pollee Management” and its functionality is as described in the discussion of “Date Polls” above.

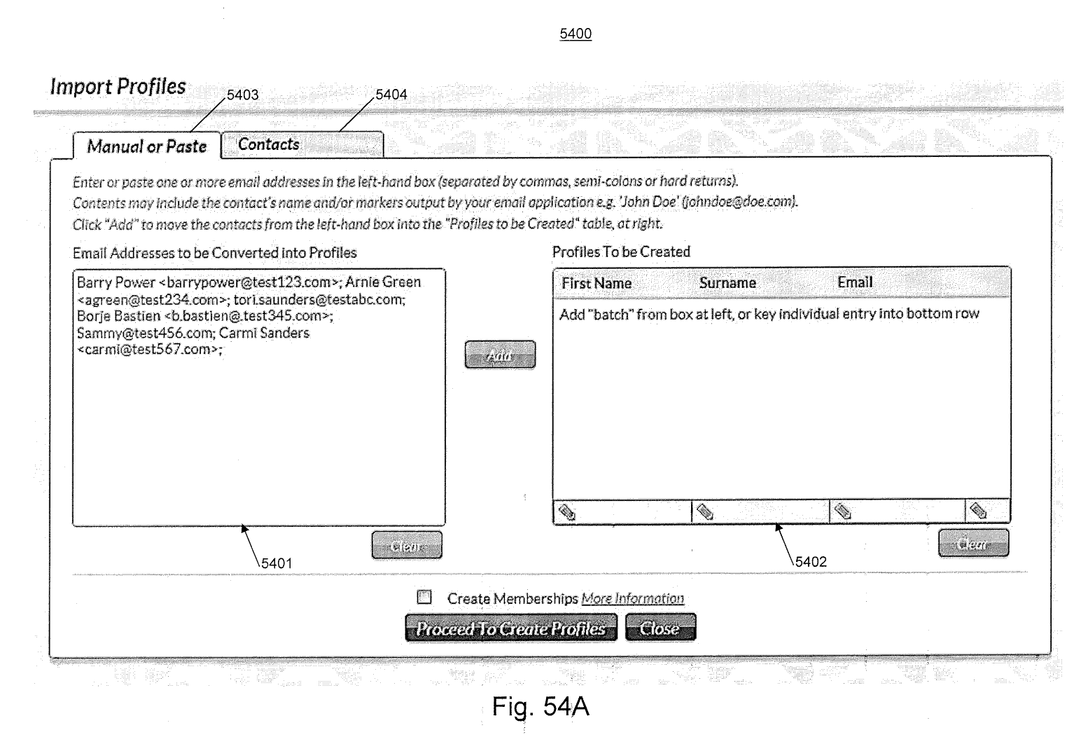

If called from a Group Page GUI, it is called “Profile and Member Management”, and an example of an embodiment of the dialog 5300 is shown in FIG. 53. A table 5301 consists of one row for each Profile associated with the Group. There are columns for the name 5302, the Affiliation Icon 5303, the email address 5304, the Membership Class, provided that there is more than one class of Members, and the Membership expiry date 5305, provided that at least one Profile has a Membership expiry date. An Administrator may click a row to open or edit the Profile or may delete a Profile which has never been used, or may retire a Profile which has been used. A Profile of an Entity which has never been used, for example, is a Profile for which an email notification has never been sent to the holder of the associated User Account in relation to the Entity.

Import Profiles.

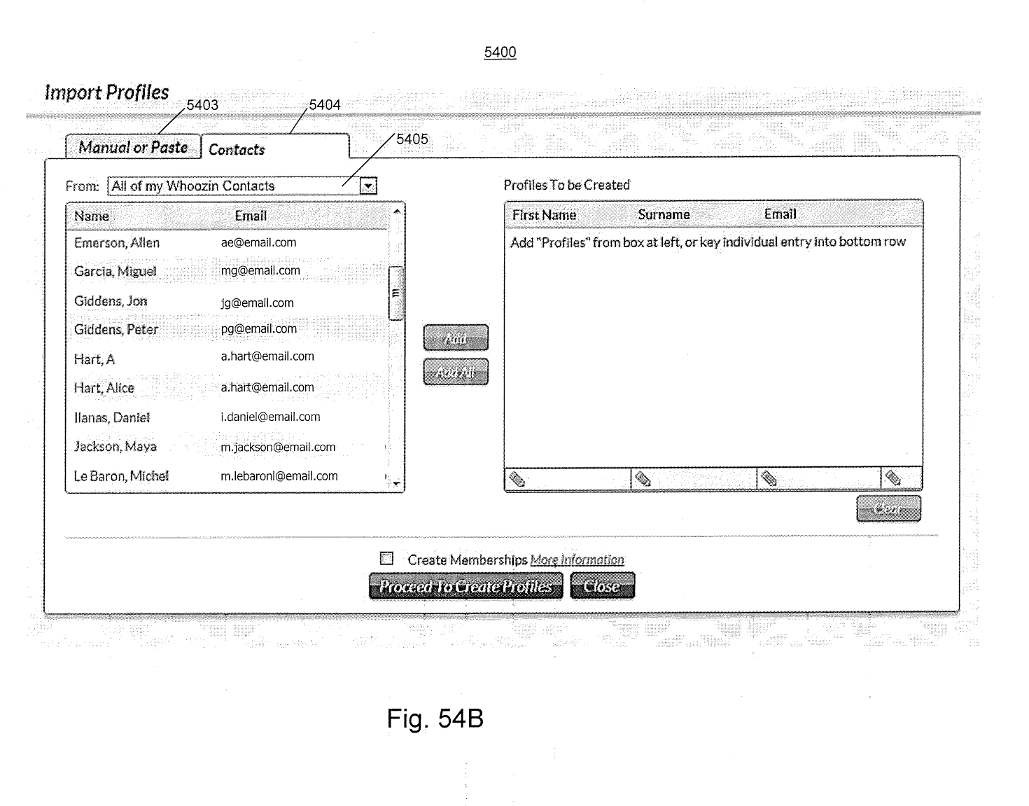

To create a single Profile, information can be keyed in to a contracted Profile dialog. Alternatively, the User can access functionality to import Profiles. Such functionality supports the importation of Profiles from a delimited list of email addresses, either with or without associated names. It also supports the importation from a list of all Profiles associated with any entity for which the User has the right to view Profiles of others, and an example of an embodiment of such a GUI 5400 thereof is shown in FIG. 54A. This figure shows a “Manual or Paste” tab 5403 and a “Contacts” tab 5404. When the “Manual or Paste” tab 5403 is actively shown, it displays two boxes. The box on the left 5401 allows a User to input therein email addresses, for example, manually or by pasting, which the system can parse and convert into the appropriate format. The box on the right 5402 lists the names and email addresses which have been parsed, and the User may edit this information prior to directing that the server create Profiles using this information.

In another example of an embodiment, in FIG. 54B, when the “Whoozin Contacts” tab, or more generally a contacts tab, 5404 is actively shown, a User can select contacts to import from existing Entities with which the User is associated. A control 5405 allows a User to specify from which Entity the associated contacts can be imported.

Member Classes.

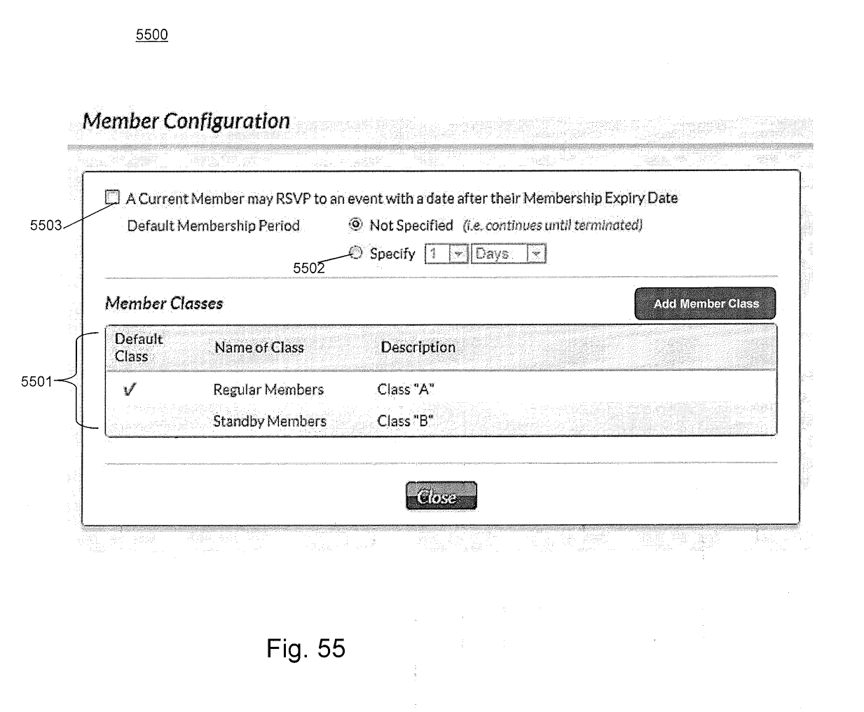

By default, a Group has one class of Members. An example of an embodiment of a GUI 5500 for creating additional Member Classes is shown in FIG. 55. If there is more than one Member Class, the Administrator can designate the default Member Class 5501, namely, the Member Class to which a new Member will, by default, belong. The Administrator can also designate a default Membership term, such as one year, 5502, which is applied to new Memberships and Membership renewals. The Administrator can also designate whether, by default, a Member is an Eligible Attendee of an Event for which the Event Date is later than the Membership expiry date 5503.

Member Management.

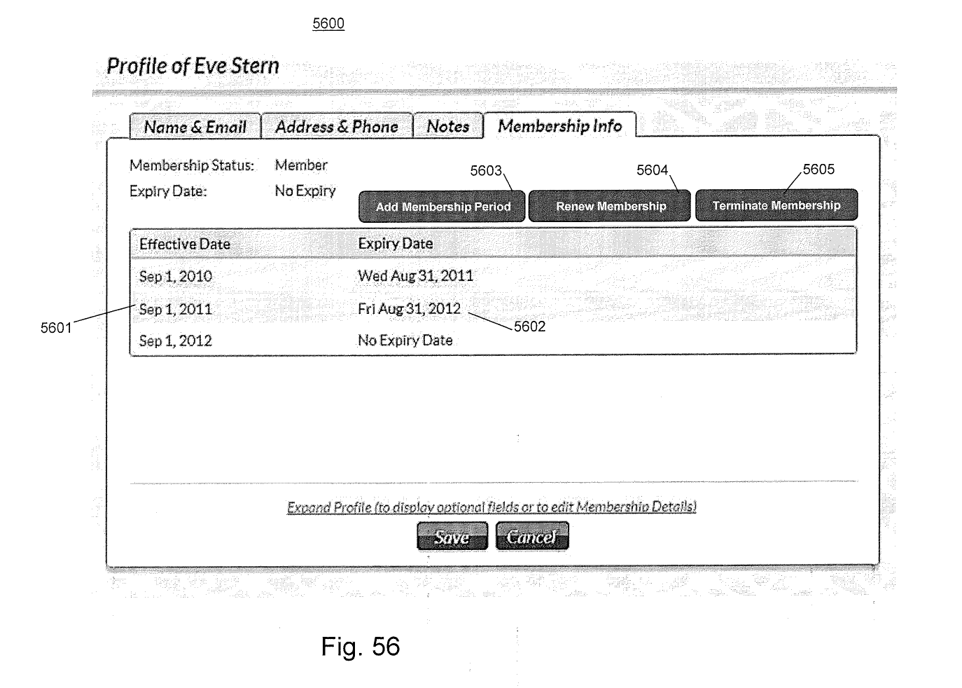

Member Management is the functionality by which Membership attributes are assigned, by the Administrator, to Profiles associated with a Group. In an example of an embodiment of a GUI 5600, as shown in FIG. 56, a history of Membership periods is retained as part of a Profile's data. Each Membership period consists of an effective date 5601; a Member Class, although the Member Class may not be displayed if the Group has only one class of Members; and, optionally, a Membership expiry date 5602. If the server detects that a Membership period has no designated expiry date, the server determines that such Membership continues until terminated by the Administrator.

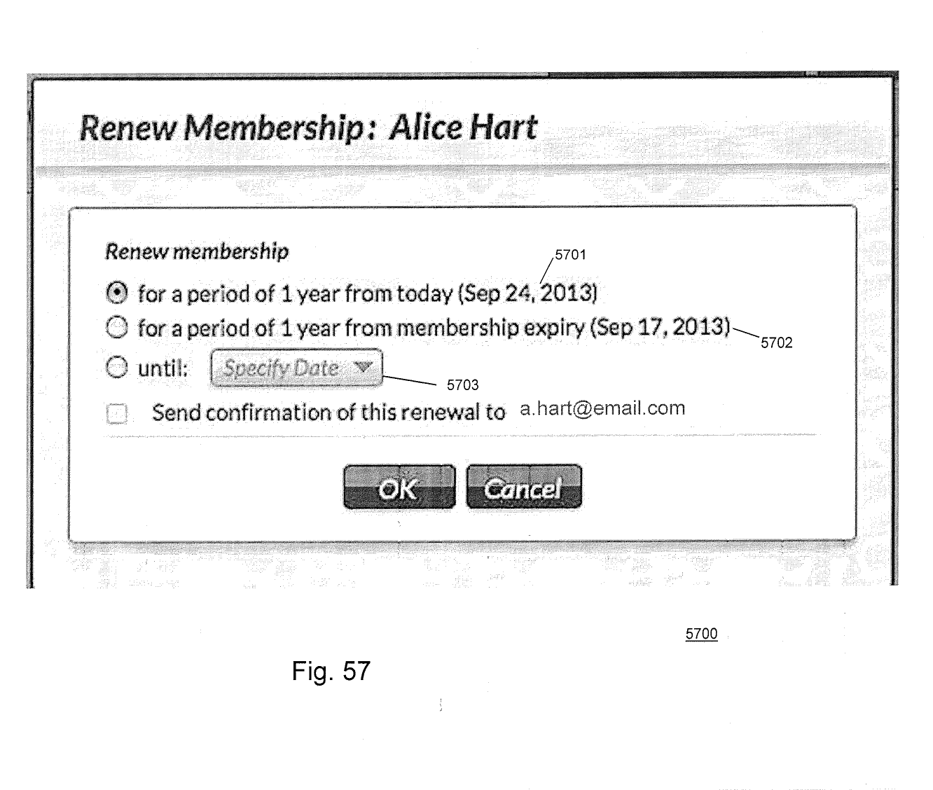

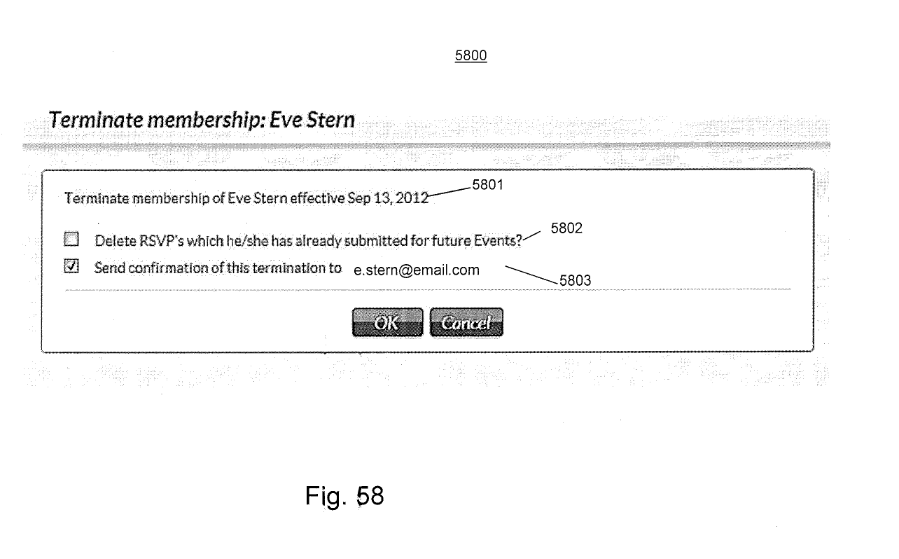

Related functionality includes the ability to add a Membership period 5603, renew a Membership for the default Membership term 5604 (see FIG. 57), terminate a Membership 5605 (see FIG. 58), delete a Membership period or modify a Membership period. In an example of an embodiment, a Profile cannot have Membership periods with overlapping dates. To expedite the process of designating Profiles as Members, the Administrator may designate a default Member Class, provided that more than one class of Members has been set up for the Group, and, optionally, a default Membership term.

FIG. 57 shows an example of an embodiment of a GUI 5700 for renewing Membership. An option is renewing the Membership for a certain Member for a period of one year on the basis of the default membership period, for example, previously specified using control 5502, from today 5701. Another option is to renew the Membership of that Member for a period of one year from expiry of the current membership period 5702 or until a specified date 5703

FIG. 58 shows an example of an embodiment of a GUI 5800 for terminating Membership for a given Member. A statement 5801 indicates that a given Member's Membership will terminate effective on a particular date. There is also the option to delete RSVPs which the given Member has already submitted for future Events 5802. There is also the option to send confirmation of the termination to the given Member 5803.

### Interpretations of Examples and Figures

The steps or operations illustrated in the flow charts in the Figures and described herein are examples just for the convenience and additional assistance to the reader. There may be many variations to these steps or operations. For instance, the steps may be performed in a differing order, or steps maybe added, deleted, or modified.

The GUIs and screen shots illustrated in the Figures and described herein are examples just for the convenience and additional assistance to the reader. There may be variations to the graphical and interactive elements. For example, such elements can be positioned in different places, or added, deleted, or modified.

It will be appreciated that the particular examples of the embodiments shown in the Figures and described above are for descriptive and illustrative purposes only and many other variations can be used according to the examples of the embodiments described. Although the above has been described with reference to certain specific examples of the embodiments, various modifications thereof will be apparent to those skilled in the art.

1. A method performed by a computing device for organizing events comprising:
receiving data from an administrator to create an entity, the entity comprising any one of a group, an event, and a date poll, the data including a unique identifier of a user;
creating the entity;
creating a user account based on the unique identifier and associating the entity with the user account;
receiving other data from an other administrator to create an other entity, the other entity comprising any one of an other group, an other event, and an other date poll, the other data including the unique identifier of the user;
creating the other entity;
identifying the user account using the unique identifier and associating the other entity with the user account; and
when the user account is accessed by the user using the unique identifier, enabling access to the entity and the other entity.

2. The method of claim 1, wherein the unique identifier is an email address of the user.

3. The method of claim 1, wherein the administrator has a profile associated with the entity and the other administrator has an other profile associated with the other entity and both the profile and the other profile are associated with a same user account.

4. The method of claim 1, wherein the administrator is associated with a different user account and the other administrator is associated with an other different user account.

5. The method of claim 1, wherein, after associating the entity with the user account, sending an electronic message to the user with information to view the entity.

6. The method of claim 1, wherein, after receiving the data to create the entity; the method further comprises:
determining whether the user has an existing user account based on the unique identifier; and
creating the user account if the user does not have one.

7. The method of claim 6, wherein if the user has an existing account, the entity is associated with the existing user account.

8. The method of claim 1, further comprising:
creating a profile for the user, identified by the unique identifier, that is associated with the entity;
creating an other profile for the user, identified by the unique identifier, that is associated with the other entity; and
associating the profile and the other profile with the user account.

9. The method of claim 8, wherein the entity and the other entity each have an entity ID, and the profile and the other profile each have a profile ID.

10. The method of claim 1, further comprising:
determining whether the entity is activated, and if so, enabling the user to access the entity; and
determining whether the other entity is activated, and if so, enabling the user to access the other entity.

11. The method of claim 10, wherein the entity is the event and enabling access to the event includes a condition that precludes the user from sending an RSVP response or registering for the event until a date prior to an event date of the event.

12. The method of claim 1, wherein a user home page graphical user interface is displayed when the user accesses the user account, the user home page graphical user interface including the data about the entity and the other data about the other entity.

13. A method performed by a computing device for creating an entity, the entity being any one of an event, a date poll and a group, the method comprising:
receiving an input from an electronic device to create the entity;
generating an entity ID;
obtaining entity information and associating the entity information with the entity ID;
obtaining contact information associated with a user;
associating the user with the entity ID;
obtaining a profile and a corresponding profile ID for the user, the profile and the profile ID associated with the entity ID; and
enabling the user to access the entity after receiving an input to activate the entity.

14. The method of claim 13, further comprising, after receiving the input to activate the entity, sending an electronic message to the user with information to view the entity.

15. The method of claim 13, wherein before the entity is activated, the method further comprises:
generating a cookie including the entity ID and sending the cookie to the electronic device;
after detecting that the electronic device has been disconnected and reconnected with the computing device, obtaining the cookie from the electronic device;
using the cookie and the entity ID stored therein to obtain and enable the display of the entity information to facilitate the creation of the entity.

16. The method of claim 14, wherein the electronic message includes data from which the computing device can identify the entity ID and the profile ID.

17. The method of claim 13, further comprising associating the profile ID and entity ID with a user account.

18. The method of claim 17, further comprising:
after receiving the input to activate the entity, sending an electronic message that includes a web link to the user with information to view the entity, the web link including data from which the computing device can identify the entity ID and the profile ID; and
enabling access to the user account when accessed through the web link.

19. The method of claim 17, further comprising, after the user account is accessed, displaying the entity information.

20. The method of claim 13, wherein the contact information includes an email address of the user for use as a unique identifier of the user.

21. The method of claim 18, wherein, after obtaining the contact information associated with the user, the method further comprises:
determining whether the user has an existing user account based on the unique identifier; and
generating a user account associated with the unique identifier when no such user account exists.

22. The method of claim 13, wherein the entity is a copy of an original entity, and the entity information is a copy of original entity information of the original entity.

23. The method of claim 22, wherein the computing device receives, from the electronic device, modification to the original entity information when obtaining the entity information.

24. The method of claim 22, wherein the original entity information includes another profile of another user, and enabling the other user to access the entity after the entity is activated.

24. The method of claim 13, wherein the entity is the event that is converted from an other date poll, and the entity information is a copy of information of the other date poll.

25. The method of claim 13, wherein the entity is created by an administrator having a user account, the user account being associated with an other entity, the other entity associated with an other user, the method further comprising:
associating the other user with the entity ID;
generating an other profile and an other corresponding profile ID for the other user, the other profile and the other profile ID associated with the entity ID; and
enabling the other user to access to the entity after activating the entity.

26. The method of claim 13, wherein:
the entity is the event created within context of a group;
the profile and the corresponding profile ID are associated with the group; and,
the method further comprises:
automatically obtaining the contact information of the user from the profile; and
automatically associating the profile and the profile ID with the entity ID.

27. The method of claim 26, wherein, after associating the profile and the profile ID with the entity ID, the method further comprises:
determining whether the user is a member of the group; and
if the user is a member, automatically designating the user as eligible to attend the event.

28. The method of claim 13, wherein the computing device receives the contact information of the user from the electronic device.

29. A method performed by a computing device for converting a date poll to an event, the method comprising:
receiving an input to convert the date poll to the event;
displaying a graphical user interface for receiving a selection of one of a plurality of polled dates in the date poll and for receiving a selection to designate pollees of the date poll as invitees of the event; and
after receiving an input to proceed with creating the event, establishing the selected one of the plurality of polled dates as a date of the event as the event and designating the pollees as invitees.

30. The method of claim 29, wherein the graphical user interface is also for receiving a selection for terminating the date poll.

31. The method of claim 29, wherein a name of the event is identical to a name of a proposed event presented in the date poll.
